(19) United States
(12) Patent Application Publication
(10) Pub. No.: US 2014/0342797 A1
(43) Pub. Date: Nov. 20, 2014

(54) GAMING MACHINE AND GAMING METHOD

(71) Applicants: Aruze Gaming America, Inc., Las Vegas, NV (US); Universal Entertainment Corporation, Tokyo (JP)

(72) Inventors: Masumi FUJISAWA, Tokyo (JP); Kenta KITAMURA, Tokyo (JP); Kensaku YOSHIKAWA, Tokyo (JP); Kou KOBAYASHI, Tokyo (JP)

(73) Assignees: Aruze Gaming America, Inc., Las Vegas, NV (US); Universal Entertainment Corporation, Tokyo (JP)

(21) Appl. No.: 13/896,381

(22) Filed: May 17, 2013

(51) Int. Cl. G07F 17/34

(52) U.S. Cl. CPC G07F 17/34
USPC 463/20

(57) ABSTRACT

A gaming machine according to an embodiment of the present invention includes: a reel assembly including basic reels including a plurality of basic symbols and an extra reel including a plurality of extra symbols; and a controller configured to: control the basic reels and the extra reel; execute a first lottery with the basic reels to determine a win or a loss of a game; execute a second lottery to select one of the extra symbols; and control the extra reel to spin and stop to show the selected one of the extra symbols, wherein the plurality of extra symbols include a multiplier symbol multiplying a win prize of the game, an effect symbol used in an effect of the game, a determinant symbol determining a number of free rounds in a free mode of the game, and an adder symbol adding extra free rounds in the free mode of the game.

### BACKGROUND

(a) Field

The present invention generally relates to a gaming machine and a gaming method.

(b) Description of the Related Art

A conventional gaming machine such as a slot machine includes a plurality of reels including a plurality of symbols. The gaming machine arranges the symbols in a game round, and awards a payout to a player based on a symbol arrangement as a result of the execution of the game round (for example, United State Patent Application Publication No. 2008/0058067 and United State Patent Application Publication No. 2008/0058072).

However, a player may easily lose interest in gaming with conventional gaming machines including the reels that repeat similar movements in the game rounds. For example, the reels of conventional slot machines simply repeat spin and stop in response to inputs of the player. In addition, the symbols on the reels of the conventional slot machines may be used only in determining a win or a loss or at most in determining a multiplier for a win prize, which may not attract the player.

Therefore, there is a need for new types of a game and/or new types of visual and sound effects that may attract a player's interest.

### SUMMARY

A gaming machine according to an embodiment of the present invention includes: a reel assembly including basic reels including a plurality of basic symbols and an extra reel including a plurality of extra symbols; and a controller configured to: control the basic reels and the extra reel; execute a first lottery with the basic reels to determine a win or a loss of a game; execute a second lottery to select one of the extra symbols; and control the extra reel to spin and stop to show the selected one of the extra symbols, wherein the plurality of extra symbols include a multiplier symbol multiplying a win prize of the game, an effect symbol used in an effect of the game, a determinant symbol determining a number of free rounds in a free mode of the game, and an adder symbol adding extra free rounds in the free mode of the game.

The controller may be configured to: determine whether a predetermined condition for moving the extra reel is satisfied; and execute the second lottery with the extra reel when it is determined that the predetermined condition is satisfied.

The plurality of reels may be mechanical reels configured to rotate around a common rotational axis.

The extra reel moves based on a result of the second lottery.

The extra reel and the basic reel move based on a result of the second lottery.

The controller may be configured to: execute the first lottery in a normal mode of the game; determine a result of the first lottery executed in a normal mode satisfies a predetermined condition for triggering a free mode; execute the second lottery to select the determinant symbol before starting a game round in the free mode when a result of the first lottery executed in the normal mode satisfies the predetermined condition; and determine a number of game rounds in the free mode based on the selected determinant symbol.

The controller may be configured to: execute the first lottery in a free mode of the game; determine a result of the first lottery executed in the free mode satisfies the predetermined condition; execute the second lottery to select the determinant symbol before starting a next game round when a result of the first lottery executed in the free mode satisfies the predetermined condition; and determine a number of additional game rounds in the free mode based the selected determinant symbol.

The controller may be configured to: execute the second lottery in a free mode to select the adder symbol; and increase a number of game rounds in a free mode based on the adder symbol.

The multiplier symbol may have a first multiplier value or a second multiplier value higher than the first multiplier value, and the effect symbol may include a chance symbol informing that a free mode is triggered or retriggered or that the extra reel re-spin and stops to show the multiplier symbol with the second multiplier value.

The effect symbol may include a bonus effect symbol informing that a free mode is triggered, and the controller may be configured to: execute the first lottery in a normal mode of the game; determine a result of the first lottery executed in a normal mode satisfies a predetermined condition for triggering a free mode; and control the extra reel to show the bonus effect symbol when a result of the first lottery executed in the normal mode satisfies the predetermined condition for triggering the free mode.

The effect symbol includes a loss symbol informing of a loss of a game round, and the controller may be configured to control the extra reel to show the loss symbol when a result of the first lottery fails to satisfy a predetermined condition for win.

The controller may be configured to execute a third lottery to determine a movement pattern of the extra reel.

The controller may be configured to control the extra reel based on the determined movement pattern such that the extra reel repeatedly spins and stops to show the effect symbol before showing the selected one of the extra symbols.

The gaming machine may further include an illuminator configured to illuminate light image to portions of the plurality of reels, wherein at least one of the plurality of the reels includes a reel strip including a partially reflective layer that partially reflect the light image from the illuminator.

The extra reel include a first reel strip including a first symbol layer and a second symbol layer, the first symbol layer includes a first translucent color sheet having a first background color and a first symbol that may be substantially colorless and transparent, the second symbol layer includes a second translucent color sheet having a second background color different from the first background color and a second symbol that may be substantially colorless and transparent, the first translucent color sheet and the second translucent color sheet may overlap each other, and the reel assembly may further include a backlighting unit illuminating light to the first reel strip in an outward direction with different colors such that the first symbol and the second symbol may be alternatively visible depending on a color of the light illuminated by the backlighting unit.

A gaming method according to an embodiment of the present invention includes: executing a first lottery for a game round with basic reels of a reel assembly of a gaming machine, the basic reels including a plurality of basic symbols, to determine a win or a loss of the game; executing a second lottery for the game round with an extra reel of the reel assembly, the extra reel including a plurality of extra symbols, to select one of the extra symbols; and spinning and stopping the extra reel to show the selected one of the extra symbols, wherein the plurality of extra symbols may include multiplier symbols multiplying a win prize of the game, effect symbols used in an effect of the game, determinant symbols determining a number of free rounds in a free mode of the game, and adder symbols adding extra free rounds in the free mode of the game.

The gaming method may further include: determining whether a predetermined condition for moving the extra reel is satisfied; and moving the extra reel in connection with the basic reels when it is determined that the predetermined condition is satisfied, wherein the second lottery may be executed when it is determined that the predetermined condition is satisfied.

The spinning and stopping the extra reel may be performed based on a movement pattern such that the extra reel repeatedly spins and stops to show the effect symbol before showing the selected one of the extra symbols.

The effect symbols may include a first effect symbol informing that the extra reel re-spins and stops to show one of the multiplier symbols, or informing that a free mode is triggered or retriggered.

The effect symbols may further include a second effect symbol informing of a loss of a game round.

### BRIEF DESCRIPTION OF THE DRAWINGS

FIG. 1 is a schematic block diagram of a gaming machine according to an embodiment of the present invention.

FIG. 2 is a schematic view of symbol strips in a gaming machine according to an embodiment of the present invention.

FIG. 3 to FIG. 5 illustrate movements of reels of the gaming machine according to embodiments of the present invention.

FIG. 6A illustrates image variation on an auxiliary display depending on a symbol on an extra reel in the gaming machine according an embodiment of the present invention.

FIG. 6B illustrates a spinning of an extra reel in response to an action of a character image on an auxiliary display according an embodiment of the present invention.

FIG. 7 is a schematic flow chart illustrating a gaming method using a gaming machine including basic reels and an extra reel according to an embodiment of the present invention.

FIG. 8 is a schematic perspective view of a slot machine according to an embodiment of the present invention.

FIG. 9 is a schematic perspective view of a reel assembly and a reel cover according to an embodiment of the present invention.

FIG. 10A is a schematic exploded plan view of a reel strip according to an embodiment of the present invention.

FIG. 10B is a schematic exploded sectional view of the reel strip shown in FIG. 10A.

FIG. 11A is a schematic exploded plan view of a reel strip according to another embodiment of the present invention.

FIG. 11B is a schematic exploded sectional view of the reel strip shown in FIG. 11A.

FIG. 12 is a schematic plan view of color sheets overlapping each other according to an embodiment of the present invention.

FIG. 13A and FIG. 13B are schematic exploded plan views of a reel strip according to other embodiments of the present invention.

FIG. 14 is a symbol code table according to an embodiment of the present invention.

FIG. 15 is a schematic front view of a reel and a backlighting unit according to an embodiment of the present invention.

FIG. 16A and FIG. 16B shows a reel strip illuminated with different color lights according to an embodiment of the present invention.

FIG. 17 shows a schematic diagram of a reel assembly including a light illuminator according to an embodiment of the present invention.

FIG. 18A and FIG. 18B show operations of reel strips and a light illuminator according to an embodiment of the present invention.

FIG. 19 is a layout view of a control panel according to an embodiment of the present invention.

FIG. 20 is an electrical block diagram of the slot machine shown in FIG. 49 according to an embodiment of the present invention.

FIG. 21 is a block diagram of an electrical circuit of the reel assembly according to an embodiment of the present invention.

FIG. 22 is a functional block diagram of the game program executed by a main CPU of a motherboard in the slot machine shown in FIG. 49 according to an embodiment of the present invention.

FIG. 23 shows a state machine of a gaming mode in a gaming machine according to an embodiment of the present invention.

FIG. 24 is a schematic flow chart illustrating a gaming method according to an embodiment of the present invention.

FIG. 25 is a schematic flow chart illustrating a normal mode process according to an embodiment of the present invention.

FIG. 26A and FIG. 26B are a schematic flow chart illustrating a normal reel spin process according to an embodiment of the present invention.

FIG. 27 is a schematic flow chart illustrating a free mode process according to an embodiment of the present invention.

FIG. 28A and FIG. 28B are a schematic flow chart illustrating a free reel spin process according to an embodiment of the present invention.

FIG. 29A, FIG. 29B, and FIG. 29C illustrate symbol sets on an extra reel used in various situations.

FIGS. 30A and 30B show exemplary rendering patterns.

FIG. 31 shows the displays in an idle state of the gaming machine according to an embodiment of the present invention.

FIG. 32 and FIG. 33 illustrate operations of the displays of the gaming machine in a normal round without spinning an extra reel according to an embodiment of the present invention.

FIG. 34 to FIG. 37 illustrate operations of the displays of the gaming machine in a normal mode or in a free mode according to an embodiment of the present invention when an extra wheel stops spinning before basic reels stop spinning and when no chance symbol is selected to be displayed.

FIG. 38 to FIG. 42 illustrate operations of the displays of the gaming machine in a normal mode or in a free mode according to an embodiment of the present invention when an extra wheel stops spinning before basic reels stop spinning and when a chance symbol is selected to be displayed in a display window.

FIG. 43 to FIG. 45 illustrate operations of the displays of the gaming machine in a normal mode or in a free mode according to an embodiment of the present invention when an extra wheel starts spinning at substantially the same time as basic reels and stops spinning after basic reels stop spinning and when no chance symbol is selected to be displayed.

FIG. 46 to FIG. 49 illustrate operations of the displays of the gaming machine in a normal mode according to an embodiment of the present invention when an extra wheel starts spinning after basic reels stop spinning and when no chance symbol is selected to be displayed.

FIG. 50 to FIG. 56 illustrate operations of the displays of the gaming machine in a normal mode or in a free mode according to an embodiment of the present invention when an extra wheel starts spinning after basic reels stop spinning and when a chance symbol is selected to be displayed.

FIG. 57 to FIG. 61 illustrate operations of the displays of the gaming machine in transition from a normal mode to a free mode according to an embodiment of the present invention.

FIG. 62 to FIG. 66 illustrate operations of the displays of the gaming machine in a free mode when a free mode is retriggered according to an embodiment of the present invention.

FIG. 67 to FIG. 70 illustrate operations of the displays of the gaming machine in a free mode when extra free rounds are added according to an embodiment of the present invention.

FIG. 71 is a schematic electrical block diagram of a gaming machine according to an embodiment of the present invention.

FIG. 72 is a schematic diagram of a data sheet provided by a gaming machine development system according to an embodiment of the present invention.

FIG. 73 is a schematic diagram of an example data sheet for a rendering effect according to an embodiment of the present invention.

FIG. 74A, FIG. 74B, and FIG. 74C are schematic diagrams of example reel controls file shown in FIG. 73.

FIG. 75A, FIG. 75B, and FIG. 75C are schematic diagrams of example reel controls file shown in FIG. 73.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Outline of Gaming Machine and Gaming Method

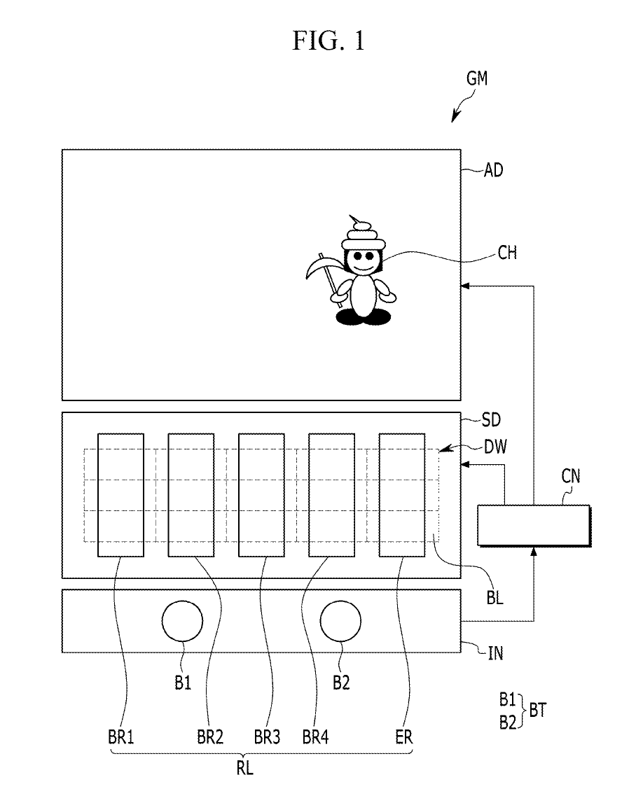

A gaming machine according to an embodiment of the present invention is described with reference to FIG. 1 to FIG. 6B.

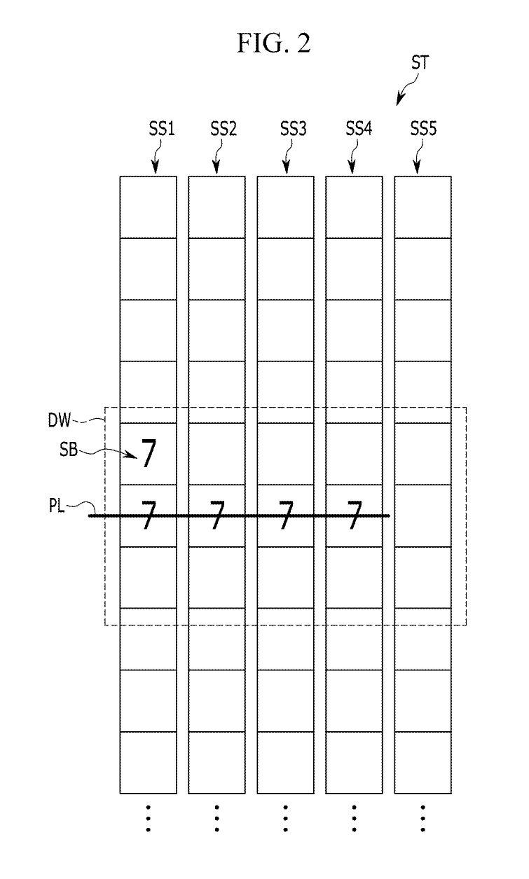

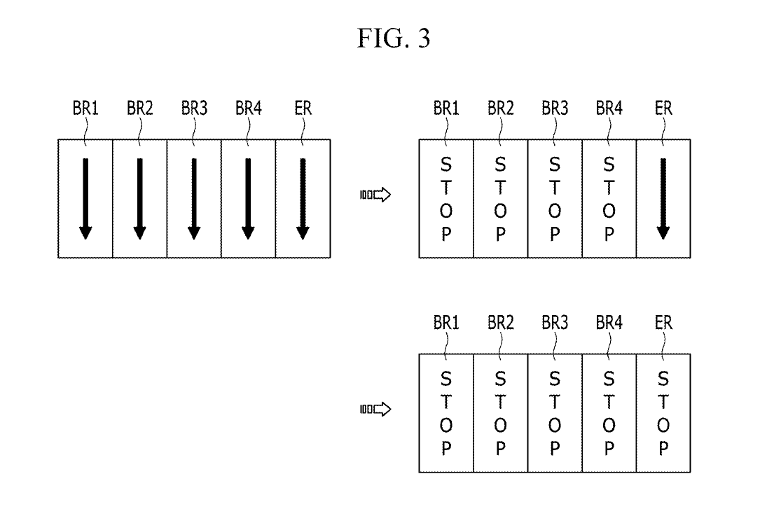

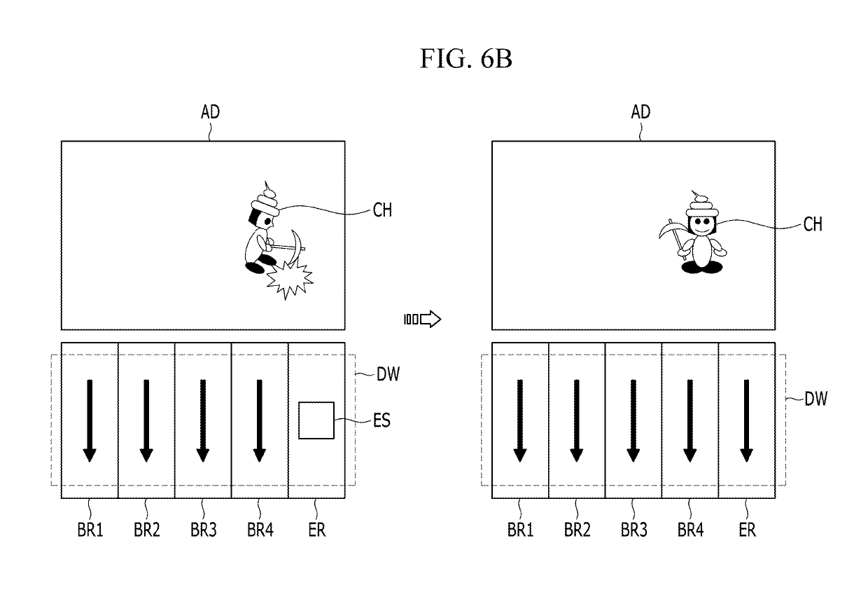

FIG. 1 is a schematic block diagram of a gaming machine according to an embodiment of the present invention, FIG. 2 is a schematic view of symbol strips in a gaming machine according to an embodiment of the present invention, FIG. 3 to FIG. 5 illustrate movements of reels of the gaming machine according to embodiments of the present invention, FIG. 6A illustrates image variation on an auxiliary display depending on a symbol on an extra reel in the gaming machine according an embodiment of the present invention, and FIG. 6B illustrates a spinning of an extra reel in response to an action of a character image on an auxiliary display according an embodiment of the present invention.

Referring to FIG. 1, a gaming machine GM according to an embodiment of the present invention includes a symbol display SD, an auxiliary display AD, an input unit IN, and a controller CN connected to the symbol display SD, the auxiliary display AD, and the input unit IN. The gaming machine GM may execute a game in a normal mode or in a free mode. The gaming machine GM may execute a base game in a normal mode and at least one bonus game different from the base game in a bonus mode.

The symbol display SD includes a plurality of reels RL including a set of basic reels BR1-BR4 and an extra reel ER. The extra reel ER and the set of the basic reels BR1-BR4 may be used in different lotteries. The set of the basic reels BR1-BR4 may be used in an ordinary lottery, and the extra reel ER may be used in an extra lottery. For example, the set of the basic reels BR1-BR4 may show a result of the ordinary lottery, and the extra reel ER may show a result of the extra lottery.

According to an embodiment of the present invention, the ordinary lottery may determine a win or a loss of a game round. According to an embodiment of the present invention, a result of the extra lottery may modify a result of the ordinary lottery or may affect a moving pattern of the extra reel ER and/or a moving pattern of the basic reels BR1-BR4. The extra lottery may be also used in determining or changing the number of game rounds in a free mode or in a bonus mode. According to an embodiment of the present invention, the result of the extra lottery may be advantageous or at least may not be disadvantageous to a player. For example, the result of the extra lottery may not change a win or a loss of a game round, may not decrease a win prize of the game round, and may not decrease the number of free rounds in a free mode.

The set of basic reels BR1-BR4 may move, spin, or scroll in each execution (or round) of a game while the extra reel ER move, spin, or scroll under a predetermined condition. The predetermined condition may include a predetermined result of a separate lottery irrelevant of the ordinary lottery or may include a predetermined result of the ordinary lottery.

The reels RL and the extra reel ER may be actual/mechanical reels or virtual/video reels. The basic reels BR1-BR4 and the extra reel ER, when they are mechanical reels, may rotate around a common rotational axis, and may have similar structures or substantially the same mechanical structure.

According to an embodiment of the present invention, the reels RL may further include two or more extra reels ER. According to an embodiment of the present invention, the number of the basic reels BR1-BR4 is four. However, the numbers of the basic reels are not limited thereto. According to an embodiment of the present invention, the basic reels BR1-BR4 are gathered together, and the extra reel ER is disposed at a side of a group of the basic reels BR1-BR4. However, the positions of the basic reels BR1-BR4 and the extra reel ER are not limited thereto. For example, the extra reel ER may be disposed between the basic reels BR1-BR4.

Each reel RL may carry a series of the symbols SB forming a symbol strip SS1-SS5 as shown in FIG. 2. A symbol set ST including all the symbols SB on the symbol strips SS1-SS5 for a game may be predefined.

The symbol display SD further includes a display window DW that shows a group of symbols selected from the symbol set ST to a player. The display window DW may include a plurality of virtual/actual display blocks BL arranged in rows and columns FIG. 1 and FIG. 2 show that the plurality of display blocks BL form a 3×5 matrix. However, the arrangement of the display blocks BL is not limited thereto.

When the reels RL stop, some of the symbols SB on each reel RL may occupy respective display blocks BL, and the other of the symbols SB may not be shown to the player.

A group of symbols on the basic reels BR1-BR4, which are shown by the display window DW, form a “symbol arrangement.” A series of consecutive symbols on the extra reel ER, which are shown by the display window DW, form an “extra symbol column” According to an embodiment of the present invention, a symbol arrangement includes twelve symbols arranged in a 3×4 matrix where three consecutive symbols are selected from each of the four symbol strips SS1-SS4 on the basic reels BR1-BR4, and an extra symbol column includes three consecutive symbols selected from the fifth symbol strip SS5 on the extra reel ER.

The symbol arrangement may include one or more predetermined “winning combinations” of the symbols SB. When the symbol arrangement for a game round includes one or more winning combinations, a player wins the game round. However, when the symbol arrangement includes no winning combination, a player loses the game round. Accordingly, a win or a loss of the game round may be determined by the symbol arrangement.

FIG. 2 shows an exemplary payline PL that passes through a row in each column of a symbol arrangement. When a group of the symbols SB in the symbol arrangement placed on the payline PL satisfies a predetermined condition, a “line win” may be established. For example, when two, three, or more symbols SB successively arranged from a first symbol strip SS1 to right along the payline PL are the same, the two, three, or more successively arranged symbols SB may form a winning combination and a line win may be established. Various paylines may be drawn, and two or more of the paylines may be selected by the player to expect more probability of win.

In addition to the line win that is related to the payline PL, there is another type of win, referred to as a “scatter win,” which is established when one or more of predetermined symbols referred to as scatter symbols are shown on the display window DW regardless of their positions, even if they are scattered on the display window DW. The one or more scatter symbols shown on the display window DW may form another winning combination.

The symbols SB may include ordinary symbols and special symbols, and the special symbols may include bonus symbols and function symbols, for example. The ordinary symbols may form a line win. A predetermined number of the bonus symbols on the display window DW may trigger a bonus mode or a free mode of the game. According to an embodiment of the present invention, the bonus symbols may serve as scatter symbols. The function symbols may include multiplier symbols multiplying a given win prize, effect symbols used in effects of a game, determinant symbols determining the number of free rounds in a free mode of a game, adder symbols adding extra free rounds, and so on. The symbols SB may further include blank symbols. However, the function of the function symbols is not limited thereto.

According to an embodiment of the present invention, the ordinary symbols and the bonus symbols may be disposed on the basic reels BR1-BR4, and the function symbols may be disposed on the extra reel ER. The blank symbols may be disposed on both basic reels BR1-BR4 and the extra reel ER. Hereinafter, the symbols SB on the basic reels BR1-BR4 will be referred to as “basic symbols,” and the symbols SB on the extra reel ER will be referred to as “extra symbols.” In addition, the ordinary symbols and the bonus symbols may be sometimes referred to as “win-determining symbols” hereinafter.

The extra reel ER may move solely or together with the basic reels BR1-BR4 when the above-described predetermined condition for moving the extra reel ER is satisfied.

According to an embodiment of the present invention, the extra reel ER may start movement before the basic reels BR1-BR4 stop their movements when the extra reel ER moves together with the basic reels BR1-BR4. For example, the extra reel ER may start movement along with the basic reels BR1-BR4. According to an embodiment of the present invention, the extra reel ER may stop the movement in a manner similar to the basic reels BR1-BR4. According to another embodiment of the present invention, the extra reel ER may stop its movement before any of the basic reels BR1-BR4 stops their movements or after all the basic reels BR1-BR4 stop their movements. According to an embodiment of the present invention, the basic reels BR1-BR4 may stop the movement in sequence. For example, a first basic reel BR1, a second basic reel BR2, a third basic reel BR3, and a fourth basic reel BR4, which are arranged in sequence from left to right, may stop their movements in sequence.

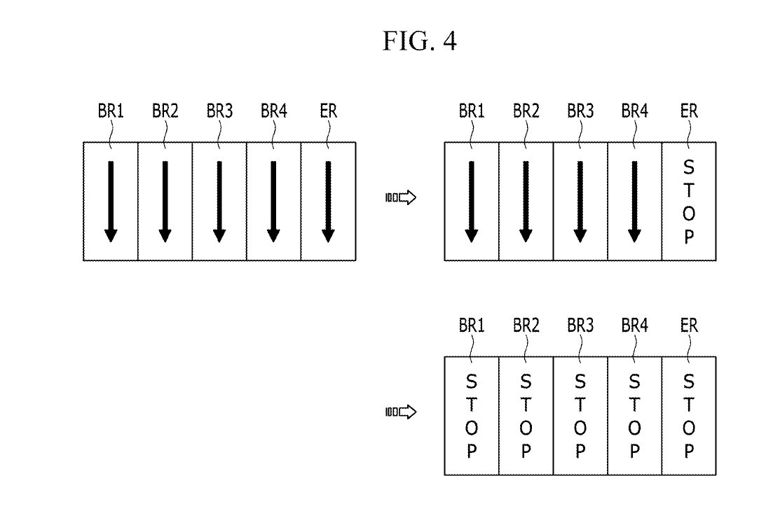

For example, referring to FIG. 3, the extra reel ER may start spinning substantially simultaneously with the basic reels BR1-BR4, and may stop spinning after all the basic reels BR1-BR4 stop spinning Referring to FIG. 4, the extra reel ER may start spinning substantially simultaneously with the basic reels BR1-BR4, and may stop spinning before any of the basic reels BR1-BR4 stops spinning.

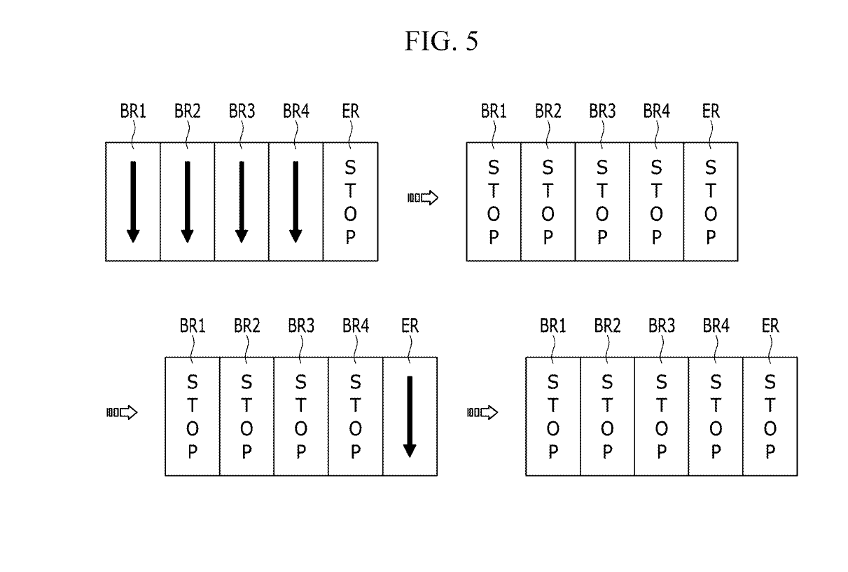

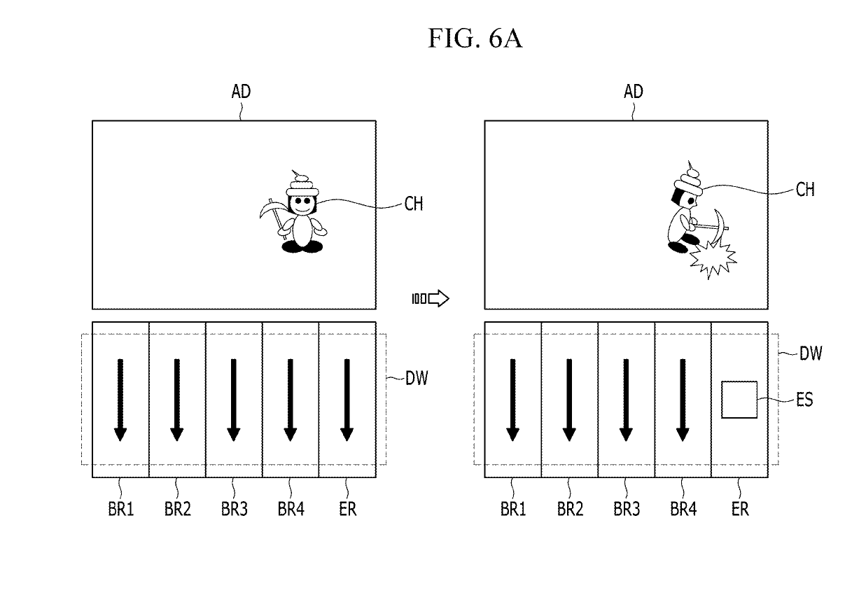

According to an alternative embodiment of the present invention, the extra reel ER may start movement after the basic reels BR1-BR4 start and stop movement. For example, referring to FIG. 5, the basic reels BR1-BR4 may start and stop spinning while the extra reel ER is at rest. Thereafter, the extra reel ER may start and stop spinning after the basic reels BR1-BR4 stop their spinning and are at rest.

However, the movements of the basic reels BR1-BR4 and the extra reel ER are not limited thereto. For example, the extra reel ER may start and stop movement before the basic reels BR1-BR4 start movement.

Referring to FIG. 1 again, the auxiliary display AD may be configured to display images related to a game being executed by using the symbol display SD. According to an embodiment of the present invention, visual effects for the game may be shown on the auxiliary display AD. According to an embodiment of the present invention, the images displayed by the auxiliary display AD may include a character CH.

According to an embodiment of the present invention, the images displayed by the auxiliary display AD may vary depending on the movement of the reels RL or depending on the symbols SB shown by the display window DW of the symbol display SD. For example, the behavior of the character CH shown on the auxiliary display AD may vary depending on a symbol on the extra reel ER shown by the display window DW or on the movement of the extra reel ER. According to an embodiment of the present invention, the effect symbols on the extra reel ER may include a visual effect symbol that may affect the behavior of the character. FIG. 6A shows that the character CH, which carries a pickaxe with its right hand in an ordinary state, strikes the ground or the extra reel ER when a visual effect symbol ES on the extra reel ER is shown in the display window DW.

On the contrary, according to an embodiment of the present invention, the movement of the reels RL, for example, the movement of the extra reel ER may vary depending on the images displayed by the auxiliary display AD. For example, an action of the character CH shown on the auxiliary display AD may trigger the extra reel ER to move or spin. FIG. 6B shows that the extra reel ER starts spinning in response to the striking action of the character CH.

The input unit IN includes a plurality of buttons BT, for example, a bet button B1 and a spin button B2 that are operable by a player. The bet button B1 is used for betting on a game, and the spin button B2 is used for spinning the reels RL to get a new arrangement of the symbols SB (or for starting the game).

The controller CN receives inputs from the input unit IN and controls the symbol display SD with the symbols SB in response to inputs from the input unit IN.

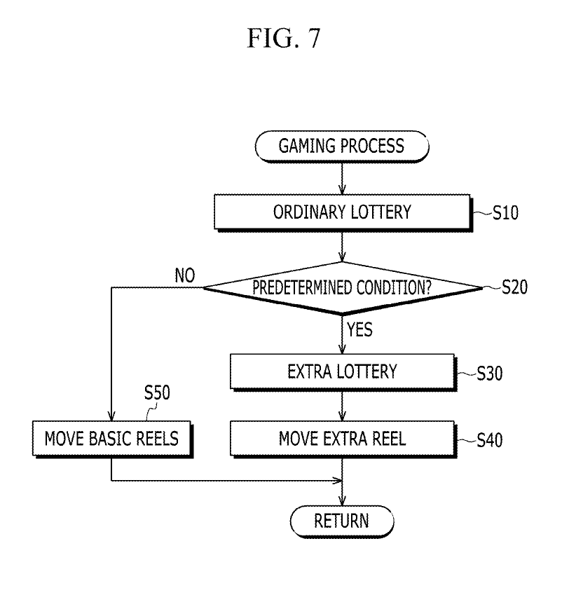

Now, a gaming method using a gaming machine including basic reels and an extra reel according to an embodiment of the present invention is described in detail with reference to FIG. 7.

FIG. 7 is a schematic flow chart illustrating a gaming method using a gaming machine including basic reels and an extra reel according to an embodiment of the present invention.

Referring to FIG. 7, at a beginning of a game round, the controller CN of the gaming machine GM executes an ordinary lottery using the basic reels BR1-BR4 (S10). According to an embodiment of the present invention, the ordinary lottery may determine a win or a loss of a game round. For example, the ordinary lottery may determine a symbol arrangement including a group of basic symbols selected from the basic symbols on the basic reels BR1-BR4. When the symbol arrangement includes at least one winning combination, the game round may be determined to be won. However, when there is no winning combination in the symbol arrangement, the game round may be determined to be lost. The determination of the symbol arrangement may be performed by using a predetermined symbol code table, for example, by using a random number generator (not shown).

The controller CN of the gaming machine GM may make the symbol display SD display a plurality of symbols SB before starting the game round, and the controller CN may execute the ordinary lottery in response to inputs from a player. The inputs from the player may include an input from the bet button B1 and another input from the spin button B2 shown in FIG. 1. The player may determine a bet amount by pressing the bet button B1, and starts the game round by pressing the spin button B2.

Thereafter, the controller CN may determine whether a predetermined condition for moving the extra reel ER is satisfied (S20). The predetermined condition may include a predetermined result of a separate lottery irrelevant of the ordinary lottery using the basic reels BR1-BR4. The determination of the satisfaction of the predetermined condition may be performed before the ordinary lottery.

According to an alternative embodiment of the present invention, the predetermined condition may include a predetermined result of the ordinary lottery.

When it is determined that predetermined condition for moving the extra reel ER is satisfied (S20: YES), the controller CN may execute an extra lottery using the extra reel ER (S30). A result of the extra lottery may modify a result of the ordinary lottery or may affect a moving pattern of the extra reel ER and/or a moving pattern of the basic reels BR1-BR4. The extra lottery may be also used in determining or changing the number of free rounds in a free mode.

According to an embodiment of the present invention, the result of the extra lottery may be advantageous or at least may not be disadvantageous to a player. For example, the result of the extra lottery may not change a win or a loss of a game round, may not decrease a win prize of the game round, and may not decrease the number of free rounds in a free mode. For example, the extra lottery may select a function symbol among the extra symbols on the extra reel ER. Among the above-described function symbols, multiplier symbols multiplying a given win prize, determinant symbols determining the number of free rounds in a free mode of a game, and adder symbols adding extra free rounds may be used in the extra lottery. The effect symbols may not be used in the extra lottery. The selection of the function symbol may be performed by using a predetermined symbol code table, for example, by using a random number generator (not shown).

According to an embodiment of the present invention, the controller CN may perform an additional lottery to determine a rendering effect pattern based on which the reels RL and the character image CH move. The effect symbols may be used in conducting a rendering effect.

After executing the extra lottery, the controller CN may move and stop the extra reel ER to show a result of the extra lottery (S40). According to an embodiment of the present invention, the selected function symbol on the extra reel ER may be shown on the display window DW as the result of the extra lottery.

When it is determined that the predetermined condition for moving the extra reel ER is not satisfied (S29: NO), the controller CN may move and stop the basic reels BR1-BR4 but not the extra reel ER to show a result of the ordinary lottery (S50). According to an embodiment of the present invention, the determined symbol arrangement on the basic reels BR1-BR4 may be shown on the display window DW as the result of the ordinary lottery.

The results of the ordinary lottery and the extra lottery may affect the movements of the extra reel ER and the movement of the basic reels BR1-BR4. The movement of the extra reel ER and the movement of the basic reels BR1-BR4 may be performed independently or may be performed depending on each other.

According to an embodiment of the present invention, the controller CN may calculate and payout a total win prize based on the results of the ordinary lottery and the extra lottery after spinning and stopping the basic reels BR1-BR4 and/or the extra reel ER. When the result of the extra lottery changes a basic win prize provided by the ordinary lottery, the win prize may be performed in consideration thereof.

Mechanical Structure of Gaming Machine

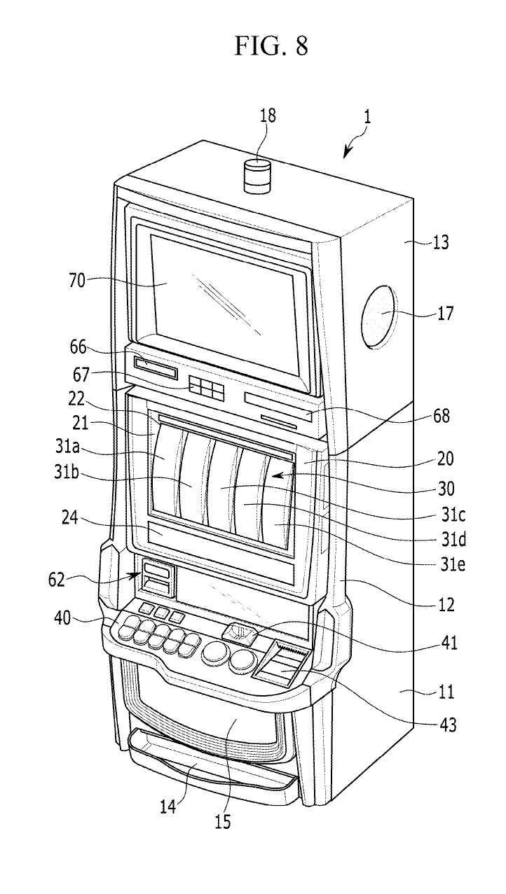

A mechanical structure of a gaming machine according to an embodiment of the present invention is described in detail with reference to FIG. 8 to FIG. 19.

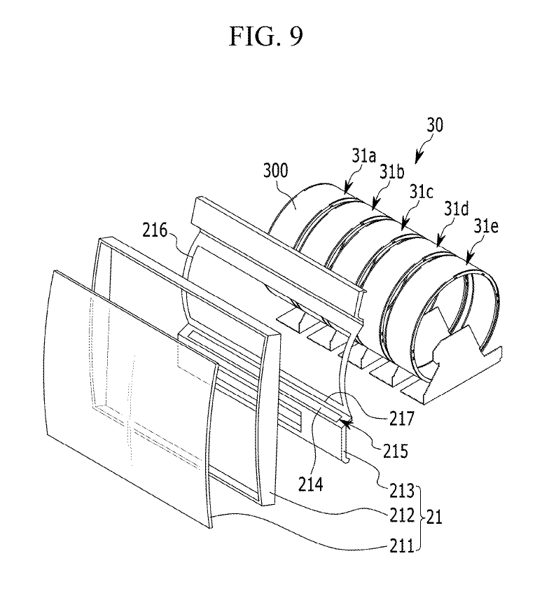

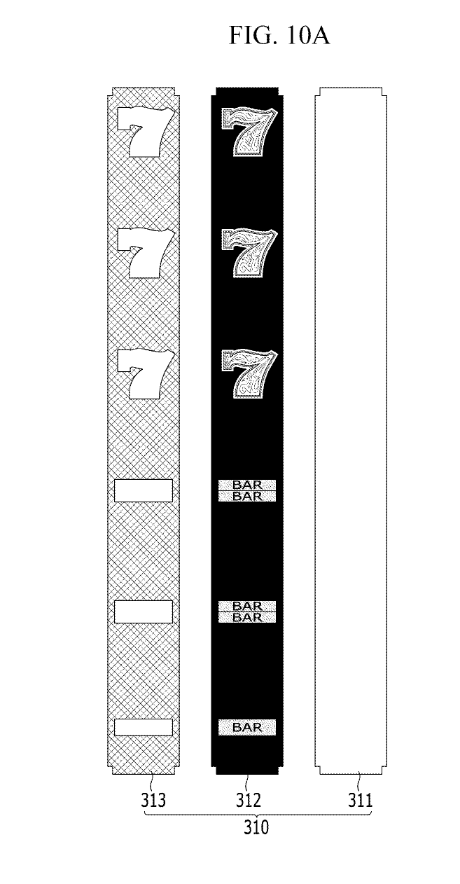

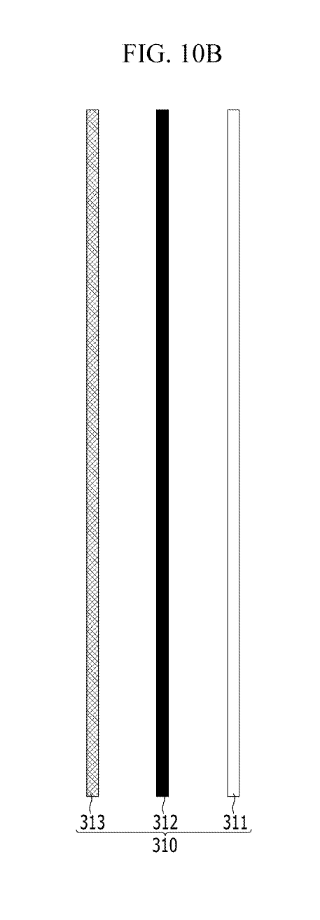

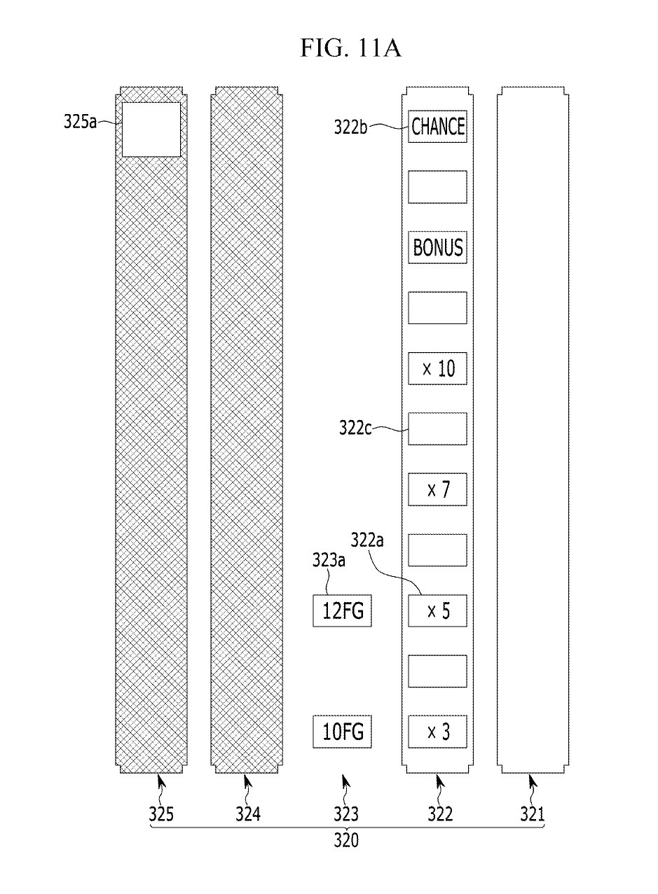

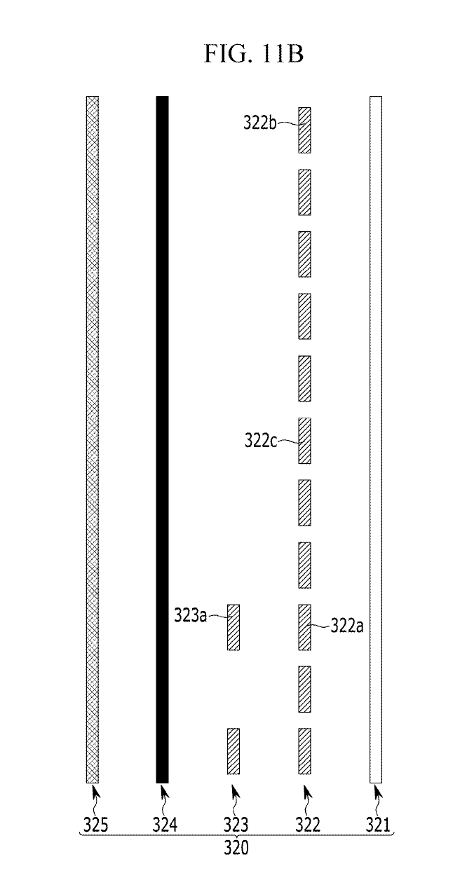

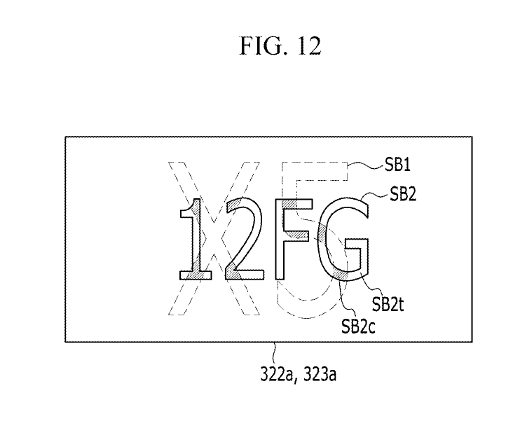

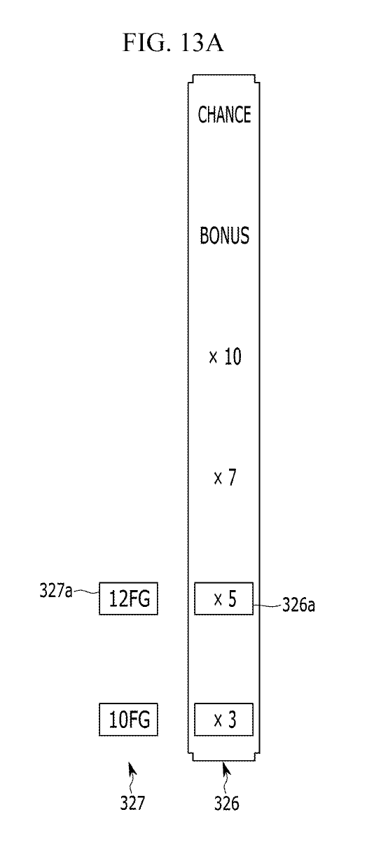

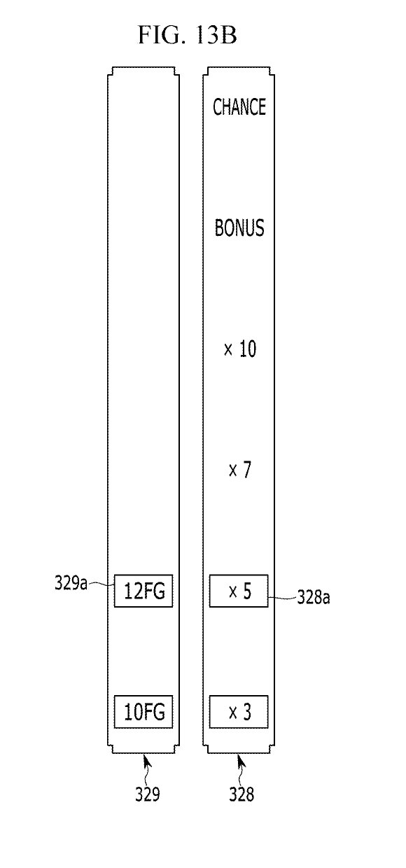

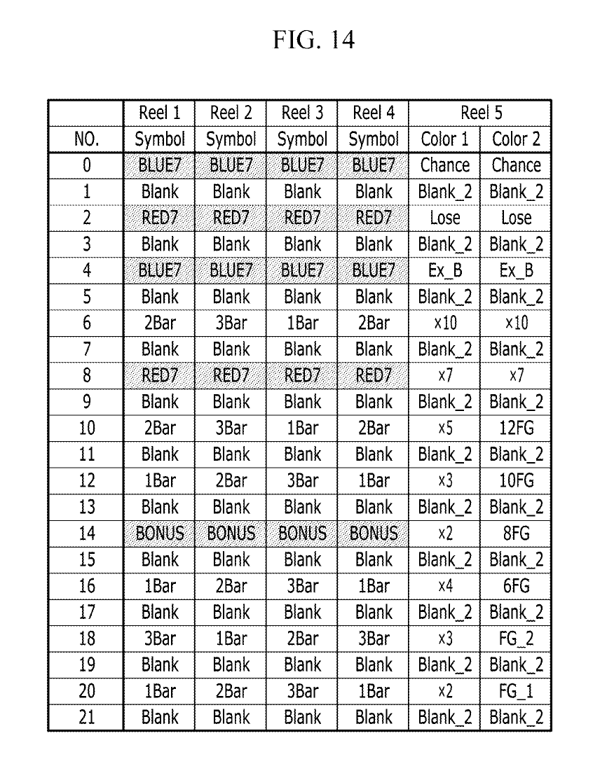

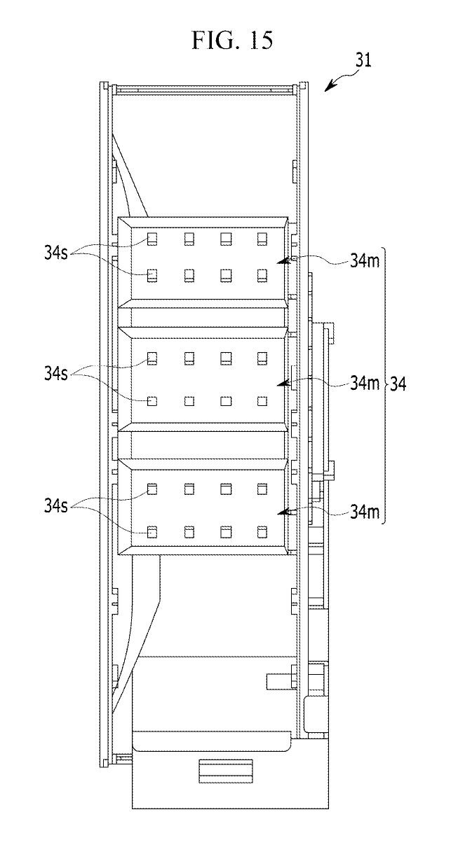

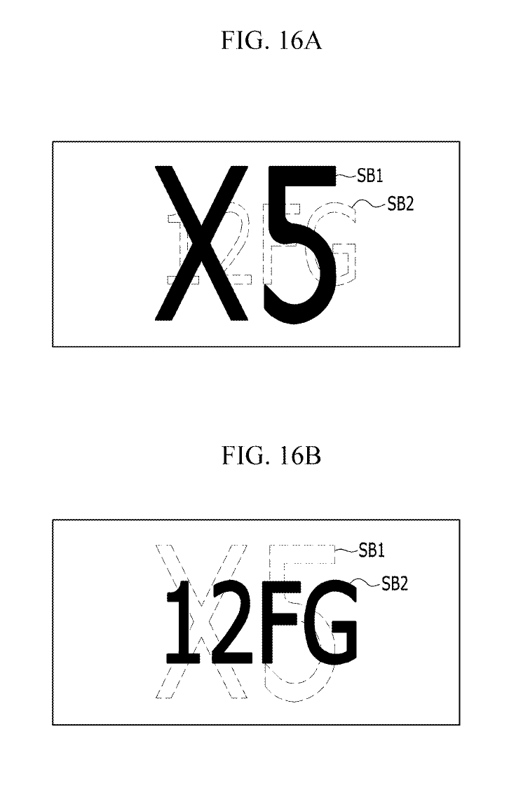

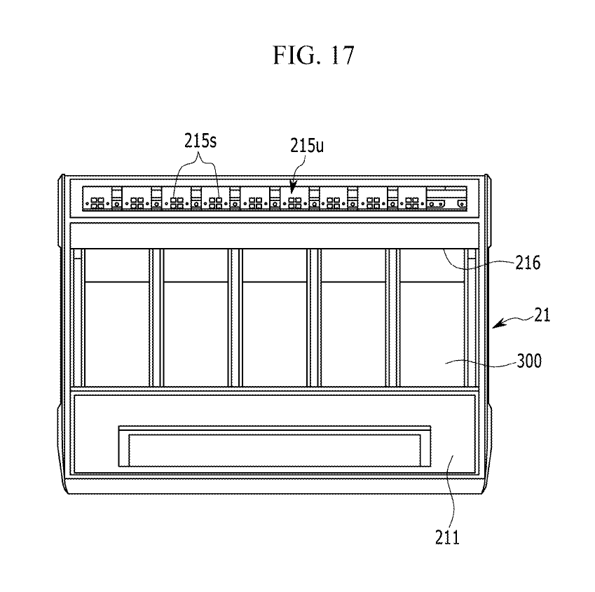

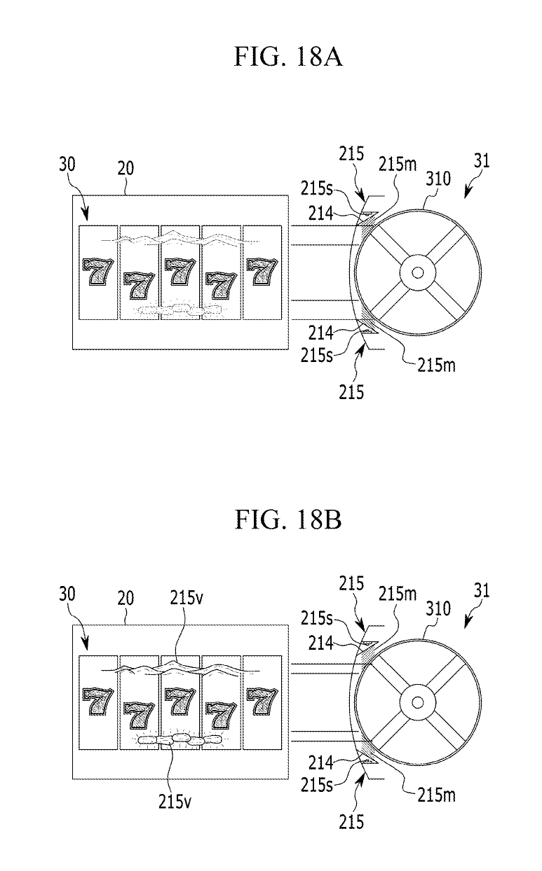

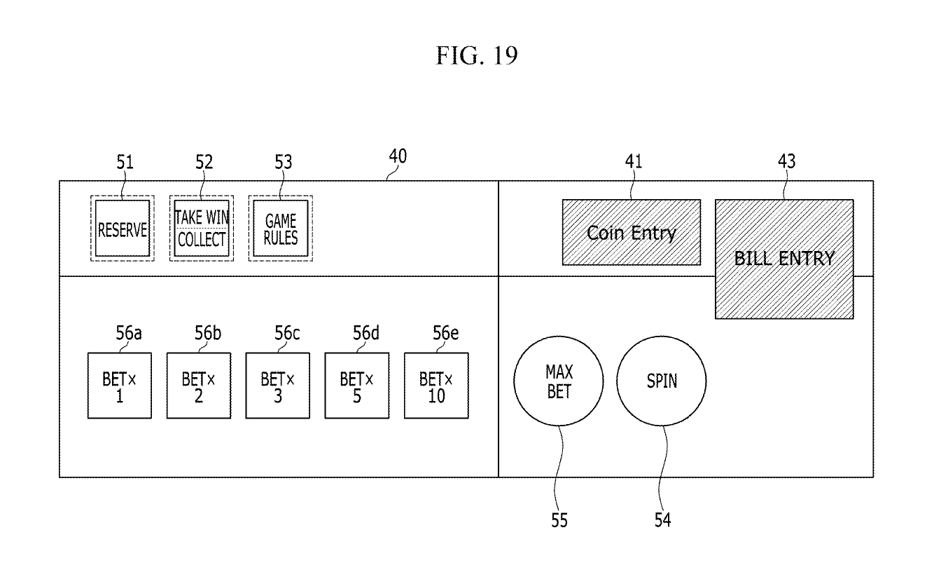

FIG. 8 is a schematic perspective view of a slot machine according to an embodiment of the present invention, FIG. 9 is a schematic perspective view of a reel assembly and a reel cover according to an embodiment of the present invention, FIG. 10A is a schematic exploded plan view of a reel strip according to an embodiment of the present invention, FIG. 10B is a schematic exploded sectional view of the reel strip shown in FIG. 10A, FIG. 11A is a schematic exploded plan view of a reel strip according to another embodiment of the present invention, FIG. 11B is a schematic exploded sectional view of the reel strip shown in FIG. 11A, FIG. 12 is a schematic plan view of color sheets overlapping each other according to an embodiment of the present invention, FIG. 13A and FIG. 13B are schematic exploded plan views of a reel strip according to other embodiments of the present invention, FIG. 14 is a symbol code table according to an embodiment of the present invention, FIG. 15 is a schematic front view of a reel and a backlighting unit according to an embodiment of the present invention, FIG. 16A and FIG. 16B shows a reel strip illuminated with different color lights according to an embodiment of the present invention, FIG. 17 shows a schematic diagram of a reel assembly including a light illuminator according to an embodiment of the present invention, FIG. 18A and FIG. 18B show operations of reel strips and a light illuminator according to an embodiment of the present invention, and FIG. 19 is a layout view of a control panel according to an embodiment of the present invention.

Referring to FIG. 8, a gaming machine, for example, a slot machine 1 according to an embodiment of the present invention includes a cabinet 11, a main door 12, a top box 13, a primary display 20, a secondary display 70, a third display 24, a control panel 40, a speaker 17, and a lamp 18.

The cabinet 11 receives several parts of the slot machine 1. The main door 12 is disposed in front of the cabinet 11, and may be coupled to the cabinet 11. The top box 13 is disposed on the cabinet 11, and may be detachably coupled to the cabinet 11.

The primary display 20 is provided in the main door 12, and includes a reel assembly 30 and a reel cover 21. The reel assembly 30 includes a plurality of, for example, five reels 31a-31e. The reel cover 21 is disposed in front of the reel assembly 30, and has a display window 22 that exposes front portions of the reels 31a-31e to be shown to a player.

The reels 31a to 31e includes first to fourth basic reels 31a, 31b, 31c and 31d and an extra reel 31e. The reels 31a-31e is rotatable around a common rotational axis, and includes a plurality of symbols arranged thereon.

Some of the symbols on the reels 31a to 31e are shown through the display window 22, and the other of the symbols may be hidden. According to an embodiment of the present invention, three symbols on each of the reels 31a and 31b may be shown through the display window 22. A set of symbols on the basic reels 31a-31d, which are shown through the display window 22, form a symbol arrangement. The symbols in the symbol arrangement may be arranged in a matrix including rows and columns A series of consecutive symbols on the extra reel 31e, which are shown by the display window 22, form an extra symbol column. According to an embodiment of the present invention, a symbol arrangement may include twelve symbols arranged in a 3×4 matrix on the basic reels 31a-31e, and an extra symbol column includes three consecutive symbols on the extra reel 31e.

Referring to FIG. 9, each of the reels 31a to 31e includes a reel strip 300 on its periphery, and the reel strip 300 includes the symbols thereon. Various structures of the reel strip 300 according to example embodiments of the present invention are shown in FIG. 10A to FIG. 13B.

Referring to FIGS. 10A and 10B, a reel strip 310 according to an embodiment of the present invention may include, for example, a base layer 311, a symbol layer 312, and a reflective layer 313, which are stacked in sequence. A base layer 311 may be an innermost layer and may include polyethylene terephthalate (PET), for example. The symbol layer 312 may be an intermediate layer and may be a black sheet including a plurality of transparent symbols printed thereon. The reflective layer 313 may be an outermost layer, and may be at least partially reflective (or translucent) or fully reflective. The reflective layer 313 may have a plurality of openings that expose the symbols on the symbol layer 312.

According to an embodiment of the present invention, the reel strip 310 may further include a transparent protection layer (not shown) disposed on the reflective layer 313. According to an embodiment of the present invention, the reel strip 310 may further include a hazy layer (not shown) disposed on the reflective layer 313.

Referring to FIGS. 11A and 11B, a reel strip 320 according to an embodiment of the present invention may include, for example, a base layer 321, a first symbol layer 322, a second symbol layer 323, a translucent layer 324, and a hazy layer 325, which are stacked in sequence.

A base layer 321 may be an innermost layer and may include PET, for example.

The symbol layers 322 and 323 may be disposed on the base layer 321, and each of the symbol layers 322 and 323 may include a plurality of translucent (or transparent) color sheets 322a-322c and 323a arranged in series. Some 322a, 322b and 323a of the color sheets 322a-322c and 323a may include symbols printed thereon while the other 322c of the color sheets 322a-322c and 323a may be blank. The symbols printed on the color sheets 322a, 322b and 323a may be colorlessly transparent or translucent in general. However, the symbols may have some colored portions.

Some 322a of the color sheets 322a-322c in the first symbol layer 322 may overlap the color sheets 323a in the second symbol layer 323. The color of the color sheets 322a in the first symbol layer 322 may be different from the color of the color sheets 323a in the second symbol layer 323. According to an embodiment of the present invention, the color of the color sheets 322a in the first symbol layer 322 may be green while the color of the color sheets 323a in the second symbol layer 323 may be red. According to an embodiment of the present invention, the color of the color sheets 322a in the first symbol layer 322 may be entirely green. According to an embodiment of the present invention, portions of a color sheet 322a disposed near the symbol may be green, and peripheral portions of the color sheet 322a may be blue. According to an embodiment of the present invention, the color of a color sheet 323a in the second symbol layer 323 may be entirely red. According to an embodiment of the present invention, a symbol on the color sheet 323a may include colorless transparent portions and colored portions, and the colored portions may have the same color as the color sheets 322a in the first symbol layer 322.

Referring to FIG. 12, a first color sheet 322a in the first symbol layer 322 and a second color sheet 323a in the second symbol layer 323 may overlap each other. In detail, the second color sheet 323a having a red background color is disposed on the first color sheet 322a having a green background color. The first color sheet 322a may include a first symbol SB1 denoted by “×5,” and the second color sheet 323a may include a second symbol SB2 denoted by “12FG” The second symbol SB2 may include colorless transparent portions SB2t and colored portions SB2c. The colored portions SB2c may overlap the first symbol SB1, and may be green like the background color of the first color sheet 322a.

Referring to FIGS. 11A and 11B again, the translucent layer 324 may be disposed on the second symbol layer 323, and may be translucent and partially reflective such that the translucent layer 324 may transmit internal light from the symbol layers 322 and 323 and may reflect external light from the hazy layer 325.

The hazy layer 325 may be an outermost layer, and may be fully reflective or at least half reflective. The hazy layer 325 may have an opening 325a overlapping a symbol on one of the color sheets 322a-322c and 323a inn the symbol layers 322 and 323 such that the symbol overlapping the opening 325a is visible to a player more clearly than other symbols. FIG. 11A and FIG. 11B show that the opening 325a overlaps a symbol 322b denoted by “Chance,” and the “Chance” symbol 322b may be predominant compared with other symbols. The hazy layer 325 may be omitted.

According to an embodiment of the present invention, the reel strip 320 may further include a protection layer (not shown) disposed on the hazy layer 325.

The structure of the reel strip 320 may be modified, examples of which are described with reference with reference to FIG. 13A and FIG. 13B.

Referring to FIG. 13A, the color sheets 322a-322c in the first symbol layer 322 shown in FIG. 11A and FIG. 11B may be integrated into the base layer 321 to form a single-sheet layer 326. The single-sheet layer 326 may include a plurality of translucent (or transparent) colored areas 326a corresponding to the color sheets 322a. The symbols on the color sheets 323b may be directly printed on the single-sheet layer 326, and the blank color sheets 323 may correspond to margins between adjacent symbols and colored regions of the single-sheet layer 326.

Referring to FIG. 13B, as well as integrating the color sheets 322a-322c in the first symbol layer 322 shown in FIG. 11A and FIG. 11B into the base layer 321 to form a first single-sheet layer 328 like the embodiment shown in FIG. 13A, the color sheets 323a in the second symbol layer 323 shown in FIG. 11A and FIG. 11B may be integrated into a substrate layer to form a second single-sheet layer 329. The substrate layer may be substantially the same as the base layer 321 shown in FIG. 11A and FIG. 11B.

According to an embodiment of the present invention, the reel strip 310 shown in FIGS. 10A and 10B may be included in the basic reels 31a-31d, and the reel strip 320 shown in FIGS. 11A to 11B, 13A and 13B may be included in the extra reel 31e.

An exemplary symbol code table is shown in FIG. 14, and the symbol code table includes a code number denoted by “NO.” and symbol names for each reel 31.

The basic reels 31a-31d denoted by Reel 1, Reel 2, Reel 3, and Reel 4 may include ordinary symbols, bonus symbols, and blank symbols. The ordinary symbols may include symbols denoted by “BLUE7,” “RED7,” “1BAR,” “2BAR,” and “3BAR.” The bonus symbol may be denoted by “BONUS,” and the blank symbol may be denoted by “Blank.” The blank symbols denoted are disposed in turn with other symbols.

The symbols on the extra reel 31e denoted by Reel 5 may include function symbols. The function symbols may include multiplier symbols denoted by “×2,” “×3,” “×4,” “×5,” “×7,” and “×10,” effect symbols denoted by “Chance,” “Ex_B,” and “Lose,” determinant symbols denoted by “6FG,” “8FG,” “10FG,” and “10FG,” adder symbols denoted by “FG_{—}1” and “FG_{—}2,” and blank symbols denoted by “Blank_{—}2.”

As described above, the multiplier symbols may multiplies a basic win prize. For example, the symbol denoted by “×5” may provide a total win prize equal to five times the basic win prize.

The effect symbols may be used in rendering effects or visual effects of a game. For example, the “Chance” symbol may inform that the extra reel 31e will rotate again and stop to show a multiplier symbol, for example, with a high multiplier value such as “×7,” or “×10 so that a player may expect a high win prize. In addition, the “Chance” symbol may inform that the basic reels 31a-31d will show a predetermined number or more of “BONUS” symbols that may trigger or retrigger a bonus mode or a free mode. The “Ex_B” symbol may inform that a bonus mode or a free mode is triggered, and the “Lose” symbol may be used in informing of a loss of a game round. The “Lose” symbol may have no actual image like the blank symbols and may be also used as an origin.

The determinant symbols may be used in determining the number of free rounds in a free mode of the game. For example, a player may obtain ten free game rounds when the symbol denoted by “10FG” is shown to the player.

The adder symbols may provide extra free rounds in a free mode. For example, a player may be provided two additional free rounds when the symbol denoted by “FG_{—}2” is shown to the player.

The blank symbols denoted by “Blank_{—}2” are disposed in turn with other function symbols. When the “Lose” symbol has no actual image like the blank symbols and the “Lose” symbol is disposed at a center row of the display window 22, no symbol image is shown on the extra reel 31e.

According to an embodiment of the present invention, the blank symbols Blank_{—}2 on the extra reel 31e may not be shown at the center row of the display window 22 although the blank symbols Blank on the basic reels may be allowed to be shown at the center row of the display window 22.

The symbols on the extra reel 31e has two sets of the function symbols under titles “Color 1” and “Color 2.” A first set of the function symbols entitled “Color 1” may include symbols denoted by “Chance” (Code number 0), “Lose” (Code number 2), “Ex_B” (Code number 4), “×10” (Code number 6), “×7” (Code number 8), “×5” (Code number 10), “×3” (Code number 12), “×2” (Code number 14), “×4,” (Code number 16), “×3” (Code number 18), and “×2” (Code number 20). A second set of the function symbols entitled “Color 2” may include symbols denoted by “Chance” (Code number 0), “Lose” (Code number 2), “Ex_B” (Code number 4), “×10” (Code number 6), “×7” (Code number 8), “12FG” (Code number 10), “10FG” (Code number 12), “8FG” (Code number 14), “6FG,” (Code number 18), “FG_{—}2” (Code number 18), and “FG_{—}1” (Code number 20). The first set and the second set of the function symbols commonly include the symbols denoted by “Chance” (Code number 0), “Lose” (Code number 2), “Ex_B” (Code number 4), “×10” (Code number 6), and “×7” (Code number 8).

Referring to FIGS. 11A and 11B again, the first set of the function symbols may be disposed on the first symbol layer 322 of the reel strip 320, and the second set of the function symbols except for the commonly owned symbols of Code numbers 0, 2, 4, 6 and 8 may be disposed on the second symbol layer 323.

Referring to FIG. 15, at least one reel 31 of the reels 31a-31e may include a backlighting unit 34 that illuminates the reel strip 300 from an inside of the reel 31. The backlighting unit 34 is provided at the inner peripheral side of the reel 31 structured as described above. The backlighting unit 34 is provide so that illumination light is emitted from the inner peripheral side of the reel 31 in the direction of the reel strip 300, and the illumination light passed through the reel strip 300 is visible from outside of the gaming machine 1. Thus, a player recognizes the symbol as being displayed on the reel strip 300.

The backlighting unit 34 is provided for corresponding to the reel 31, which is not accurately shown in the figure. As shown in FIG. 15, the backlighting unit 34 includes a unit composed of a plurality of modules 34m (three in the present embodiment) in which a plurality of light sources 34s is arranged in matrix. Each of the light sources 34s is a full-color LED in which a red LED element capable of emitting red light, a blue LED element capable of emitting blue light, and a green LED element capable of emitting green light are packaged. In each of the light sources 34s, a controller controls the lighting and extinguishing of the red LED element, the blue LED element, and the green LED element, and the individual amount of light at the time of lighting for each LED element. More specifically, the light source 34s can form a visible light with an arbitrary color by adjusting the amount of light of each of the LED elements.

For example, referring to FIG. 16A and FIG. 16B, the first symbol SB1 is displayed in red by receiving the irradiation with red light, and the second symbol SB2 is displayed in green by receiving the irradiation with green. Therefore, each of the light sources 34s controls the light emission status so as to light the red LED element and extinguish the other LED elements when displaying the first symbol SB1, and so as to light the green LED element and extinguish the other LED elements when displaying the second symbol SB2.

Referring to FIG. 9 again, the reel cover 21 may include a transparent panel 211, a panel frame 212, a panel support 213, a light transmission panel 214, and a light illuminator 215. The transparent panel 211 is provided in front of the panel frame 212, and the panel frame 212 is supported by the panel support 213. The panel support 213 has a large rectangular opening 216 and a pair of long rectangular openings 217. The large opening 216 corresponds to the display window 22 and exposes a portion of the reel assembly 30 to be seen by a player. The pair of long openings 217 are disposed opposite each other near lower and upper edges of the large opening 216.

The light illuminator 215 is provided in each of the openings 217, and is configured to illuminate visible light toward the large opening 216. Referring to FIG. 17, FIG. 18A, and FIG. 18B, the light illuminator 215 for emitting visible information 215v toward each of the reels 31 of the reel assembly 30 is arranged. The light illuminator 215 is arranged at the upper position and the lower position of the reel assembly 30 that is provided with the plurality of reels 31. Thus, the light illuminator 215 is arranged at the position out of the line of sight region in which a player can visibly recognize the reels 31 from outside of the cabinet 11 through a large opening 216. The light illuminator 215 makes it possible to carry out the effect in the large opening 216 by reflected light of the visible light 215m irradiated on each of the reels 31, as in the case of carrying out the effect in the large opening 216 by means of the transparent liquid crystal panel and a half mirror arranged in front of the reels 31. Therefore, the light illuminator 215 makes it possible to carry out the effect in the large opening 216 without saving the space for arranging the transparent liquid crystal panel and the like in front of each of the reels 31.

In addition, the light illuminator 215 may be arranged at least one of the upper position and the lower position of the reel assembly 30. More specifically, the light illuminator 215 may be structured to be arranged in the outer side region of at least one of the upper position and the lower position relative to the large opening 216, and to emit the visible light 215m that is longer than the width of all of the reels 31 supported by the reel assembly 30.

The light illuminator 215 is also provided in the reel cover 21 that acts as the front wall on the side of the large opening 216. The light illuminator 215 and the reel cover 21 are combined as a single unit. Therefore, the light illuminator 215 can be attached simultaneously with the attachment of the reel cover 21 to the cabinet 11.

In addition, the light illuminator 215 is set to emit the visible light 215m on the surface of the reel assembly 30. In other words, it is set to emit the visible light 215m to the region at the side of non-effective range except for the effective range of the symbol.

More specifically, the light illuminator 215 has a the light transmission panel 214 (a translucent member) provided at the opening 217 of the panel support body 1343, and the light source 215s that emits the visible light 215m. The light transmission panel 214 is tinted so as to form visible information 215v with a predetermined color by passing the visible light 215m therethrough. The light transmission panel 214 has substantially same dimension as the width of the reel assembly 30. Furthermore, the light source 215s is formed to emit the visible light 215m across the entire width of the light transmission panel 214.

The light source 215s has a plurality of full-color LEDRs, which is the structure similar to that of the light source 34s of the backlighting unit 34. These full-color LEDRs are aligned in the width and depth directions to form a matrix. More specifically, as shown in FIG. 17, the light source 215s is structured so that an LED unit 215u is provided in which two pairs of four full-color LEDRs 215s aligned in two rows and two columns are arranged in the direction of the width of the reel strip 300, and the LED unit 215u is arranged to correspond to each of the reels 31. Thus, the control of the position of lighting the full-color LEDs makes it possible to adjust the position of emitting light to the reel assembly 30.

The light source 215s selectably emits the visible light 215m that is a complementary color to the tint of the light transmission panel 214, and the visible light 215m which has a color other than that complementary color. More specifically, if the light transmission panel 214 is tinted red, the visible light 215m in green that is a complementary color to red and the visible light 215m in red other than green are selectably emitted. Thus, the light illuminator 215 switches the visible light 215m with the complementary color and the visible light 215m with the color other than the complementary color, so that it is possible to disable or enable the showing of the visible information 215v (pictures of mountains and gold ores) on the reels 31 as shown in FIG. 18A and FIG. 18B.

In addition, the light source 215s of the present embodiment makes it possible to easily form the visible light 215m with the color as being the complementary color and the visible light 215m with the color other than the complementary color by means of a single full-color LED. However, it is not limited to the full-color LED, but it can be formed by an LED with a single color for outputting the visible light 215m with the complementary color and an LED with a single color for outputting the visible light 215m with the color other than the complementary color.

Referring to FIG. 8 again, the primary display 20 may be disposed on an upper part of the main door 13, and may include an LCD panel or an OLED panel. The primary display 20 may further include a touch screen panel that enables a player to interact with the gaming machine 1 by touching some areas on a screen.

The secondary display 70 displays images related to game information or images. The secondary display 70 may be disposed on a front surface of the top box 13 that may be provided on the cabinet 11, and may include a display panel, for example, a liquid crystal display (LCD) panel or an organic light emitting display (OLED).

Referring to FIG. 8 and FIG. 19, the control panel 40 includes a plurality of buttons 51-55 and 56a-56e, a coin entry 41, and a bill entry 43, and may be disposed below the primary display 20. The plurality of buttons 51-55 and 56a-56e may include a reserve button 51, a take win button (or collect button) 52, and a game-rules button (or help button) 53 that may be disposed on an upper stage of a left area of the control panel 40. The plurality of buttons 51-55 and 56a-56e may further include a plurality of m-bet buttons (m=1, 2, 3, 5, 10) (or bet×n buttons) 56a-56e that may be disposed at a lower stage of in a left area. The plurality of buttons 51-55 and 56a-56e may further include a start button (or repeat button) 54 and a max bet button 55 that may be disposed right to the m-bet buttons. The coin entry 41 and the bill entry 43 may be disposed upper to the max bet button 55 and the start button 54.

The reserve button 51 may be an operating button to be used when a player wants to leave a seat or when a player wants to request the staffs in a gaming facility to exchange money. The take win button 52 may be a cash-out button used to add the credit data relating to credits obtained in a variety of games to the credit data that is stored in the smart card or output the bill or the ticket corresponding to the total credits. The help button 53 may be a button to be used when a user does not clearly understand how to play a game or the like, and when the help button 53 is pressed, a variety of help information including game rules may be displayed on the primary display 20.

The 1-bet button 56a may be used when player's current credits are betted on a one-by-one basis for each winning payline every time the button is pressed. The m-bet button (m>1) 56b-56e may be a button for starting a game in m BETs for each winning payline. Therefore, a bet amount to for winning paylines may be determined by pressing any one of the m-bet button 56a-56e. If the player bets N BETs by pressing the N-bet button 56a-56e, default credits (for example 50 credits) of the winning paylines may be multiplied by N such that the multiplied credits are awarded to the player. Furthermore, the player can bet (N+M) BETs by pressing the N-bet button and the M-bet button in sequence. At this time, the gaming machine 1 may restrict an upper limit of the bet amount.

The max bet button 55 may be an operating button to be used when a maximum amount are betted.

The spin button 54 may be an operating button to be used when spinning the reels 31a-31e for starting a game.

The coin entry 41 may be configured to accept the coin in the cabinet 11. The bill entry may 43 be configured to validate whether the entered bill is legitimate or not and to accept a legitimate bill in the cabinet 11. Moreover, the bill entry 41 may accept the ticket having the barcode.

The gaming machine 1 may further include an integrated circuit (IC) card reader 62 disposed below the primary display 20. The IC card reader 62 receives an IC card which stores information of player identification and game log related with the games previously played by the player, for example. In addition, the IC card may store data equivalent to coins, bills, or credits owned by the player. The IC card reader 62 reads and writes data from and to the inserted IC card. The IC card reader 62 may include an LCD for displaying the data read from the IC card.

The gaming machine 1 further include a speaker 17 for outputting sound effects and a lamp 18 for light flashing.

Electronic Configuration of Gaming Machine

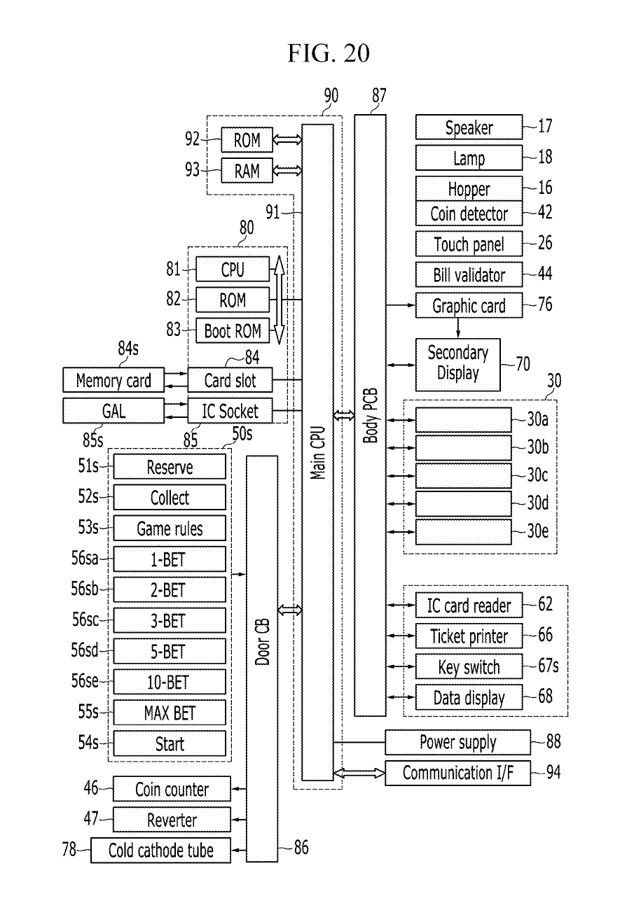

Next, a configuration of a circuit included in a gaming machine 1 will be described with reference to FIG. 20 to FIG. 22.

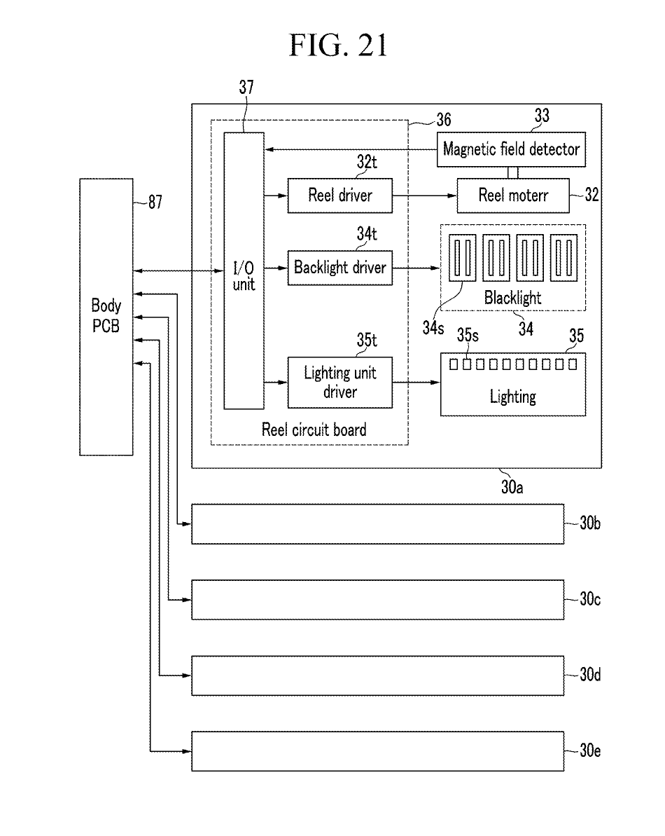

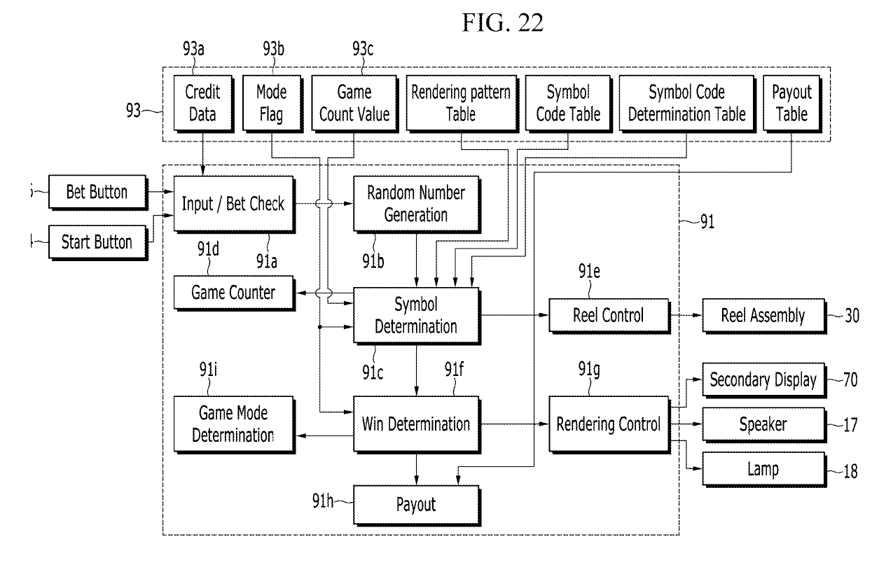

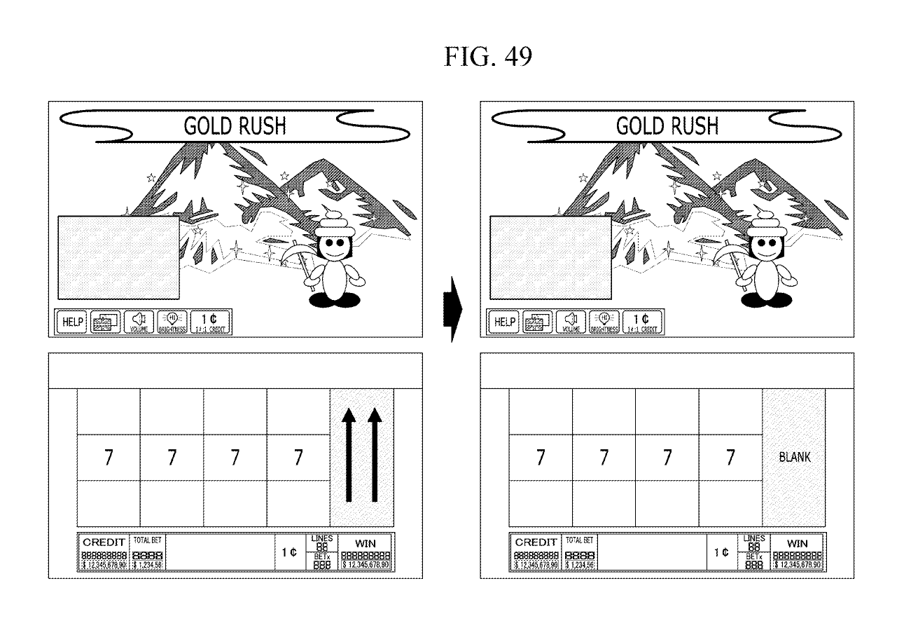

FIG. 20 is an electrical block diagram of the slot machine shown in FIG. 49 according to an embodiment of the present invention, FIG. 21 is a block diagram of an electrical circuit of the reel assembly according to an embodiment of the present invention, and FIG. 22 is a functional block diagram of the game program executed by a main CPU of a motherboard in the slot machine shown in FIG. 49 according to an embodiment of the present invention.

Referring to FIG. 20, the gaming machine 1 includes a gaming board 80, a motherboard 90, and a door PCB 86, and a body PCB 87.

A gaming board 80 includes a CPU 81, a ROM 82 accessible by the CPU 81 through an internal bus, and a boot ROM 83 accessible by the CPU 81 by an internal bus. The gaming board 80 additionally includes a card slot 84 which can receive and communicate with a memory card 84s, and an IC socket 85 provided correspondingly to a Generic Array Logic (GAL) 85s.

The memory card 84s includes a non-volatile memory and stores a game program and a game system program.

The card slot 84 is configured to receive and eject the memory card 84s, and is connected to a motherboard 90 by an IDE bus. The details of the game performed in the gaming machine 1 can be changed by replacing the memory card 84s with another one, or by withdrawing the memory card 84s from card slot 84, writing another program into the memory card 84s, and then inserting the memory card 84s into the card slot 84 again.

The GAL 85s, which is a type of a Programmable Logic Device (PLD) having a fixed OR array structure, has a plurality of input ports and output ports. When the GAL 85s receives certain data through the input ports, it outputs data corresponding to the input data through the output ports.

The IC socket 85 is configured in such a manner that the GAL 85s can be inserted into the IC socket 85 or detached from the IC socket 85, and connected to a motherboard 90 by a PCI bus.

The CPU 81, the ROM 82, and the boot ROM 83 interconnected by the internal bus are connected to the motherboard 90 by the PCI bus. The PCI bus enables signal transmission between the motherboard 90 and the gaming board 80, and supply of power from the motherboard 90 to the gaming board 80.

The ROM 82 stores an authentication program. The boot ROM 83 stores a preliminary authentication program, a boot code to be used by the CPU 81 for activating the preliminary authentication program, and the like. The authentication program is a tamper check program for authenticating the originality of the game program and the game system program. The preliminary authentication program is a program for authenticating the originality of the authentication program. The authentication program and the preliminary authentication program are written in a sequence of proving that the subject program has not been tampered.

The motherboard 90, which may be implemented using a commonly available general main board, executes the game program and the game system program. The motherboard 90 includes a main CPU 91, a ROM 92, a RAM 93, and a communication interface 94.

The ROM 92, which may be a flash memory, may be configured to store a program to be executed by the main CPU 91 such as BIOS, along with another data to be maintained permanently. When being executed by the main CPU 91, the BIOS performs initialization of peripheral devices. Also, the BIOS starts to load the game program and the game system program stored in the memory card 54 through the gaming board 80. The ROM 92 may be rewritable. However, write-protected one might be used as the ROM 92 as well.

The RAM 93 may store data and programs used in the operation of the main CPU 91. According to an embodiment of the present invention, the RAM 93 may store a game program, a game system program, and an authentication program to be loaded for executing a game. In addition, the RAM 93 may have a working space for executing the programs for the game. The working space may be used in storing the number of bets, a payout amount, a credit amount, and the like, which may be maintained during the execution of the game. Furthermore, a plurality of tables defining symbols, symbol codes, winning combinations, and their probabilities may be stored in the working space during the execution of the game. Moreover, the RAM 93 may store symbol code determination tables that stores mapping information between symbol codes and random numbers and may be used in determining symbols based on random numbers. The RAM 93 may further store a mode flag informing a gaming mode, along with a game and a game counter having a count value denoting the number of executed free rounds or the number of remaining free rounds.

According to an embodiment of the present invention, the RAM 93 may store count values of a plurality of counters or meters that include a bet meter, a payout amount meter, a credit meter, and a free mode round counter that counts the number of free rounds. According to an alternative embodiment of the present invention, some of the count values may be stored in an internal register of the main CPU 91.

According to an embodiment of the present invention, the RAM 93 may store rendering pattern tables that determine patterns of rendering effects. Rendering effects may include movements of the reels 31a-31e, visual effects on the symbols, movements of the images on the secondary display 70, sound effects from the speaker 17, and so on.

The communication interface 94 may facilitate data communication of the main CPU 91 with an external controller, for example, a controller of a server through a communication channel.

In addition, the motherboard 90 is connected to the door PCB 86 and the body PCB 87 by USB communications, for example. The motherboard 90 is also connected to a power supply 88. The main CPU 91 of the motherboard 90 may boot up and operate using the power supplied from the power supply 88, and may pass over some of the power to the gaming board 80 through the PCI bus to boot up the CPU 81. The door PCB 86 and the body PCB 87 are connected to input devices such as switches and sensors and peripheral devices controlled by the main CPU 91. In addition, the door PCB 86 is connected to a control panel 40, a coin counter 46, a reverter 47, and a cold cathode tube 78.

The control panel 40 includes a reserve switch 51s, a collect switch 52s, a game rule switch 53s, a start switch 54s, a MAX BET switch 55a, a 1-BET switch 56sa, a 2-BET switch 56sb, a 3-BET switch 56sc, a 5-BET switch 56sd, and a 10-BET switch 56se, which are coupled to corresponding buttons 51 to 55 and 56a to 56e. The switches 51s to 54s and 56as to 56es may detect pressing of the respective buttons 51 to 55 and 56a to 56e to generate signals to be output to the main CPU 91.

The coin counter 46 and the reverter 47 may be disposed in the coin entry 41. The coin counter 46 may validate legitimacy of coins inserted into the coin entry 41 in terms of material, shape, or the like. The coin counter 46 may output a signal to the main CPU 91 when detecting a legitimate coin. Meanwhile, illegitimate coins may be discharged to the coin tray 15. The reverter 47, which may operate under the control of the main CPU 91, may distribute the legitimate coins validated by the coin counter 46 into either a hopper 16 or a cash box (not shown). The coins may be guided into the hopper 16 when the hopper 16 is not full. However, the coins may be guided into the cash box when the hopper 16 is filled with coins.

The cold cathode tube 78 may be disposed on the rear face of the secondary display 70, and may function as a backlight of the secondary display 70. The cold cathode tube may illuminate under the control of the main CPU 91.

The body PCB 87 is connected to the speaker 17, the lamp 18, the hopper 16, a coin detector 42, the touch panel 26, a bill validator 44, the reel assembly 30, the IC card reader 62, a graphic card 76, the ticket printer 66, a key switch 67s, and a data display 68.

The lamp 18 may flash lights under the control of the main CPU 91. The speaker 17 may make a sound including a background music under the control of the main CPU 91.

The hopper 16, which operates based upon a control signal from the main CPU 91, pays out coins of the designated payout amount to the coin tray 15 through a coin payout exit formed between the belly glass 14 and the coin tray 15. The coin detector 42 detects coins paid out from the hopper 16 to output a detection signal to the main CPU 91.

The touch panel 26 detects a position touched by the player to provide the main CPU 91 with a position sense signal corresponding to the detected position. The bill validator 44 in the bill entry 43 provides, upon detection of a legitimate bill, the main CPU 91 with a bill detection signal corresponding to the bill amount.

The graphic card 76 controls video display of the secondary display 70 and the display panel 24 of the primary display 20 in response to a control signal from the main CPU 91. The graphic card 76 includes a Video Display Processor (VDP) generating video data, and a video RAM temporarily storing the video data. The video data may be originated from the game program stored in the RAM 93.

The IC card reader 62 reads out data stored in the IC card inserted into the card slot 176 to provide the read-out data to the main CPU 91. Also, the IC card reader 62 writes data received the main CPU 91 into the ID card.

The ticket printer 66 prints on a ticket the barcode containing information of the credit amount stored in the RAM 93, date and time, the identification number of the gaming machine 1, and the like, in response to the control signal from the main CPU 91 to output the barcode imprinted ticket.

The key switch 67s, which is disposed behind the keypad 67, outputs a key detection signal to the main CPU 91 when the keypad 67 is pressed by the player.

The data display 68 displays information related the input through the keypad 67 in response to a control signal from the main CPU 91.

The body PCB 87 is also electrically connected to the reel assembly 30, which includes first thorough fifth reel units 30a to 30e, each of the reel unit 30a to 30e including the reels 31a to 31e, respectively.

Referring to FIG. 21, each of the reel units 30a to 30e includes a reel circuit board 36. The reel circuit board 36 includes an input/output (I/O) unit 37 capable of communicating with the body PCB 87, a reel driver 32t connected to the I/O unit 37, a backlight driver 34t, and a lighting unit driver 35t.

To the I/O unit 37 is connected a magnetic field detector 33, which includes a magnetic sensor for sensing magnetic field intensity to output a magnetic detection signal proportional to the magnetic field intensity, and sensor fixation means for fixing the magnetic sensor to a predetermined position. The magnetic sensor detects the intensity of the magnetic field generated by a magnet which is connected to a rotating axis of a reel motor 32 to rotate with the reel 31a.

The reel driver 32t supplies electric power to the reel motor 32. The backlight driver 34t supplies electric power individually to each light source 34s in a backlight unit 34. The lighting unit driver 35t supplies electric power individually to each light source 35t of a lighting unit 35.

Since a second thorough a fifth reel units 30b to 30e have substantially the same configuration as a first reel unit 30a, detailed description thereof will be omitted.

The body PCB 87, which is connected to the main CPU 92, may be also electrically connected to the secondary display 70.

When the power is supplied to the gaming machine 1, the main CPU 91 reads the authenticated game program and game system program from the memory card 84s through the gaming board 80 and writes the programs into the RAM 93. The game program is executed in a state being loaded into the RAM 93 in such a manner.

According to an embodiment, the game program includes a input/bet check 91a, a random number generation 91b, a symbol determination 91c, a game counter 91d, a reel control 91e, a win determination 91f, a rendering control 91g, a payout 91h, and a game mode determination 91i to execute respective processing.

The bet/input check 91a, in an idle state where the reels 31a to 31e stop, continuously checks whether any of the BET buttons 56a to 56e or the START button 79 is pressed. After the BET buttons 56a to 56e or the START button 79 is pressed, the bet/input check 91a checks whether there remains any credit for the player on the basis of credit data 93a stored in the RAM 93. If the player has at least one remaining credit, the bet/input check 91a call the random number generation 91b.

Subsequently, the random number generation 91b generates random numbers to be used for the symbol determination 91c. According to an embodiment of the present invention, the random number generation 91b may generate four random numbers for a symbol arrangement, each of which is directed to respective one of the basic reel units, i.e., the first though the fourth reel units 30a to 30d. According to an embodiment of the present invention, the random number generation 91b may further generate an additional random number for an extra reel column, which is directed to the extra reel unit, i.e., the fifth reel unit 30e.

After the random numbers are extracted, the symbol determination 91c may select symbols corresponding to the extracted random numbers based on the symbol code determination table stored in the RAM 93. The selected symbols may form a center row of a symbol arrangement shown by the display window 22 of the primary display.

According to an embodiment of the present invention, the random number generation 91b may further generate a random number for selecting a rendering pattern from the rendering pattern tables stored in the RAM.

According to an embodiment of the present invention, the symbol determination 91c may check a current gaming mode based on the mode flag 93b stored in the RAM 93, and may differentiate the symbol determination process between the normal mode and the free mode.

The reel control 91e may control the reel assembly 30 by providing stop position information about stop positions corresponding to the selected symbols so that the reels 31a to 31e may spin and stop at the positions designated by the stop position information. Thus, the reels 31a to 31e may spin and stop such that the selected symbols form a center row of a symbol arrangement shown in the display window 22 of the primary display 20.

The win determination 91f may determine whether a symbol arrangement includes any winning combination. When there is a winning combination in the symbol arrangement, the rendering control 91g may control the secondary display 70, the speaker 17, and the lamp 18 to output rendering effects. The rendering effects may include video effect, audio effect, backlighting effect, and lighting effect. The payout 91h determines payout amount depending on the established winning combination to payout the amount the player obtained.

Meanwhile, whenever the game round is finished, the game mode determination 91i determines the gaming mode of the next game round. The game mode determination 91i changes the normal mode into the free mode when a trigger event occurs in the symbol arrangement. On the other hand, the game mode determination 91i changes the free mode into the normal mode when an exit condition is satisfied. In the other cases, the game mode determination 91i maintains the previous gaming mode. Meanwhile, the game mode determination 91i may be included in the win determination 91f.

Gaming Modes

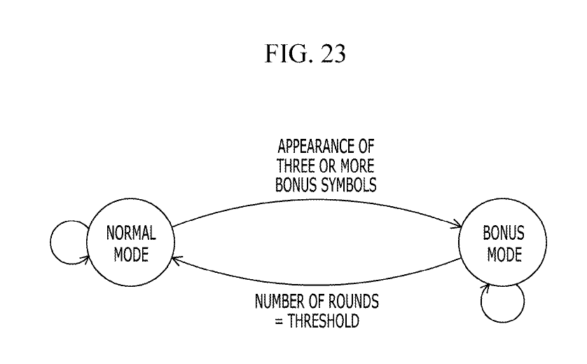

Next, a gaming mode according to an embodiment of the present invention is described in detail with reference to FIG. 23.

FIG. 23 shows a state machine of a gaming mode in a gaming machine according to an embodiment of the present invention.

According to an embodiment of the present invention, a gaming machine executes a game in one mode of a normal mode and a bonus mode (or a free mode), and switches one mode to the other mode. Generally, the gaming machine starts a game (i.e., a normal mode game) in the normal mode, and maintains the normal mode unless a trigger event occurs. When a game result of the normal mode game satisfies the trigger event for the bonus mode, the gaming machine switches the normal mode to the bonus mode and starts a game (i.e., a bonus mode game) in the bonus mode. The trigger event for the bonus mode may be appearance of three or more bonus symbols (“BONUS”). The bonus mode game is an additional game that is advanced from the normal mode game according to the game result of the normal mode game.

The gaming machine switches the bonus mode to the normal mode when an ending condition of the bonus mode is satisfied in the bonus mode. The bonus mode may be switched to the normal mode when the number of rounds executed in the bonus mode is equal to a threshold.

Gaming Method

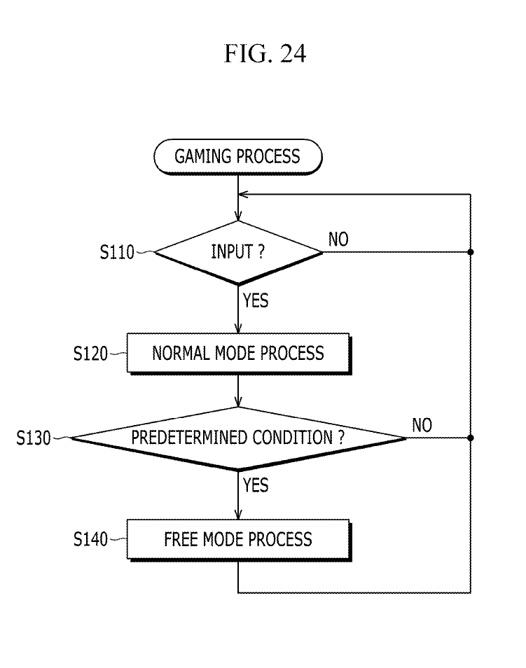

A gaming method according to an embodiment of the present invention is described in detail with reference to FIG. 24 to FIG. 30B.

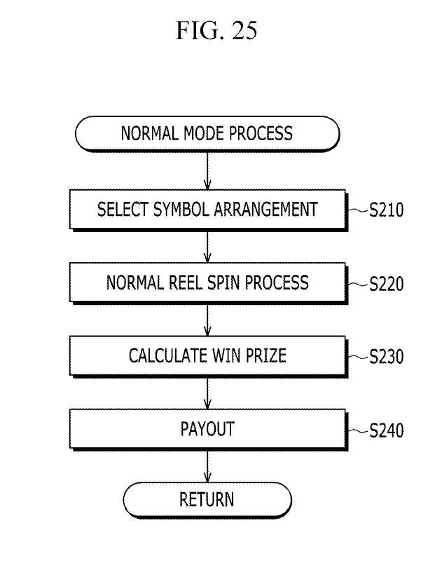

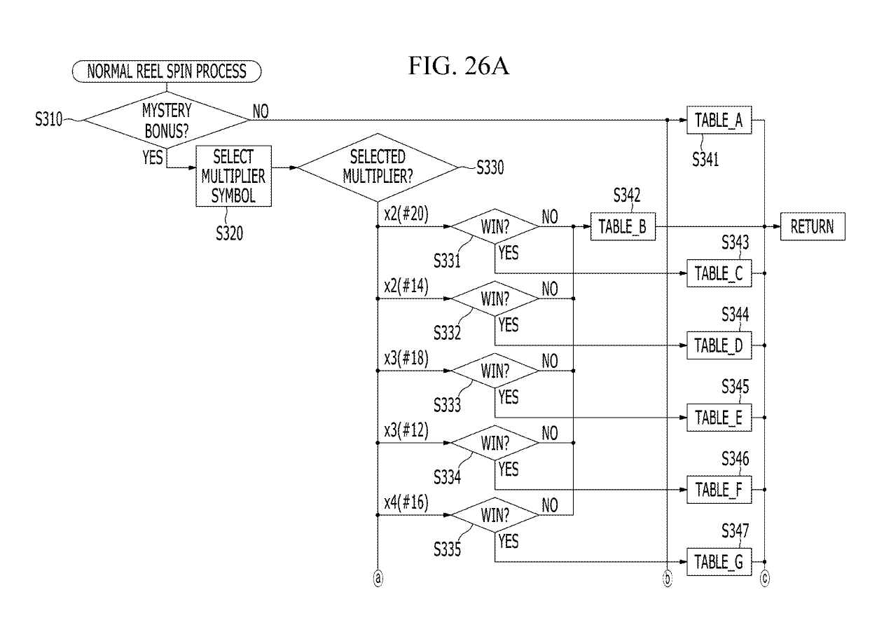

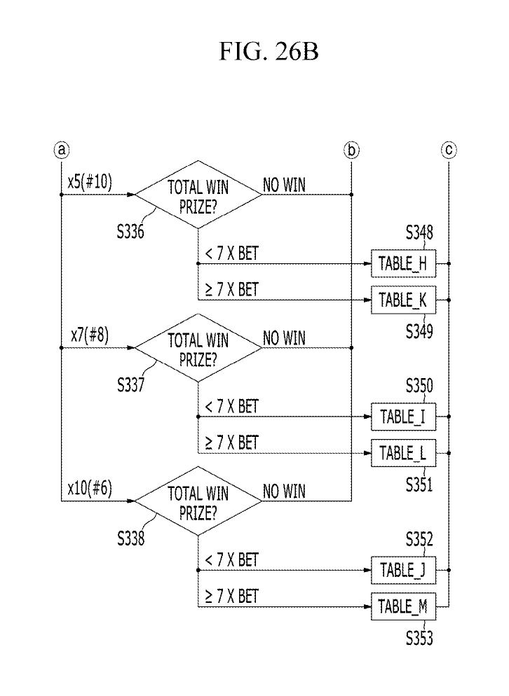

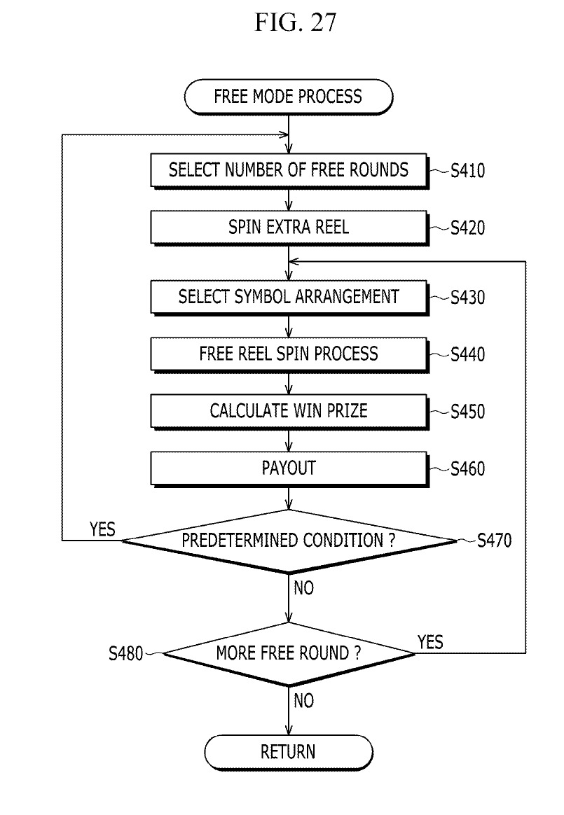

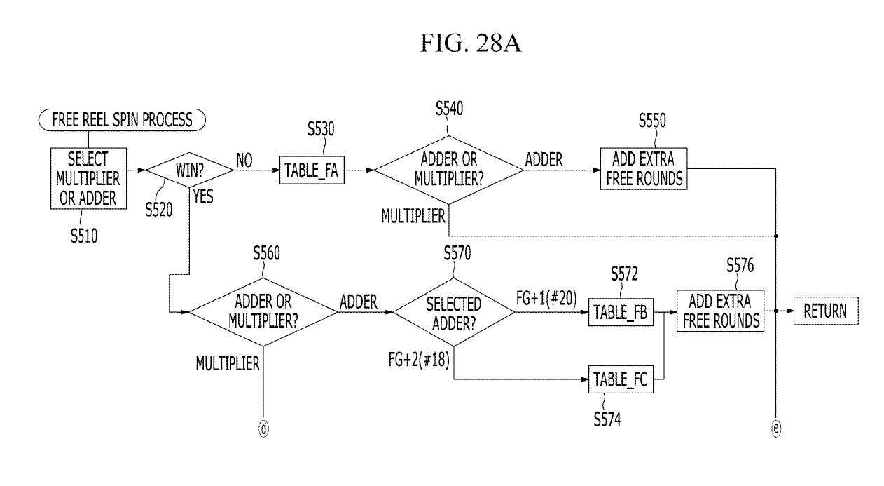

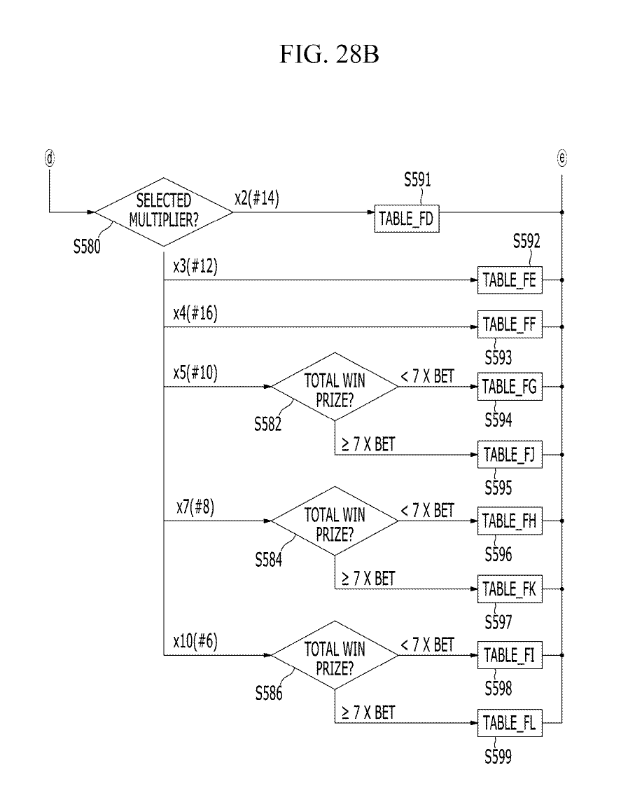

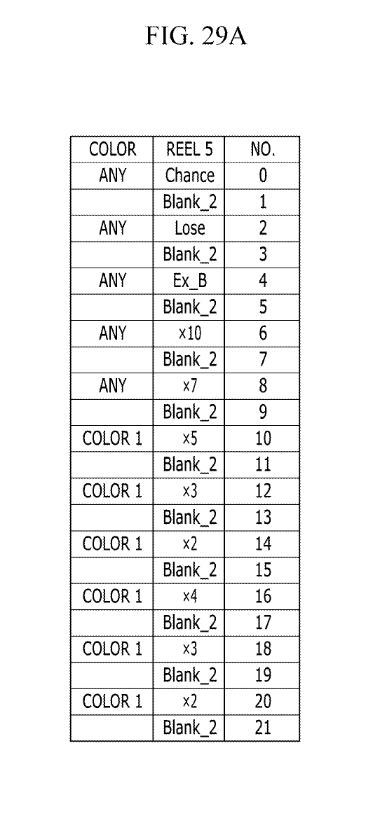

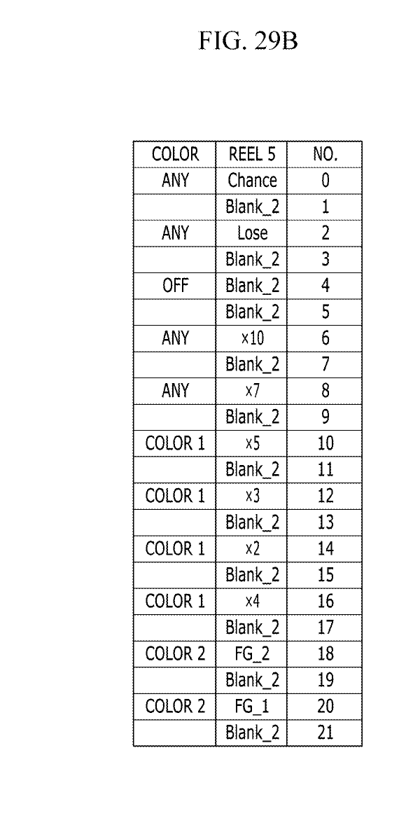

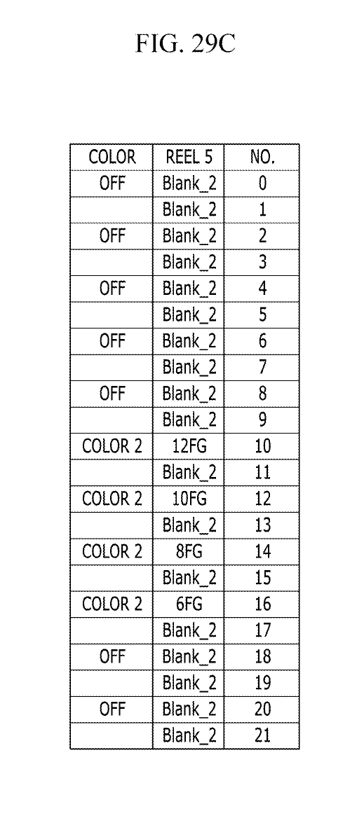

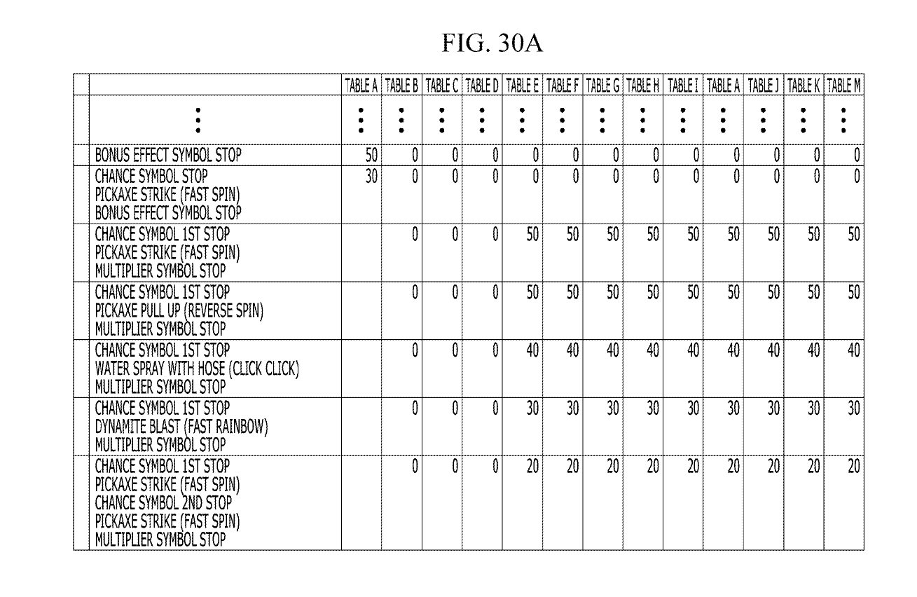

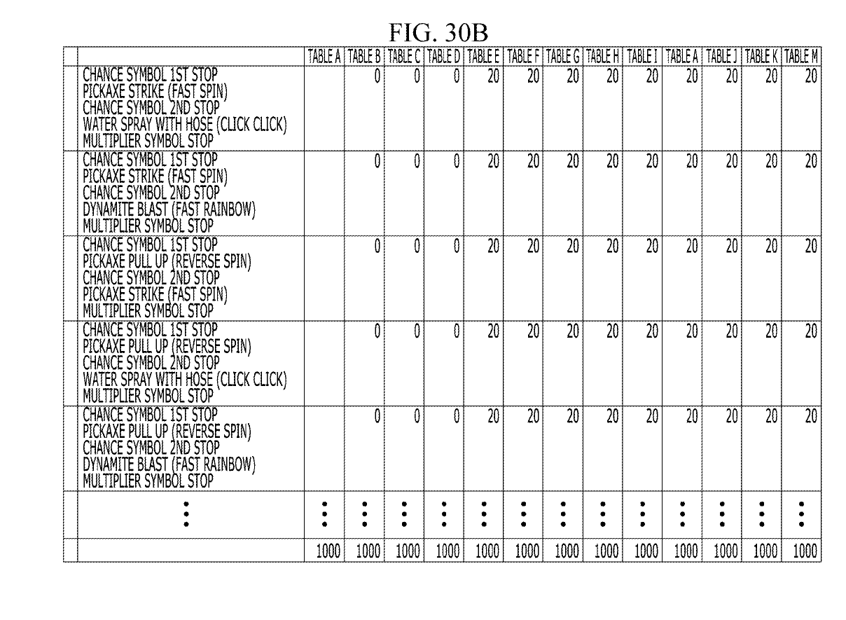

FIG. 24 is a schematic flow chart illustrating a gaming method according to an embodiment of the present invention, FIG. 25 is a schematic flow chart illustrating a normal mode process according to an embodiment of the present invention, FIG. 26A and FIG. 26B are a schematic flow chart illustrating a normal reel spin process according to an embodiment of the present invention, FIG. 27 is a schematic flow chart illustrating a free mode process according to an embodiment of the present invention, FIGS. 28A and 28B are a schematic flow chart illustrating a free reel spin process according to an embodiment of the present invention, FIG. 29A, FIG. 29B, and FIG. 29C illustrate symbol sets on an extra reel used in various situations, and FIGS. 30A and 30B show exemplary rendering patterns.

A gaming method according to an embodiment of the present invention, the gaming machine 1 may execute a game in a normal mode or in a bonus mode (or a free mode). Although a player playing in the normal mode may be required to bet some coins or credits on each game round in the normal mode, the free mode may not require a player's betting.

A symbol set on the basic reels 31a-31d for a normal round of the game may be also used in a free round of the game. However, different symbol sets may be used in the normal round and the free round.

According to an embodiment of the present invention, the symbols in first four columns in the symbol code table shown in FIG. 14 may be used both in the normal round and the free round. However, a symbol set shown in FIG. 29A may be used for the extra reel 31e in the normal round while a symbol set shown in FIG. 29B may be used for the extra reel 31e in the free round. A symbol set shown in FIG. 29C may be used for the extra reel 31e in selecting the number of free rounds when starting a free mode.

The symbol sets shown in FIG. 29A to 29C may be selected by backlighting. For example, the symbol set shown in FIG. 29A may be obtained by illuminating the symbols of Code numbers 10, 12, 14, 16, 18 and 20 with a first color light, for example, red light using the backlighting unit 34 shown in FIG. 15 and by illuminating the symbols of Code numbers 0, 2, 4, 6 and 8 with any color light. The symbol set shown in FIG. 29B may be obtained by illuminating the symbols of Code numbers 10, 12, 14, and 16 with the first color light, by illuminating the symbols of Code numbers 18 and 20 with a second color light, for example, green color light, by illuminating the symbols of Code numbers 0, 2, 4, 6 and 8 with any color light, and by turning off the backlight for the symbol of Code number 4. Similarly, the symbol set shown in FIG. 29C may be obtained by illuminating the symbols of Code numbers 10, 12, 14, and 16 with the second color light, and by turning off the backlight for the symbols of Code number 0, 2, 4, 6, 8, 18 and 20.

Referring to FIG. 24, a controller of the gaming machine 1 determines whether there is an input from a player (S110). The controller goes to a normal mode process where a normal round of the game is executed (S120) when it is determined that there is an input from the player (S110: YES). After executing the normal mode process (S120), the controller determines whether a result of the normal mode process (S120) satisfies a predetermined condition for triggering a free mode process (S130). According to an embodiment of the present invention, the predetermined triggering condition may be that a symbol arrangement selected in the free mode process includes three or more bonus symbols. The controller goes to a free mode process (S140) when it is determined that the result of the normal mode process (S120) satisfies the predetermined condition (S130: YES). When it is determined that that there is an input from the player (S110: NO) or that the result of the normal mode process (S120) does not satisfy the predetermined condition (S130: NO), the controller waits for an input from the player.

Referring to FIG. 25, in the normal mode process, the controller select a symbol arrangement including a group of symbols on the basic reels 31a-31d arranged in a 4×4 matrix (S210). Thereafter, the controller goes into a normal reel spin process (S220). After executing the normal reel spin process (S220), the controller calculates a win prize (S230), and executes a payout process (S240).

Referring to FIGS. 26A and 26B, the controller selects a rendering pattern and controls the reels 31a-31e and the secondary display 70 based on the selected rendering pattern in the normal reel spin process. A rendering pattern may define one or more rendering effects, and the rendering effects may include a display of an extra symbol, a movement of the extra reel 31e, and a movement of images on the secondary display 70.

According to an embodiment of the present invention, the extra reel 31e may move in connection with a movement of the images on the secondary display 70 in a game round in the normal mode. The connection between the movement of the extra reel 31e and the movement of the images on the secondary display 70 may be adopted in the normal round when a player wins the normal round. However, the movement connection between the extra reel 31e and the images on the secondary display 70 may be also selected by a lottery even when the player loses the normal round in order to provide diverse visual effects that attract the player.

Referring to FIG. 14, the extra symbols may include effect symbols, multiplier symbols, determinant symbols, and adder symbols. The effect symbols include a chance symbol “Chance” of Code number 0, a loss symbol “Lose” of Code Number 2, and a bonus effect symbol “Ex_B” of Code number 4. The multiplier symbols include a “×10” multiplier symbol of Code Number 6, a “×7” multiplier symbol of Code Number 8, a “×5” multiplier symbol of Code Number 10, a “×3” multiplier symbol of Code Number 12, a “×2” multiplier symbol of Code Number 14, a “×4” multiplier symbol of Code Number 16, a “×3” multiplier symbol of Code Number 18, and a “×2” multiplier symbol of Code Number 20. The determinant symbols include a “12FG” determinant symbol of Code Number 10, a “10FG” determinant symbol of Code Number 12, an “8FG” determinant symbol of Code Number 14, and a “6FG” determinant symbol of Code Number 16. The adder symbols include a “FG_{—}2” adder symbol of Code Number 18 and a “FG_{—}1” adder symbol of Code Number 20.

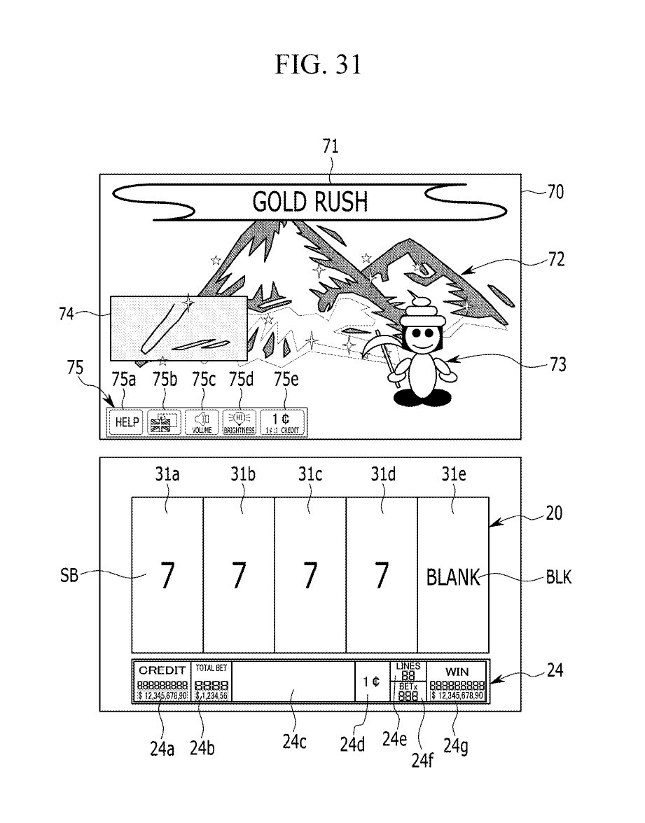

The images on the secondary display 70 may include a character image 73, for example, carrying a pickaxe with a right hand as shown in FIG. 31. The character image 73 may strike the ground or the extra reel 31e with the pickaxe, pull up the pickaxe, spray water with a hose, and blast the ground or the extra reel 31e with dynamites, for example.

The extra reel 31e may spin with various types, for example, various speeds and directions. Examples of the spin type may include fast spinning, reverse spinning, click spinning, and fast rainbow spinning.

FIGS. 30A and 30B show a variety of rendering patterns according to an embodiment of the present invention. The rendering pattern table shown in FIGS. 30A and 30B includes columns and rows. The columns are entitled “TABLE_A,” “TABLE_A,” . . . , and “TABLE_M,” and the rows include scenarios. A scenario may be denoted by a scenario number (shown in a first column entitled “SCN. NO.”) and a content of the scenario (shown in a second column).

The content of the scenario may include at least one of actions of the extra symbols and the character image 73 on the secondary display 70.

The actions of the extra symbols may include, for example, a stop (or a show) of a bonus effect symbol denoted by “BONUS EFFECT SYMBOL STOP,” a stop (or a show) of a chance symbol denoted by “CHANCE SYMBOL STOP,” and a stop (or a show) of a multiplier symbol denoted by “MULTIPLIER SYMBOL STOP.” The actions of the character image may include striking with a pickaxe denoted by “PICKAXE STRIKE,” pulling up the pickaxe denoted by “PICKAXE PULL UP,” spraying water with a hose denoted by “PICKAXE PULL UP,” and blasting with dynamites denoted by “DYNAMITE BLAST,” for example.

An action of the character image 73 may trigger a spin of the extra reel 31e, and the content of the scenario may further include a type of the spin, for example, the direction and the speed of the spin, of the extra reel 31e triggered by the action of the character image 73. For example, the action of striking with a pickaxe denoted by “PICKAXE STRIKE” may trigger a fast spin of the extra reel 31e denoted by “FAST SPIN” in parenthesis, and the action of pulling up the pickaxe denoted by “PICKAXE PULL UP” may trigger a reverse spin of the extra reel 31e denoted by “REVERSE SPIN” in parenthesis. The action of spraying water with a hose denoted by “PICKAXE PULL UP” may trigger a clicking spin of the extra reel 31e denoted by “CLICK CLICK” in parenthesis, and the action of blasting with dynamites denoted by “DYNAMITE BLAST” may trigger a fast rainbow spin of the extra reel 31e denoted by “FAST RAINBOW” in parenthesis.

Each scenario may include one or a series of the actions of the extra symbols and the actions of the character image 73, or may include one or a series of the actions of the extra symbols and the actions of the character image 73 arranged in order to be conducted. For example, a scenario SCN. NO 1 includes an action of an extra symbol, e.g., a stop of a bonus effect symbol (“BONUS EFFECT SYMBOL STOP”). A scenario SCN. NO 2 includes a combination of actions of the extra symbols and an action of the character image 73, that is, a stop of a chance symbol (“CHANCE SYMBOL STOP”), striking with a pickaxe (“PICKAXE STRIKE”) that triggers a fast spin of the extra reel 31e (“FAST SPIN”), and a stop of a multiplier symbol (“MULTIPLIER SYMBOL STOP”), which will be performed in sequence.

Although FIG. 30A and FIG. 30B shows only twelve scenarios from SCN. NO. 1 to SCN. NO. 12, a number of other scenarios may be included in the rows.

Each cell defined by a row and a column includes a probability number, for example, 0, 20, 30, 40, 50, and so on. The probability number divided by a total number 1000 may indicate the probability for a corresponding column (or table) and a corresponding scenario. Therefore, each column may be considered to include a number of scenarios having respective non-zero probabilities. For example, the column entitled “TABLE_A” may include two scenarios SCN. NO 1 and SCN. NO 2.

According to an embodiment of the present invention, although FIGS. 30A and 30B may be used in the normal mode process, it may be also used in the free mode process. According to another embodiment of the present invention, rendering patterns for the free mode process may be separately prepared.

Referring again to FIGS. 26A and 26B, the controller may determine whether the player wins a mystery bonus by using a lottery, for example (S310). When it is determined that the player loses the mystery bonus (S310: NO), the controller may select a column entitled “TABLE_A” shown in FIGS. 30A and 30B (S341) in a case that the above-described predetermined condition for triggering the free mode is satisfied, for example, a symbol arrangement shown in the display window 22 includes three or more bonus symbols. The column TABLE_A includes two rendering patterns (or scenarios), a first scenario (or rendering pattern) SCN. NO. 1 and a second scenario SCN. NO. 1, which have non-zero probabilities. The controller selects one of the first scenario and the second scenario by lottery, for example.

According to an embodiment of the present invention, the extra reel 31e may not spin when the predetermined condition for triggering the free mode is not satisfied and the player loses the mystery bonus.

When it is determined that the player win the mystery bonus (S310: YES), the controller selects one of the multiplier symbols of Code Numbers 6, 8, 10, 12, 14, 16, 18, and 20 on the extra reel 31e shown in FIG. 29A (S330) by using a random number generator, for example. According to an embodiment of the present invention, a multiplier value of the selected multiplier symbol may be twice (×2), three times (×3), four times (×4), five times (×5), seven times (×7), or ten times (×10).

One of the columns denoted by TABLE_A to TABLE_M in FIGS. 30A and 30B may be selected based on the selected multiplier symbol and a value of a total win prize. The value of the total win prize is determined as a basic win prize multiplied by the multiplier value.

In detail, the selected multiplier symbol is an “×2” symbol of Code Number 20 shown in FIG. 29A (S330: ×2(#20)), the controller determines whether the player wins a current normal game round (S331) based on the selected symbol arrangement (S210 in FIG. 25). When it is determined that the player loses the normal round (S331: NO), a column TABLE_B is selected (S342). However, a column TABLE_C is selected (S343) when it is determined that the player wins the normal round (S331: YES).

Likewise, the selected multiplier symbol is an “×2” symbol of Code Number 14 shown in FIG. 29A (S330: ×2(#14)), the controller determines whether the player wins the current normal game round (S332). The column TABLE_B is selected (S342) when the player loses the normal round (S332: NO), and a column TABLE_D is selected (S344) when the player wins the normal round (S332: YES).

The selected multiplier symbol is an “×3” symbol of Code Number 18 shown in FIG. 29A (S330: ×3(#18)), the controller determines whether the player wins the current normal game round (S333). The column TABLE_B is selected (S342) when the player loses the normal round (S333: NO), and a column TABLE_E is selected (S345) when the player wins the normal round (S333: YES).

Similarly, the selected multiplier symbol is an “×3” symbol of Code Number 12 shown in FIG. 29A (S330: ×3(#12)), the controller determines whether the player wins the current normal game round (S334). The column TABLE_B is selected (S342) when the player loses the normal round (S334: NO), and a column TABLE_F is selected (S346) when the player wins the normal round (S334: YES).

The selected multiplier symbol is an “×4” symbol of Code Number 16 shown in FIG. 29A (S330: ×4(#16)), the controller determines whether the player wins the current normal game round (S335). The column TABLE_B is selected (S342) when the player loses the normal round (S335: NO), and a column TABLE_F is selected (S347) when the player wins the normal round (S335: YES).

The selected multiplier symbol is an “×5” symbol of Code Number 10 shown in FIG. 29A (S330: ×5(#10)), the controller determines whether a total win prize earned by the player in the normal game round is none (“NO WIN”), smaller than seven times a betting amount (<7×BET), or equal to or greater than seven times the betting amount (≧7×BET) (S336). When it is determined that the total win prize is none, i.e., the player loses the normal round (S336: NO WIN), the column TABLE_A is selected (S341). When it is determined that the total win prize is smaller than seven times the betting amount (S336: <7×BET), a column TABLE_H is selected (S348). A column TABLE_K is selected (S349) when it is determined that the total win prize is equal to or greater than seven times the betting amount (S336: ≧7×BET).

Likewise, the selected multiplier symbol is an “×7” symbol of Code Number 8 shown in FIG. 29A (S330: ×7(#8)), the controller determines whether a total win prize earned by the player in the normal game round is none (“NO WIN”), smaller than seven times a betting amount (<7×BET), or equal to or greater than seven times the betting amount (≧7×BET) (S337). When the total win prize is none (S337: NO WIN), the column TABLE_A is selected (S341). When the total win prize is smaller than seven times the betting amount (S337: <7×BET), a column TABLE_I is selected (S350). A column TABLE_L is selected (S351) when the total win prize is equal to or greater than seven times the betting amount (S337: ≧7×BET).

Similarly, the selected multiplier symbol is an “×10” symbol of Code Number 6 shown in FIG. 29A (S330: ×10(#6)), the controller determines whether a total win prize earned by the player in the normal game round is none (“NO WIN”), smaller than seven times a betting amount (<7×BET), or equal to or greater than seven times the betting amount (≧7×BET) (S338). When the total win prize is none (S338: NO WIN), the column TABLE_A is selected (S341). When the total win prize is smaller than seven times the betting amount (S338: <7×BET), a column TABLE_J is selected (S352). A column TABLE_M is selected (S353) when the total win prize is equal to or greater than seven times the betting amount (S338: ≧7×BET).

According to an embodiment of the present invention, the rendering patterns including a stop of a chance symbol may be selected for triggering a bonus mode or for higher multiplier values, for example, “×7” and “×10” so that a player may expect free game rounds or a high win prize. If the chance symbol stops for lower multiplier values as well as the higher multiplier values, the degree of the player's expectation may be decreased.

Referring to FIG. 27, in the free mode process, the controller select the number of free rounds at a beginning of the free mode (S410). According to an embodiment of the present invention, the selected number of the free rounds may be 6, 8, 10, or 12.

Thereafter, the controller spins and stops the extra reel 31e to show a determinant symbol corresponding to the selected number of the free rounds (S420). The movement of the extra reel 31e may be performed based on a rendering pattern, and the rendering pattern may vary depending on the selected number of the free rounds. The extra reel 31e may move in connection with the movement of the images on the secondary display 70.

After spinning of the extra reel 31e, the control selects a symbol arrangement including a group of symbols on the basic reels 31a-31d arranged in a 4×4 matrix (S430) like in the normal mode. Thereafter, the controller goes into a free reel spin process (S440). After executing the free reel spin process (S440), the controller calculates a win prize (S450), and executes a payout process (S470).

After executing the payout process (S470), the controller determines whether a predetermined retriggering condition is satisfied (S470). The retriggering condition may be substantially the same as the predetermined condition for triggering the free mode process. For example, the predetermined retriggering condition is satisfied when the symbol arrangement selected in S430 includes three or more bonus symbols.

The controller returns to S410 to select the number of the additional free rounds and to increase the number of remaining free rounds by the selected number when it is determined that the predetermined retriggering condition is satisfied (S470: YES). The controller determines whether there are more free rounds to be executed (S480) when it is determined that the predetermined retriggering condition is not satisfied (S470: NO). When it is determined that there is more free round to be executed (S480: YES), the controller goes to S430 to execute another free round. The controller terminates the free mode process when it is determined that there is no more free round to be executed (S480: NO).

Referring to FIGS. 28A and 28B, the controller selects a rendering pattern and controls the reels 31a-31e and the secondary display 70 based on the selected rendering pattern in the free reel spin process. The rendering patterns for the free mode process may be separately stored in a memory as those shown in FIGS. 30A and 30B. According to an embodiment of the present invention, columns are entitled from TABLE_FA to TABLE_FL.

According to an embodiment of the present invention, the extra reel 31e may move in connection with a movement of the images on the secondary display 70 in a game round in the free mode. The connection between the movement of the extra reel 31e and the movement of the images on the secondary display 70 may be adopted in the free round by a lottery when a player wins the free round. However, the movement connection between the extra reel 31e and the images on the secondary display 70 may be omitted when the player loses the game round in order for a fast progress of the game.

The controller selects a function symbol among the multiplier symbols of Code Numbers 6, 8, 10, 12, 14, and 16 and the adder symbols of Code numbers 18 and 20 on the extra reel 31e shown in FIG. 29B at a beginning of the free reel spin process (S510) by using a random number generator, for example. According to an embodiment of the present invention, a multiplier value of the selected multiplier symbol may be twice (×2), three times (×3), four times (×4), five times (×5), seven times (×7), or ten times (×10), and the number of extra free rounds represented by the selected adder symbol of may be one (FG_{—}1) or two (FG_{—}2).

Thereafter, the controller determines whether the player wins a current free round (S520).

When it is determined that the player loses the current free round (S520: NO), the column TABLE_FA may be selected (S530). The column TABLE_FA may include ordinary rendering patterns. Subsequently, the controller determines which of an adder symbol and a multiplier symbol the selected function symbol is (S540). When it is determined that the selected function symbol is an adder symbol (S540: ADDER), the controller adds the number of extra free rounds corresponding to the selected adder symbol into the number of remaining free rounds (S550). However, when it is determined that the selected function symbol is a multiplier symbol (S540: MULTIPLIER), the controller terminates the free reel spin process.

When it is determined that the player wins the current free round (S520: YES), the controller determines which of an adder symbol and a multiplier symbol the selected function symbol is (S560).

When it is determined that the selected function symbol is an adder symbol (S560: ADDER), the controller determines which of the “FG_{—}1” symbol of Code Number 20 and the “FG_G” symbol of Code Number 18 shown in FIG. 29B the selected adder symbol is (S570). When it is determined that the selected adder symbol is the “FG_{—}1” symbol of Code Number 20 (S570: FG+1(#20)), the column TABLE_FB is selected (S572). The column TABLE_FC is selected (S573) when it is determined that the selected adder symbol is the “FG_{—}2” symbol of Code Number 18 (S570: FG+2(#18)). The columns TABLE_FB and TABLE_FC may include rendering patterns using the chance symbols. Thereafter, the controller adds the number of extra free rounds corresponding to the selected adder symbol into the number of remaining free rounds (S576).

When it is determined that the selected function symbol is a multiplier symbol (S560: MULTIPLIER), one of the columns TABLE_FD to TABLE_FL may be selected based on the selected multiplier symbol and a value of a total win prize. The value of the total win prize is determined as a basic win prize multiplied by the multiplier value.

In detail, when the selected multiplier symbol is an “×2” symbol of Code Number 14 shown in FIG. 29B (S580: ×2(#14)), the column TABLE_FD is selected (S591). Likewise, the column TABLE_FE is selected (S592) when the selected multiplier symbol is an “×3” symbol of Code Number 12 shown in FIG. 29B (S580: ×3(#12)), and the column TABLE_FF is selected (S593) when the selected multiplier symbol is an “×4” symbol of Code Number 16 shown in FIG. 29B (S580: ×4(#16)). The columns TABLE_FD to TABLE_FF may include rendering patterns without using the chance symbols

The selected multiplier symbol is an “×5” symbol of Code Number 10 shown in FIG. 29B (S580: ×5(#10)), the controller determines whether a total win prize earned by the player in the free round is smaller than seven times a betting amount (<7×BET), or equal to or greater than seven times the betting amount (≧7×BET) (S582). When it is determined that the total win prize is smaller than seven times the betting amount (S582: <7×BET), the column TABLE_FG is selected (S594). A column TABLE_FJ is selected (S595) when it is determined that the total win prize is equal to or greater than seven times the betting amount (S582: ≧7×BET).

The selected multiplier symbol is an “×7” symbol of Code Number 8 shown in FIG. 29B (S580: ×7(#8)), the controller determines whether a total win prize earned by the player in the free round is smaller than seven times a betting amount (<7×BET), or equal to or greater than seven times the betting amount (≧7×BET) (S584). When it is determined that the total win prize is smaller than seven times the betting amount (S584: <7×BET), the column TABLE_FH is selected (S596). A column TABLE_{—} FK is selected (S597) when it is determined that the total win prize is equal to or greater than seven times the betting amount (S584: ≧7×BET).

The selected multiplier symbol is an “×10” symbol of Code Number 6 shown in FIG. 29B (S580: ×10(#6)), the controller determines whether a total win prize earned by the player in the free round is smaller than seven times a betting amount (<7×BET), or equal to or greater than seven times the betting amount (≧7×BET) (S586). When it is determined that the total win prize is smaller than seven times the betting amount (S586: <7×BET), the column TABLE_FI is selected (S598). A column TABLE_FL is selected (S598) when it is determined that the total win prize is equal to or greater than seven times the betting amount (S586: ≧7×BET).

The columns TABLE_FG to TABLE_FL may include rendering patterns using the chance symbols.

Effects of Displays

Effects of the displays of the gaming machine 1 according to example embodiments are described in detail with reference to FIG. 31 to FIG. 70.

Idle State

FIG. 31 shows the displays in an idle state of the gaming machine according to an embodiment of the present invention.

Referring to FIG. 31, after a game is finished and before a new game starts, that is, in an idle state, the reels 31a-31e of the primary display 20 are in a still state. Some symbols SB on the basic reels 31a-31d and a blank symbol BLK on the extra reel 31e may stop in the display window (22 in FIG. 8) of the reel cover (21 in FIG. 8) to be shown to a player. Hereinafter, the symbols SB are referred to be shown or displayed when the symbols SB stop in the display window 22. Referring to FIG. 14, the “Lose” symbol of Code Number 2 may have no actual image and may correspond to the blank symbol BLK shown in FIG. 31.

The secondary display 70 may show a title 71 of the game denoted by “GOLD RUSH,” a background image 72 denoted by an image of mountains, a human character 73 carrying a pickaxe with a right hand thereof, a pay table 74, and a plurality of icons 75 that may include a “HELP” icon 75a, a “LANGUAGE” icon 75b, a volume icon 75c, a lighting icon 75d, and a denomination icon 75e.

The third display 24 includes a credit meter 24a, a total bet meter 24b, a game message area 24c, a denomination information area 24d, a line count information area 24e, a bet multiplication information area 24f, and a win meter 24g.

The credit meter 24a shows a player's current credits. The total bet meter 24b shows a bet amount in a current game round, and the bet amount may be represented by the credits. The denomination information area 24d shows a current denomination. The line count information area 24e shows the number of paylines chosen by a player, and the bet multiplication information area 24f shows the number of BETs chosen by the player. The win meter 24g shows a payout credits for win.

The game message area 24c shows messages related to the game in one or more lines. For example, in a free mode, the game message area 24c show a message informing that a current game round is a free game round, for example, “BONUS REELS IN PLAY” that may be always shown in the first line during the free mode. The game message area 24c may also show a message informing of the total number of the free game rounds and the serial number of the current free game round, for example, “FREE GAMES xx OF xx.” When a win case occurs, a message such as “SCATTER WIN=xxxx,” “LINE 22 WIN=xxxx,” “LINE 19 WIN×4=xxxx,” “LINE 22 WIN=xxxx; TOTAL WIN=200” is shown in the game message area 24c. In addition, the game message area 24c may also shows a message indicating various features, for example, “LOOK UP,” “RETRIGGER,” etc.

According to an embodiment of the present invention, the extra reel 31e may spin under a predetermined condition in a normal game round, and the predetermined condition may be satisfied at a predetermined probability. However, the extra reel 31e may spin in every free game round. According to an embodiment of the present invention, the game round where the extra reel 31e spins may not be allowed to skip. According to an embodiment of the present invention, the character image 73 may not move unless a chance symbol on the extra reel 31e is shown to a player. According to an embodiment of the present invention, the “Lose” symbol may not be shown to a player in a free game round.

Ordinary Spinning of Basic Reels without Extra Reel Spin

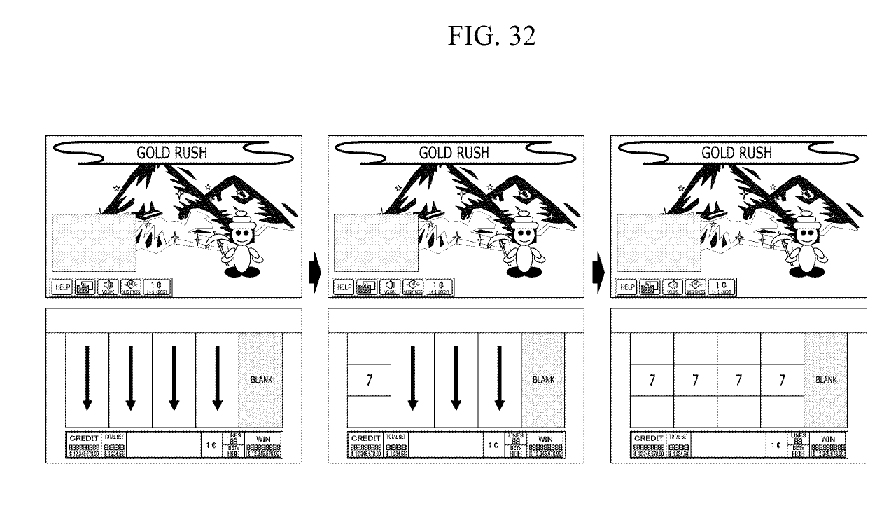

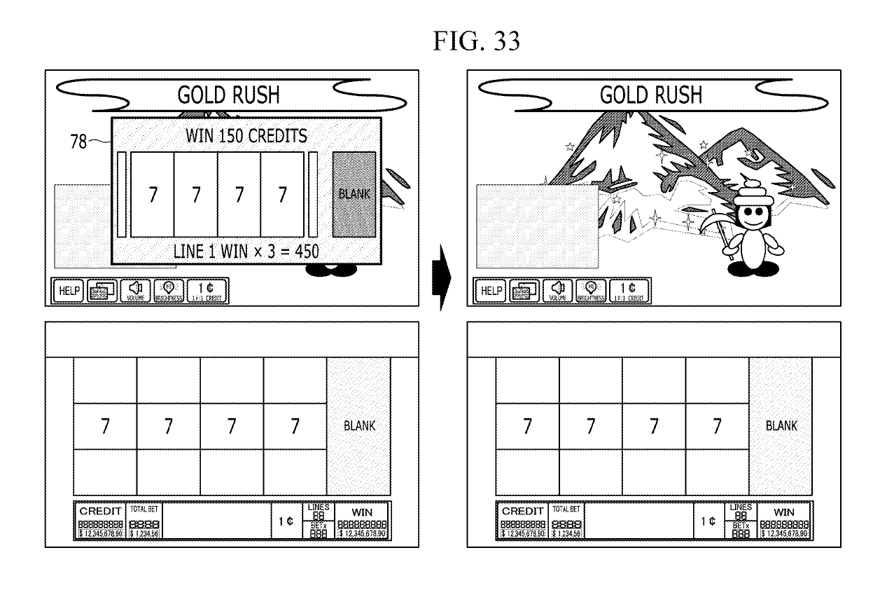

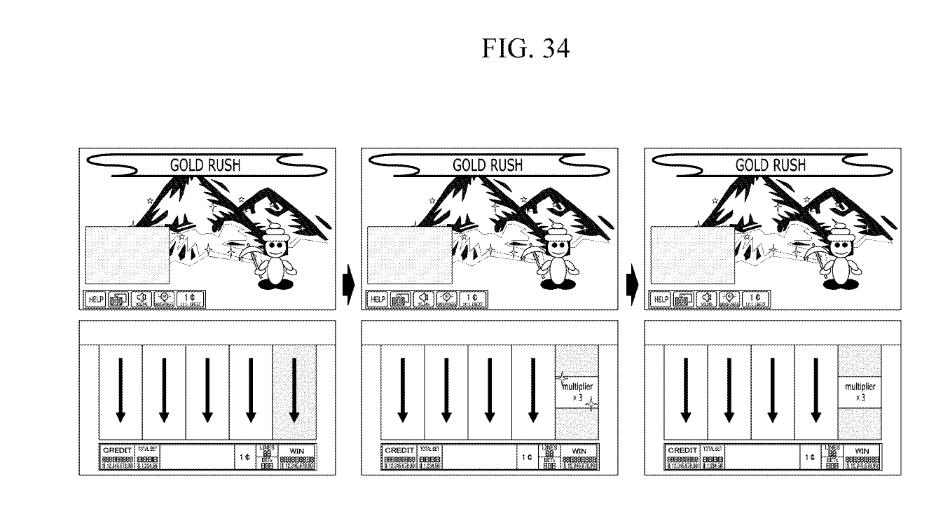

FIG. 32 and FIG. 33 illustrate operations of the displays of the gaming machine in a normal round without spinning the extra reel 31e according to an embodiment of the present invention.

Referring to FIG. 32, the first to fourth basic reels 31a-31d start to spin simultaneously in a normal round of a game when a selected rendering pattern does not allow the extra reel 31 to spin. After a predetermined time elapses from the start of the spinning, the basic reels 31a-31d stop spinning in sequence from the first basic reel 31a to the fourth basic reel 31d such that a symbol arrangement including a group of symbols on the basic reels 31a-31d is shown in the display window 22.

Referring to FIG. 33, a win plate 78 showing win information pops up on the secondary display 70 when the symbol arrangement includes a winning combination, that is, a player wins the normal round. The win meter 24g may be incremented and the win information may be also shown in the game message area 24c on the third display 24. An exemplary win shown in FIG. 33 is a line win consisting of four seven symbols in a row and providing a basic win prize of 150 credits. After a predetermined time elapses from the pop up of the win plate 78, the win plate 78 vanishes.

Preceding Stop of Extra Reel without Chance Symbol Display

FIG. 34 to FIG. 37 illustrate operations of the displays of the gaming machine in a normal mode or in a free mode according to an embodiment of the present invention when the extra reel 31e stops spinning before the basic reels 31a-31d stop spinning and when no chance symbol is selected to be displayed.

Referring to FIG. 34, the basic reels 31a-31d and the extra reel 31e start to spin in a simultaneous manner. The extra reel 31e may spin either slow or fast either in a forward direction or in a backward direction. The game message area 24c of the third display 24 may show a message “BONUS REELS IN PLAY” in a free game round.

After a predetermined time elapses from the start of the spinning, the extra reel 31e stops spinning such that a selected function symbol, for example, a “3×” multiplier symbol is shown in the display window 22, while the basic reels 31a-31d maintain their spinning. According to an embodiment of the present invention, the selected function symbol may be highlighted immediately after the extra reel 31e stops.

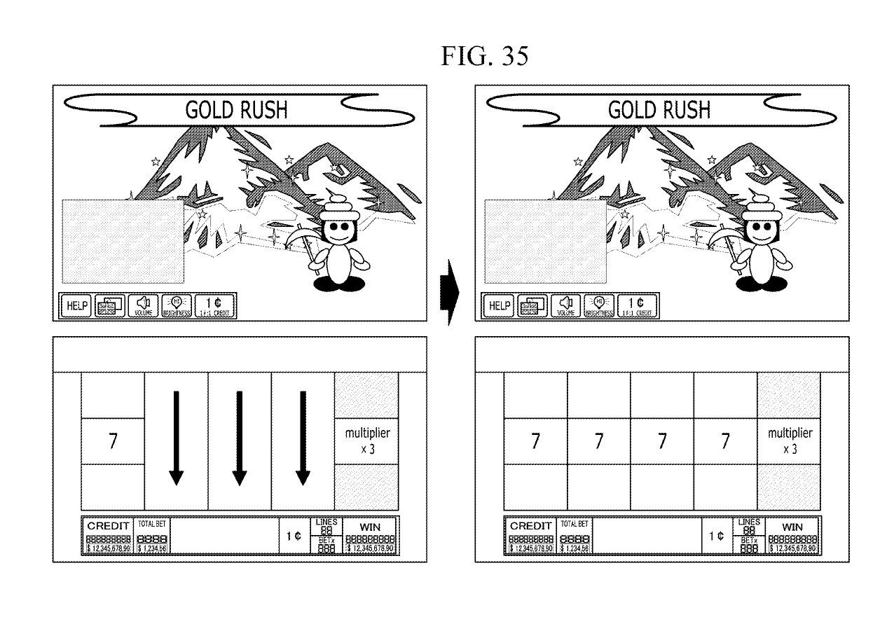

Referring to FIG. 35, the basic reels 31a-31d stop spinning in sequence from the first basic reel 31a to the fourth basic reel 31d to show a symbol arrangement after the extra reel 31e stop spinning.

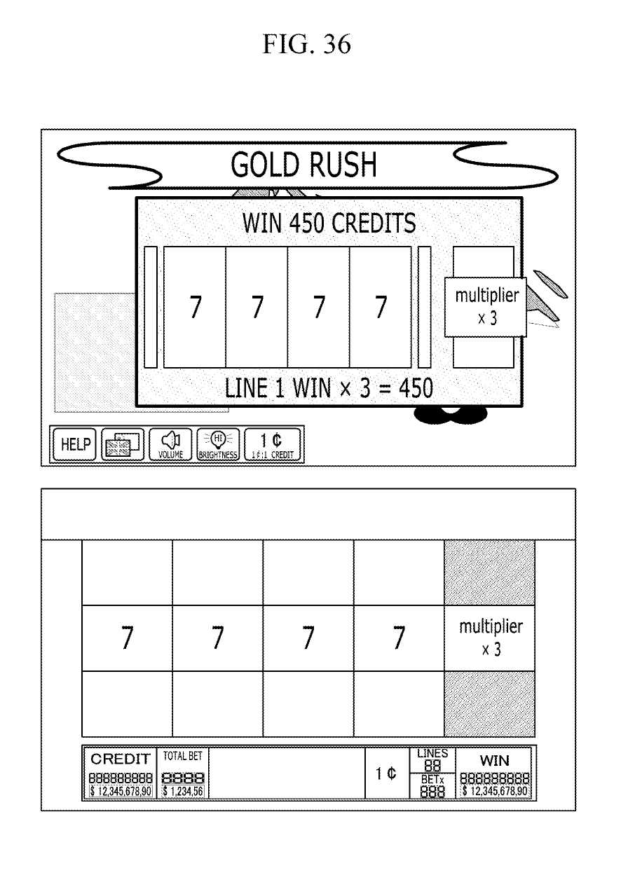

Referring to FIG. 36, a win plate showing win information pops up on the secondary display 70 when the symbol arrangement includes a winning combination, that is, a player wins the game round. The win meter 24g may be incremented and the win information may be also shown in the game message area 24c on the third display 24. FIG. 36 shows a line win of a basic win prize of 150 credits and a total win prize of 450 credits that is obtained by multiplying the basic win prize by a multiplier value (i.e. three times) of the “3×” multiplier symbol on the extra reel 31e, which is displayed in the display window 22.

When the player loses the game round, the win plate shown in FIG. 36 is not shown on the secondary display 70.

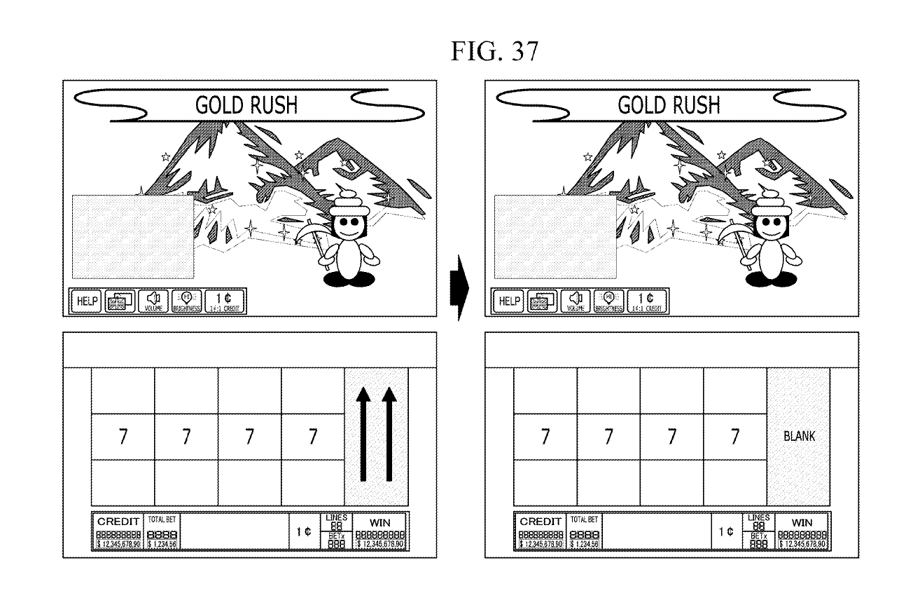

Referring to FIG. 37, the extra reel 31e spins fast in a reverse direction after the win plate vanishes and stops spinning such that the blank symbol BLK on the extra reel 31e returns to the display window 22 in order to avoid the misunderstanding that the multiplier symbol also applies to a next round.

Preceding Stop of Extra Reel with Chance Symbol Display

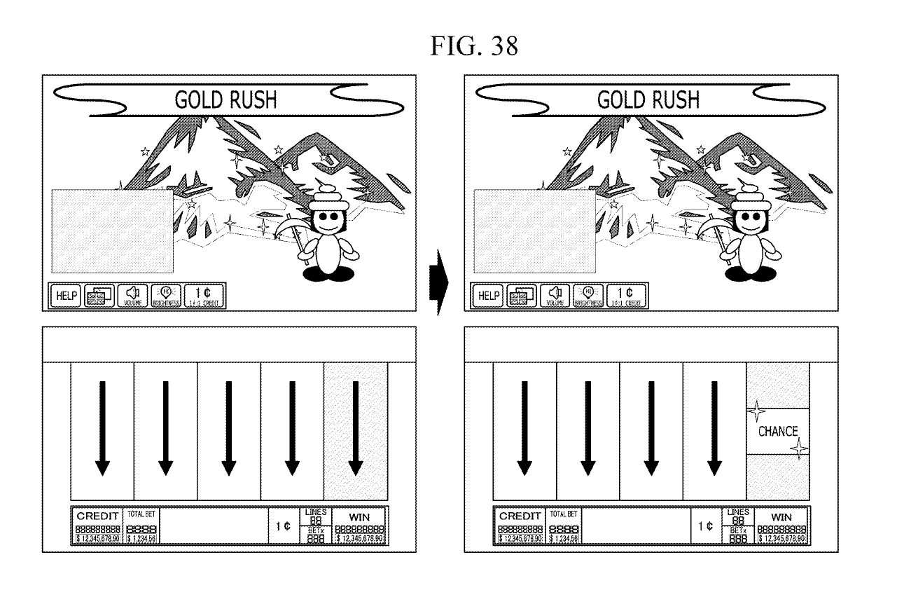

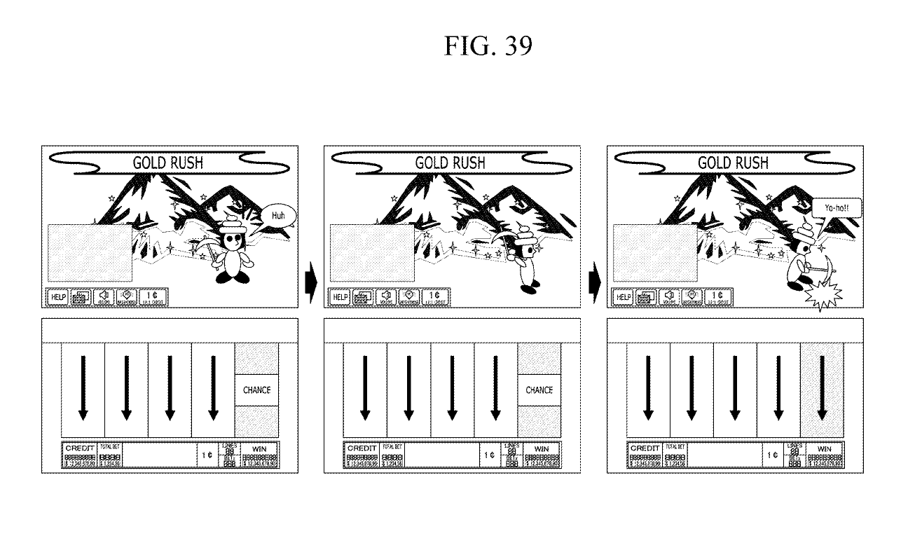

FIG. 38 to FIG. 42 illustrate operations of the displays of the gaming machine in a normal mode or in a free mode according to an embodiment of the present invention when the extra reel 31e stops spinning before the basic reels 31a-31d stop spinning and when a chance symbol is selected to be displayed in the display window 22.

Referring to FIG. 38, the basic reels 31a-31d and the extra reel 31e start to spin in a simultaneous manner. The extra reel 31e may spin either slow or fast either in a forward direction or in a backward direction. The game message area 24c of the third display 24 may show a message “BONUS REELS IN PLAY” in a free game round.

After a predetermined time elapses from the start of the spinning, the extra reel 31e stops spinning such that a chance symbol is shown in the display window 22, while the basic reels 31a-31d maintain their spinning According to an embodiment of the present invention, the rest chance symbol may be highlighted immediately after the extra reel 31e stops.

Referring to FIG. 39, the character 73 carrying a pickaxe with a right hand on the secondary display 70 senses that the chance symbol takes a rest in the display window 22. FIG. 39 shows that the character 73 makes a sound “Huh” when he or she senses the rest chance symbol. Once detecting the rest chance symbol, the character 73 pulls up the pickaxe with both hands and strikes the rest extra reel 31e with the pickaxe such that the extra reel 31e spins again. FIG. 39 shows that the character 73 makes a sound “Yo-ho!” when he or she strikes the rest extra reel 31e.

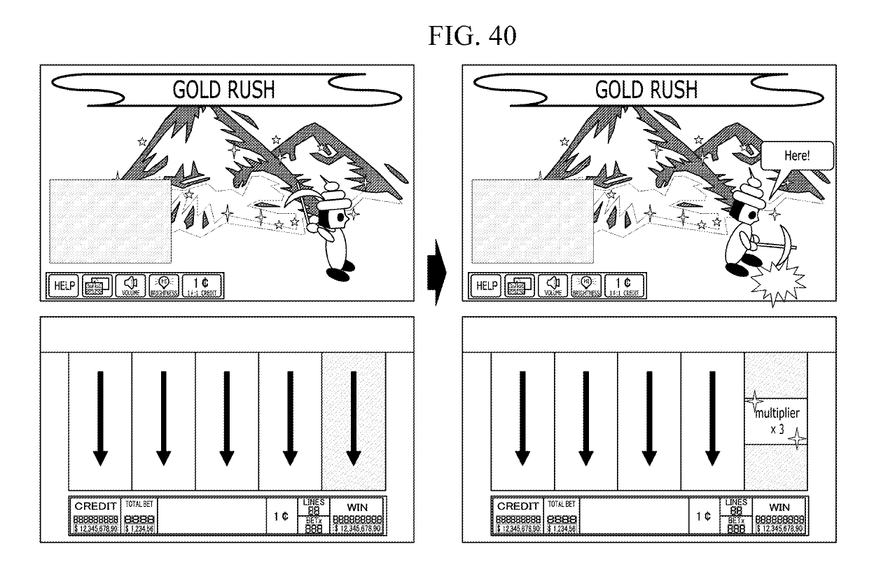

Referring to FIG. 40, the character 73 pulls up the pickaxe again and strikes the spinning extra reel 31e. FIG. 40 shows that the character 73 makes a sound “Here!” when he or she strikes the spinning extra reel 31e. The extra reel 31e struck by the pickaxe stops spinning again to show a selected function symbol, for example, a “3×” multiplier symbol while the basic reels 31a-31d maintain their spinning. According to an embodiment of the present invention, the selected function symbol may be highlighted immediately after the extra reel 31e stops.

According to an embodiment of the present invention, the chance symbol may stop in the display window 22 again. Then, the character 73 and the extra reel 31e may repeat the movements shown in FIG. 39 and FIG. 40. However, the character 73 and the extra reel 31e may move in a different way. For example, the character 73 sprays water with a hose or blows up with dynamites after the chance symbol secondly stops. In this case, images where the character 73 changes his tool may be added.

According to an embodiment of the present invention, referring to FIGS. 30A and 30B, the character 73 may take one of two actions, for example, striking the extra reel 31e to spin fast or pull up the pickaxe to make the extra reel 31e spin reversely when the chance symbol stops for the first time in the display window 22. When the chance symbol stops at a second time in the display window 22, the character 73 may take one of three actions, for example, striking the extra reel 31e to spin fast, spraying water with a hose to make the extra reel 31e clicking, or blow up the extra reel 31e with dynamite to perform fast rainbow spinning.

According to an embodiment of the present invention, the actions of water spray with a hose and dynamite blast may not be used in stopping the spinning extra reel 31e although pickaxe striking is used in stopping the spinning extra reel 31e in the above described example.

According to an embodiment of the present invention, the consecutive stopping in the display window 22 of the chance symbol may be performed at most twice.

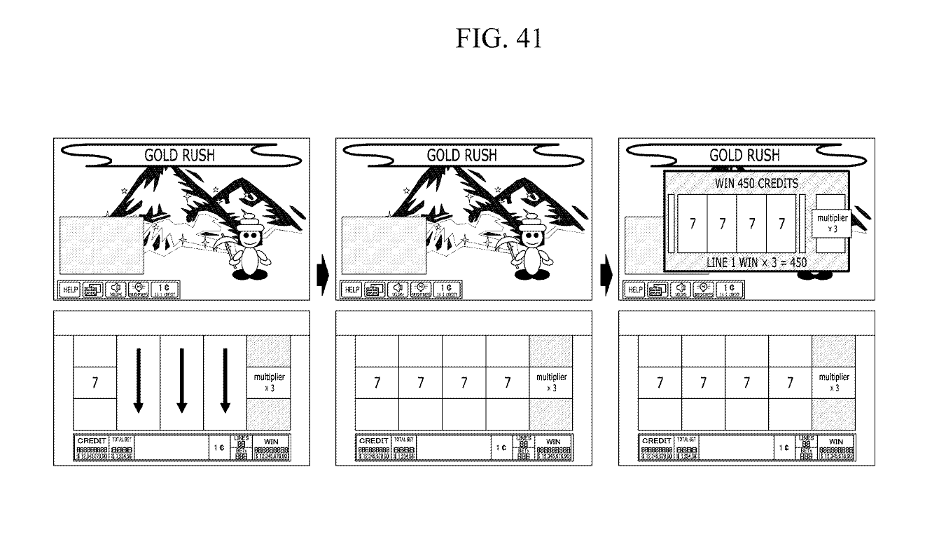

Referring to FIG. 41, the character 73 returns to his or her ordinary pose and the basic reels 31a-31d stop spinning in sequence from the first basic reel 31a to the fourth basic reel 31d to show a symbol arrangement after the second stop of the extra reel 31e that results in the display of the selected function symbol. A win plate showing win information pops up on the secondary display 70 when the symbol arrangement includes a winning combination. The win meter 24g may be incremented and the win information may be also shown in the game message area 24c on the third display 24.

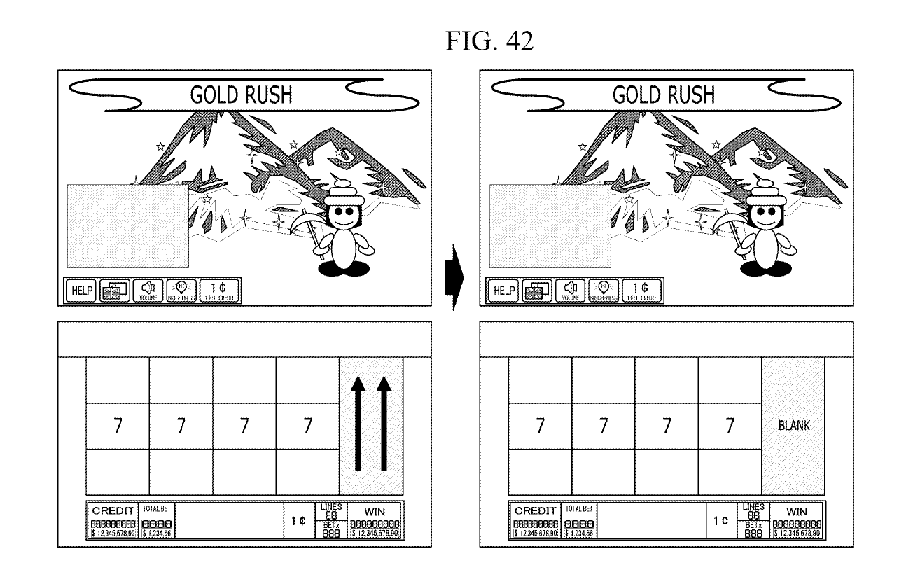

Referring to FIG. 42, the extra reel 31e spins fast in a reverse direction and stops spinning after the win plate vanishes such that the blank symbol BLK on the extra reel 31e returns to the display window 22.

Following Stop of Extra Reel without Chance Symbol Display

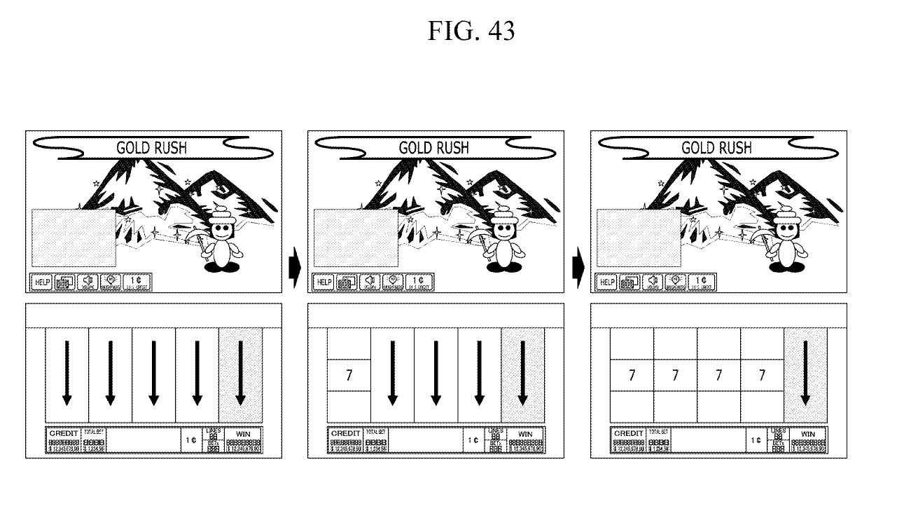

FIG. 43 to FIG. 45 illustrate operations of the displays of the gaming machine in a normal mode or in a free mode according to an embodiment of the present invention when the extra reel 31e starts spinning at substantially the same time as the basic reels 31a-31d and stops spinning after the basic reels 31a-31d stop spinning and when no chance symbol is selected to be displayed.

Referring to FIG. 43, the basic reels 31a-31d and the extra reel 31e start to spin in a simultaneous manner. The extra reel 31e may spin either slow or fast either in a forward direction or in a backward direction. The game message area 24c of the third display 24 may show a message “BONUS REELS IN PLAY” in a free game round.

After a predetermined time elapses from the start of the spinning, the basic reels 31a-31d stop spinning in sequence from the first basic reel 31a to the fourth basic reel 31d to show a symbol arrangement while the extra reel 31e maintains its spinning.

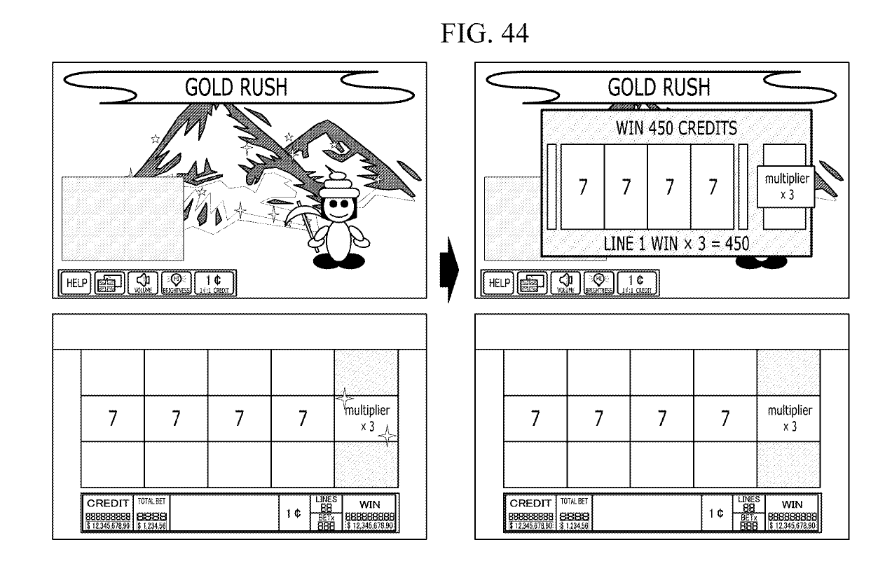

Referring to FIG. 44, the extra reel 31e stops spinning such that a selected function symbol, for example, a “3×” multiplier symbol is shown in the display window 22 after the basic reels 31a-31d stop their spinning. According to an embodiment of the present invention, the selected function symbol may be highlighted immediately after the extra reel 31e stops.

Thereafter, a win plate showing win information pops up on the secondary display 70 when the symbol arrangement on the basic reels 31a-31d includes a winning combination. The win meter 24g may be incremented and the win information may be also shown in the game message area 24c on the third display 24.

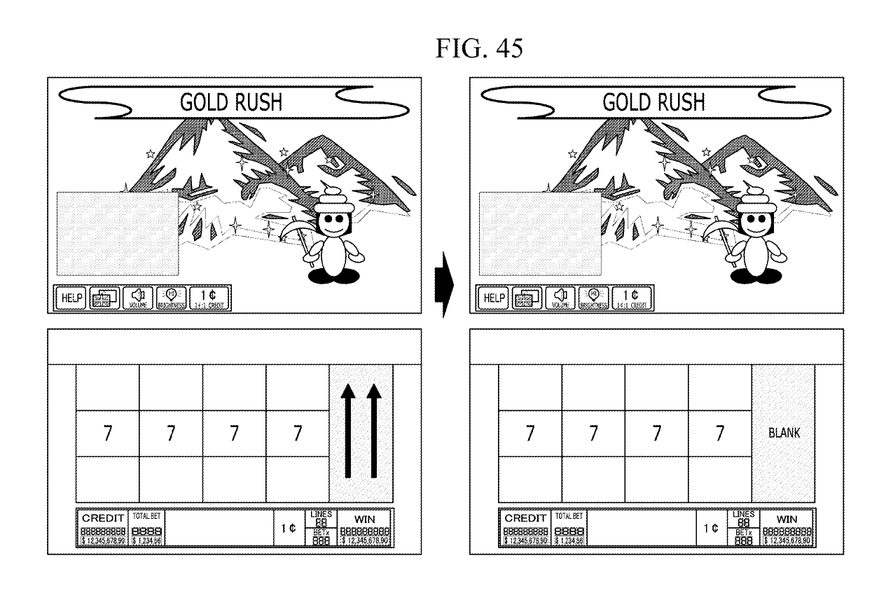

Referring to FIG. 45, the extra reel 31e spins fast in a reverse direction and stops spinning after the win plate vanishes such that the blank symbol BLK on the extra reel 31e returns to the display window 22.

Following Spin of Extra Reel without Chance Symbol Display

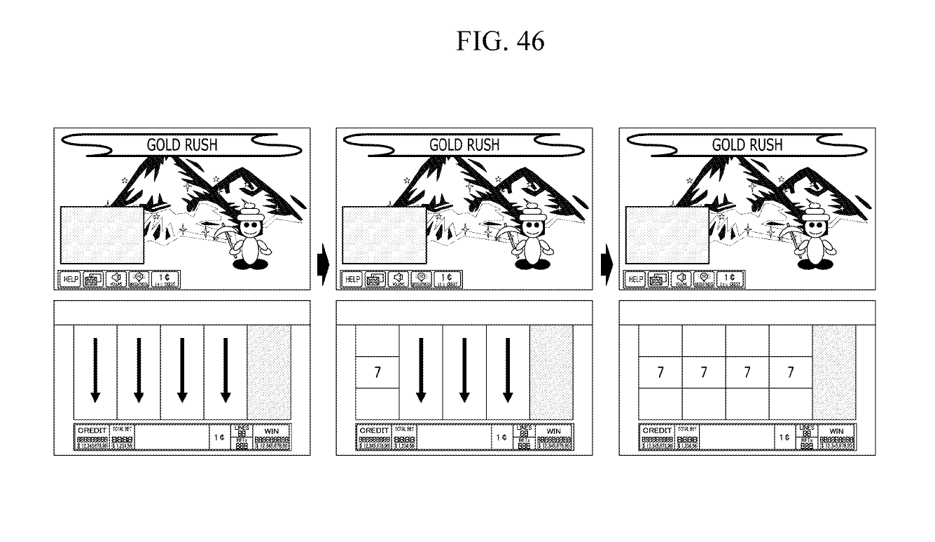

FIG. 46 to FIG. 49 illustrate operations of the displays of the gaming machine in a normal mode according to an embodiment of the present invention when the extra reel 31e starts spinning after the basic reels 31a-31d stop spinning and when no chance symbol is selected to be displayed.

Referring to FIG. 46, the basic reels 31a-31d start to spin in a simultaneous manner. After a predetermined time elapses from the start of the spinning, the basic reels 31a-31d stop spinning in sequence from the first basic reel 31a to the fourth basic reel 31d to show a symbol arrangement.

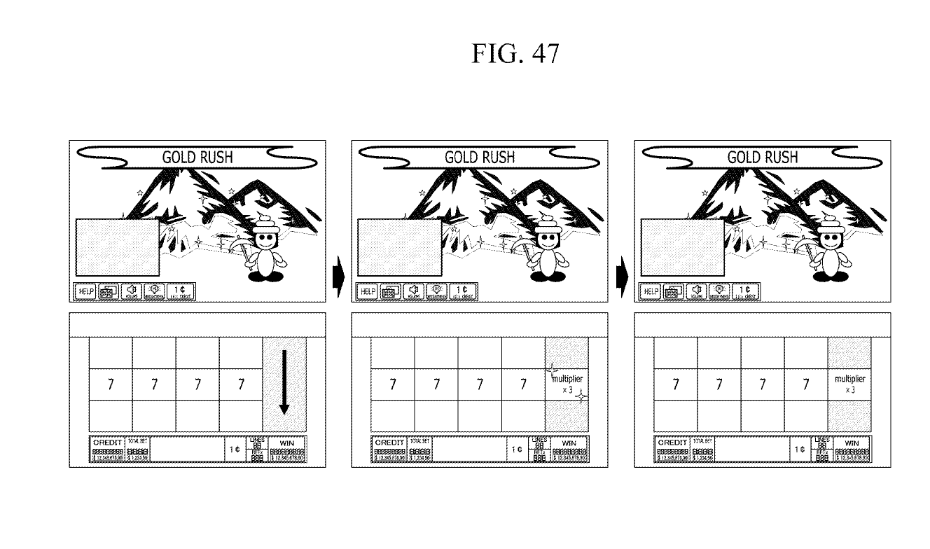

Referring to FIG. 47, the extra reel 31e starts spinning after the basic reels 31a-31d stop their spinning. The extra reel 31e may spin either slow or fast either in a forward direction or in a backward direction.

After a predetermined time elapses from the start of the spinning, the extra reel 31e stops spinning such that a selected function symbol, for example, a “3×” multiplier symbol is shown in the display window 22. According to an embodiment of the present invention, the selected function symbol may be highlighted immediately after the extra reel 31e stops.

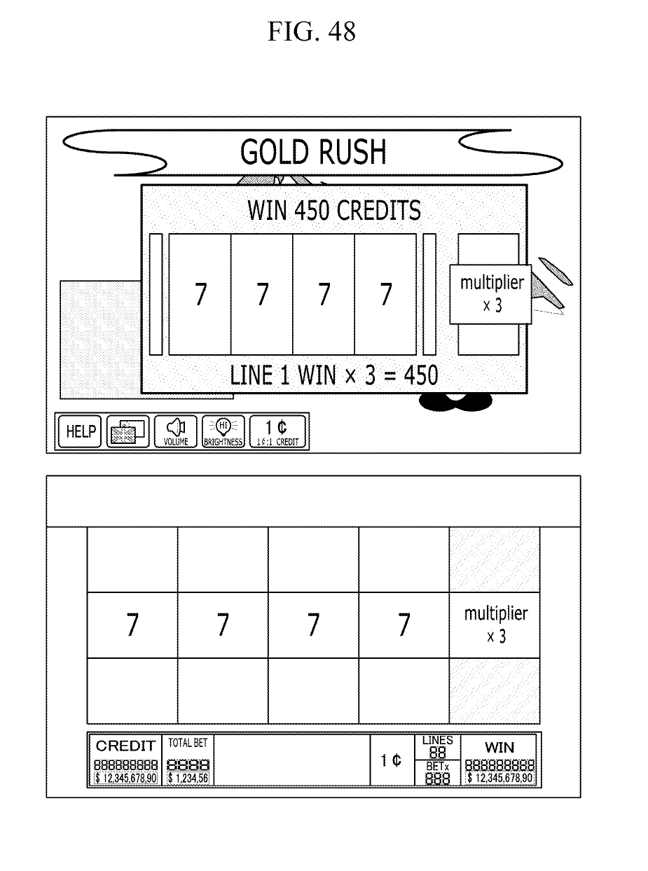

Referring to FIG. 48, a win plate showing win information pops up on the secondary display 70 when the symbol arrangement on the basic reels 31a-31d includes a winning combination. The win meter 24g may be incremented and the win information may be also shown in the game message area 24c on the third display 24.

Referring to FIG. 49, the extra reel 31e spins fast in a reverse direction and stops spinning after the win plate vanishes such that the blank symbol BLK on the extra reel 31e returns to the display window 22.

Following Spin of Extra Reel with Chance Symbol Display

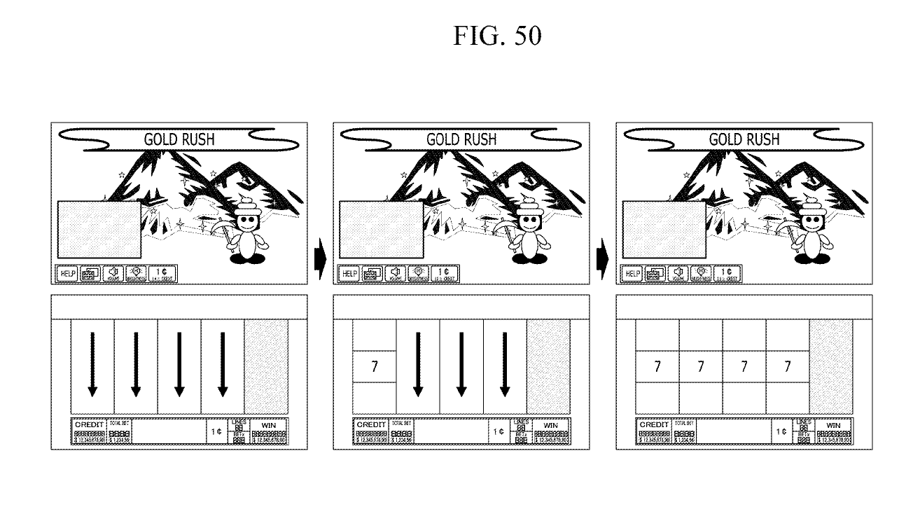

FIG. 50 to FIG. 56 illustrate operations of the displays of the gaming machine in a normal mode or in a free mode according to an embodiment of the present invention when the extra reel 31e starts spinning after the basic reels 31a-31d stop spinning and when a chance symbol is selected to be displayed.

Referring to FIG. 50, the basic reels 31a-31d start to spin in a simultaneous manner. After a predetermined time elapses from the start of the spinning, the basic reels 31a-31d stop spinning in sequence from the first basic reel 31a to the fourth basic reel 31d to show a symbol arrangement. The game message area 24c of the third display 24 may show a message “BONUS REELS IN PLAY” in a free game round.

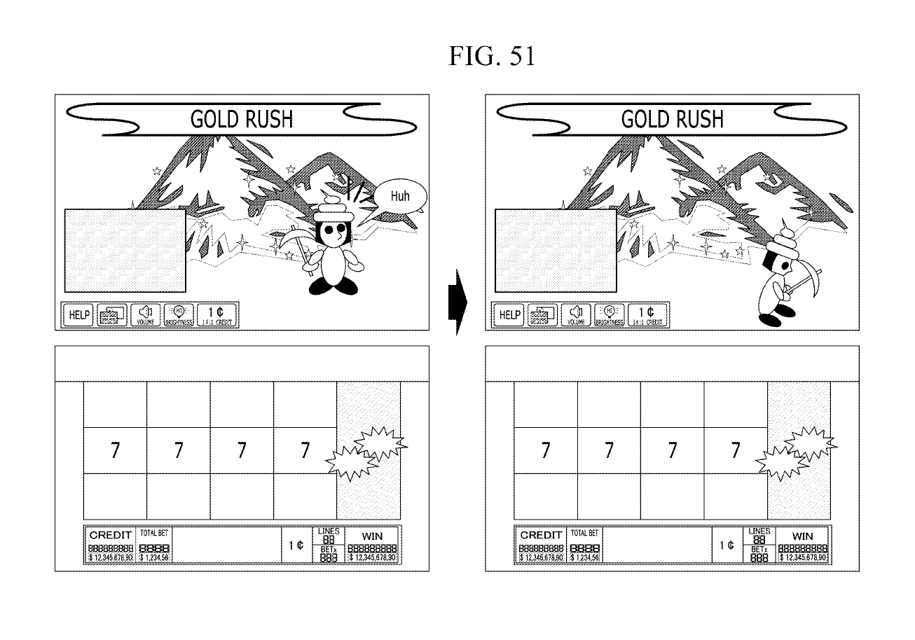

Referring to FIG. 51, the extra reel 31e tries to move or move little by little after the basic reels 31a-31d stop their spinning. The character 73 carrying a pickaxe with a right hand on the secondary display 70 takes a notice of the movement trial of the extra reel 31e. Once detecting the movement trial of the extra reel 31e, the character 73 holds the pickaxe in both hands.

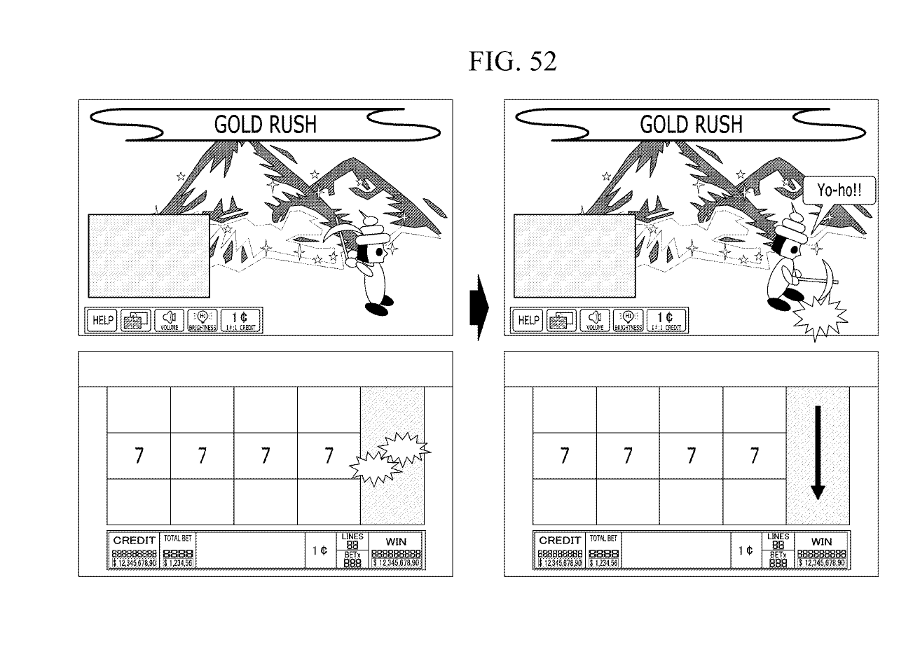

Referring to FIG. 52, the character 73 pulls up the pickaxe and strikes the extra reel 31e with the pickaxe such that the extra reel 31e starts to spin. The extra reel 31e may spin either slow or fast either in a forward direction or in a backward direction.

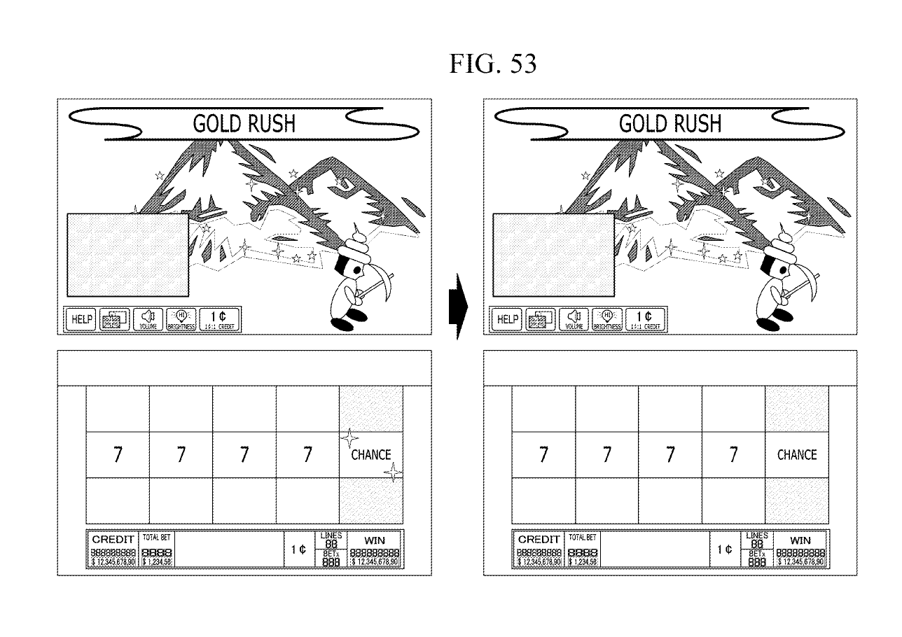

Referring to FIG. 53, the extra reel 31e stops spinning such that a chance symbol is shown in the display window 22 after a predetermined time elapses from the start of the spinning According to an embodiment of the present invention, the rest chance symbol may be highlighted immediately after the extra reel 31e stops. The character 73 may maintain his or her pose with holding the pickaxe in both hands during the spinning of the extra reel 31e.

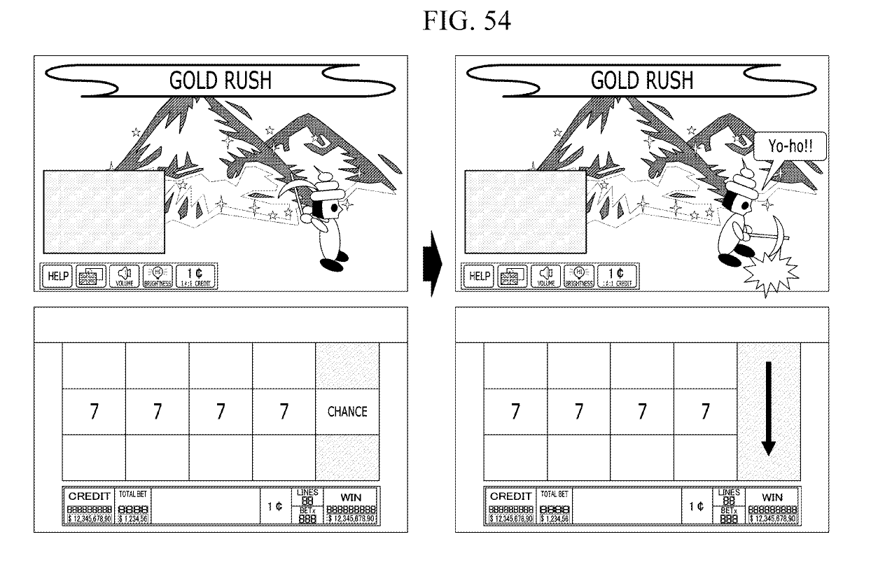

Referring to FIG. 54, the character 73 pulls up the pickaxe again and strikes the rest extra reel 31e with the pickaxe such that the extra reel 31e spins again while the basic reels 31a-31d maintain their rest state.

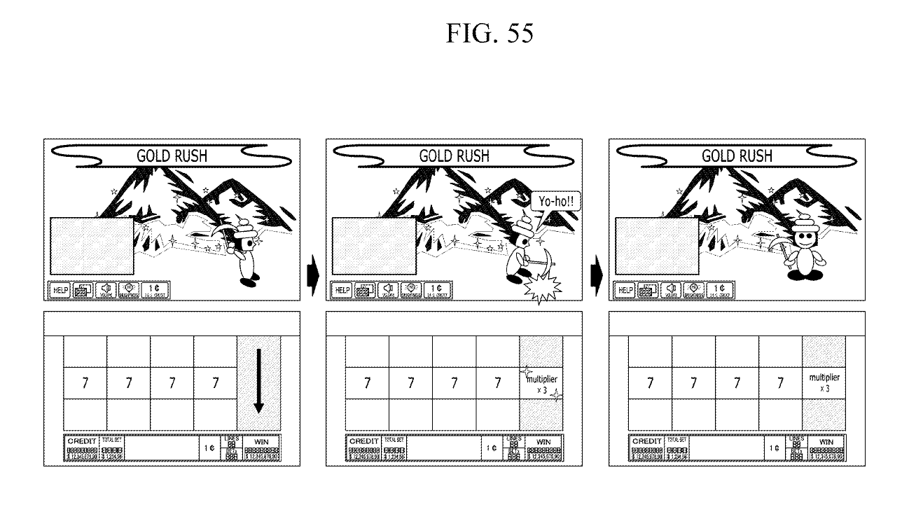

Referring to FIG. 55, the character 73 pulls up the pickaxe again and strikes the spinning extra reel 31e. The extra reel 31e struck by the pickaxe stops spinning again to show a selected function symbol, for example, a “3×” multiplier symbol. According to an embodiment of the present invention, the selected function symbol may be highlighted immediately after the extra reel 31e stops. The character 73 returns to his or her ordinary pose after the second stop of the extra reel 31e.

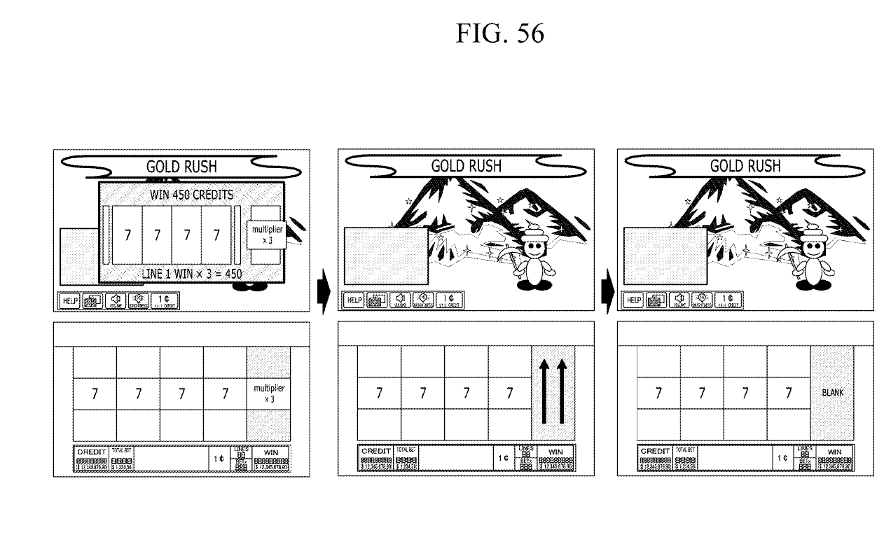

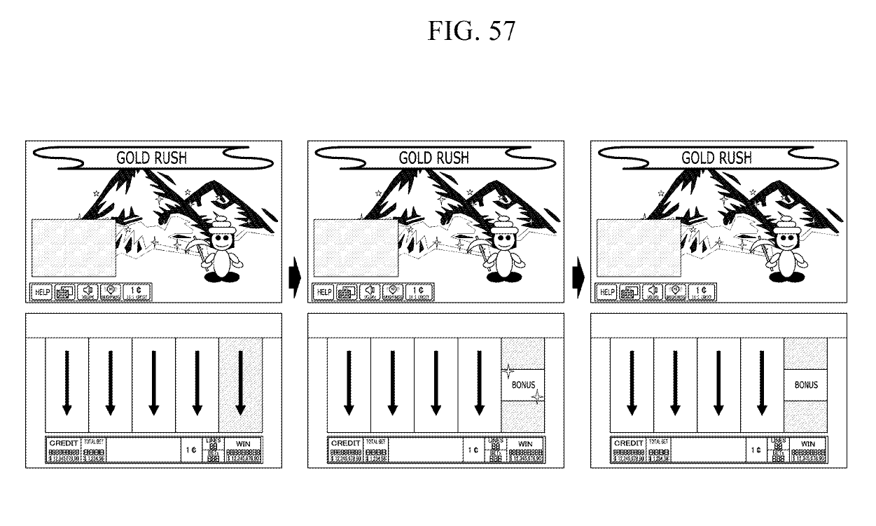

Referring to FIG. 56, a win plate showing win information pops up on the secondary display 70 when the symbol arrangement includes a winning combination. The win meter 24g may be incremented and the win information may be also shown in the game message area 24c on the third display 24.

Thereafter, the extra reel 31e spins fast in a reverse direction and stops spinning after the win plate vanishes such that the blank symbol BLK on the extra reel 31e returns to the display window 22.

Triggering of Free Mode and Selection of the Number of Free Rounds

FIG. 57 to FIG. 61 illustrate operations of the displays of the gaming machine in transition from a normal mode to a free mode according to an embodiment of the present invention.

Referring to FIG. 57, the basic reels 31a-31d and the extra reel 31e start to spin in a simultaneous manner. The extra reel 31e may spin either slow or fast either in a forward direction or in a backward direction.

After a predetermined time elapses from the start of the spinning, the extra reel 31e stops spinning such that a bonus effect symbol “BONUS” is shown in the display window 22, while the basic reels 31a-31d maintain their spinning. According to an embodiment of the present invention, the extra reel 31e may stop to show a chance symbol before showing the bonus effect symbol “BONUS,” and, thereafter, the extra reel 31e may spin again and stop to show the bonus effect symbol “BONUS.” According to an embodiment of the present invention, the bonus effect symbol may be highlighted immediately after the extra reel 31e stops.

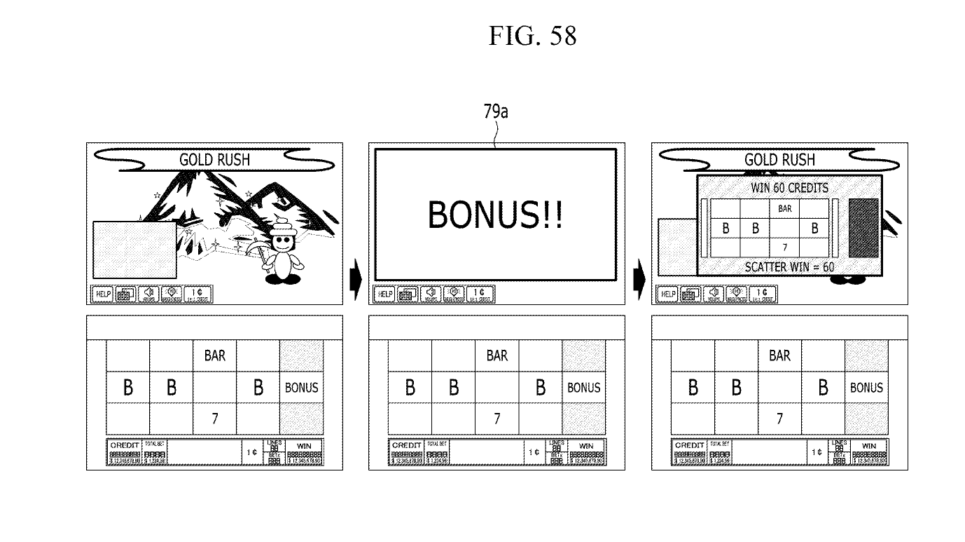

Referring to FIG. 58, the basic reels 31a-31d stop spinning in sequence from the first basic reel 31a to the fourth basic reel 31d to show a symbol arrangement including three or more bonus symbols denoted by “B” after the extra reel 31e stop spinning. Thereafter, a message window 79a informing that a bonus mode (or a free mode) is triggered pops up on the secondary display 70. After the message window 79a disappears, a win plate showing win information pops up on the secondary display 70 since the bonus symbols form a scattering win. The win meter 24g may be incremented, and the win information may be also shown in the game message area 24c on the third display 24. FIG. 58 shows that three bonus symbols are scattered and a basic win prize for the three scattered bonus symbols are 60 credits.

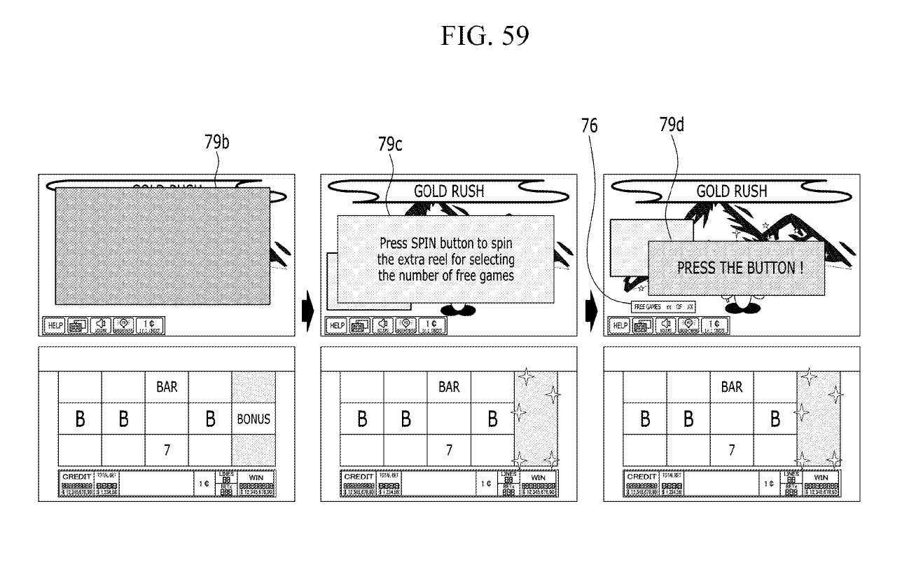

Referring to FIG. 59, a message window 79b introducing a free mode pops up on the secondary display 70 after the win plate vanishes. After the message window 79b disappears, a message window 79c informing that the number of free rounds executed in the free mode is determined by spinning the extra reel 31e pops up, maintains for a time, and vanishes. Subsequently, another message window 79d urging the player to press the spin button 43 pops up, and a free mode round counter 76 informing of the serial number of a current free round and a total number of the free rounds may appear under the payout table 74 on the secondary display 70. According to an embodiment of the present invention, the extra reel 31e may be highlighted while the message windows 79c and 79d are shown on the secondary display 70.

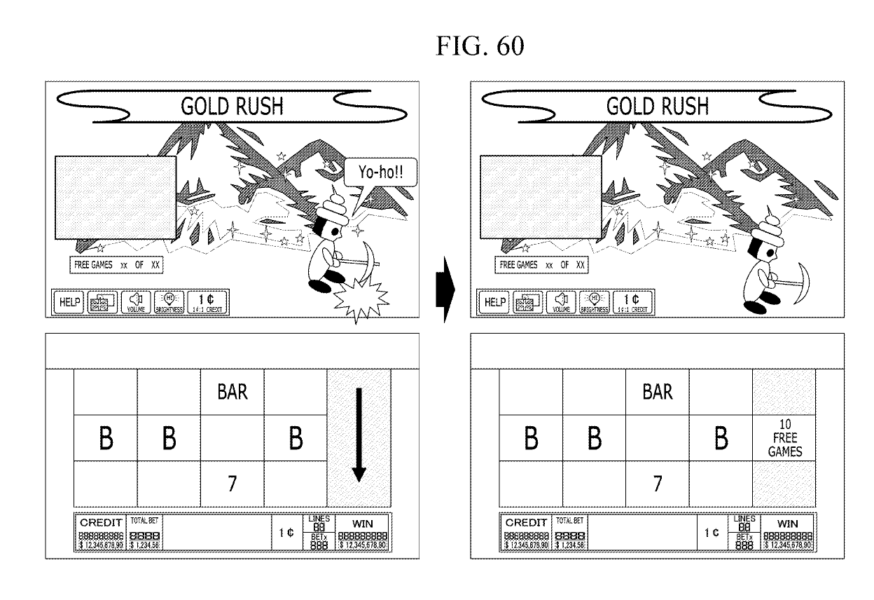

Referring to FIG. 60, after the player presses the spin button 43, the character 73 strikes the extra reel 31e to spin and stop such that one of the determinant symbols “6FG,” “8FG,” “10FG,” and “12FG” stops in the display window 22. FIG. 60 shows that the selected number of the free rounds in the free mode is ten, that is, the selected determinant symbol is “10FG.”

According to an embodiment of the present invention, the pop up of the message window 79d urging the player to press the spin button 43 and the process of the spin button pressing by the player may be omitted. The spin and stop of the extra reel 31e to show one of the determinant symbols “6FG,” “8FG,” “10FG,” and “12FG” with or without the striking action of the character 73 may be executed without any input from the player.

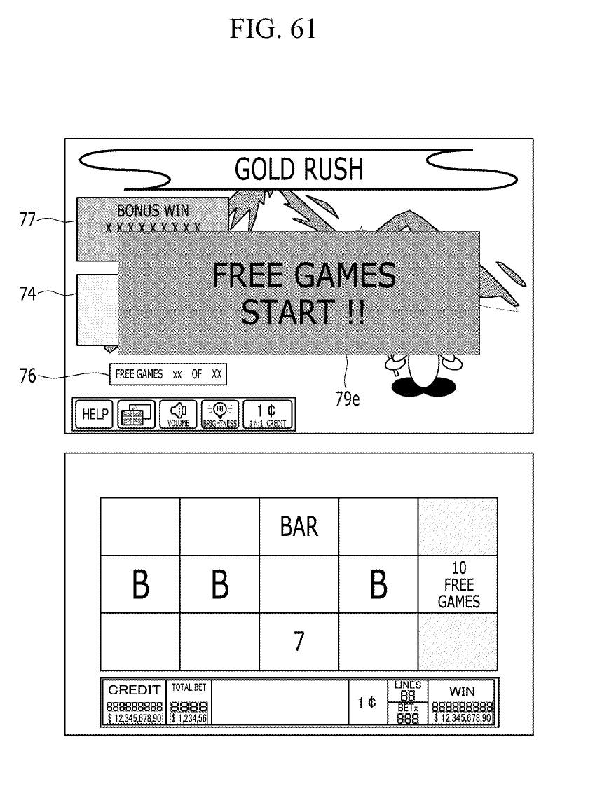

Referring to FIG. 61, after selecting the selected number of the free rounds, a message window 79e informing that a free round starts pops up on the secondary display 70. In addition, a free mode win meter 77 showing a payout credits for win in a free mode may appear over the payout table 74.

Retriggering of Free Mode and Selection of the Number of Additional Free Rounds

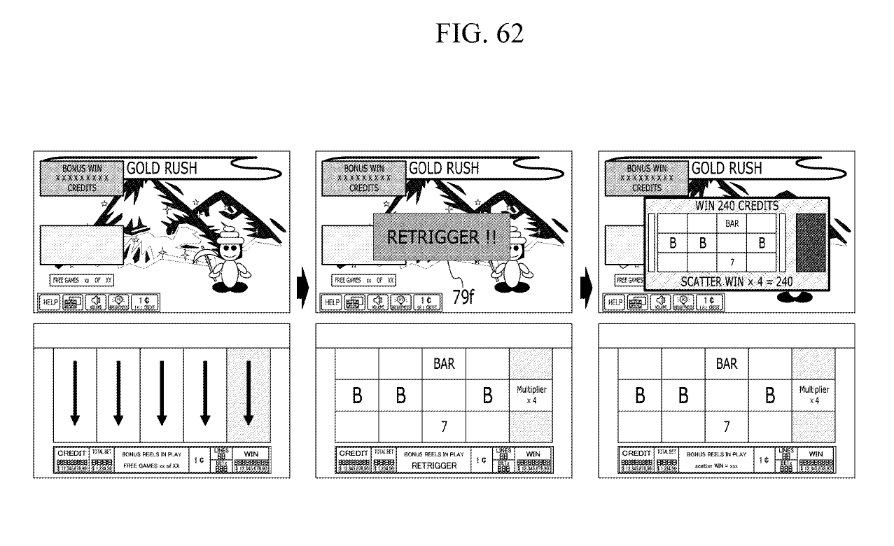

FIG. 62 to FIG. 66 illustrate operations of the displays of the gaming machine in a free mode when a free mode is retriggered according to an embodiment of the present invention.

Referring to FIG. 62, the basic reels 31a-31d and the extra reel 31e start to spin in a simultaneous manner. The extra reel 31e may spin either slow or fast either in a forward direction or in a backward direction. The game message area 24c of the third display 24 may show a message “BONUS REELS IN PLAY” and a free mode round counter informing of a serial number of a current free round and a total number of free rounds in a form “FREE GAMES XX OF XX.”

The basic reels 31a-31d and the extra reel 31e stop to show a symbol arrangement including three or more bonus symbols on the basic reels 31a-31d and a selected function symbol on the extra reel 31e. FIG. 62 shows that the selected function symbol is a “4×” multiplier symbol. The pattern of spin and stop of the reels 31a-31e may be one of the above-described patterns that are applicable to a free mode. According to an embodiment of the present invention, the extra reel 31e may firstly stop to show a chance symbol before the basic reels 31a-31d and the extra reel 31e stop to show the symbol arrangement and the selected function symbol.

Thereafter, a message window 79f informing that a bonus mode (or a free mode) is retriggered pops up on the secondary display 70. FIG. 62 shows that the message window 79f displays a message “RETRIGGER!!” In addition, the game message area 24c of the third display 24 may show a message “RETRIGGER.”

After the message window 79f disappears, a win plate showing win information pops up on the secondary display 70 since the bonus symbols form a scattering win. The free mode win meter 77 may be incremented, and the win information may be also shown in the game message area 24c on the third display 24. FIG. 62 shows a scatter win of a basic win prize of 60 credits and a total win prize of 240 credits that is obtained by multiplying the basic win prize by a multiplier value (i.e. three times) of the “4×” multiplier symbol on the extra reel 31e, which is displayed in the display window 22.

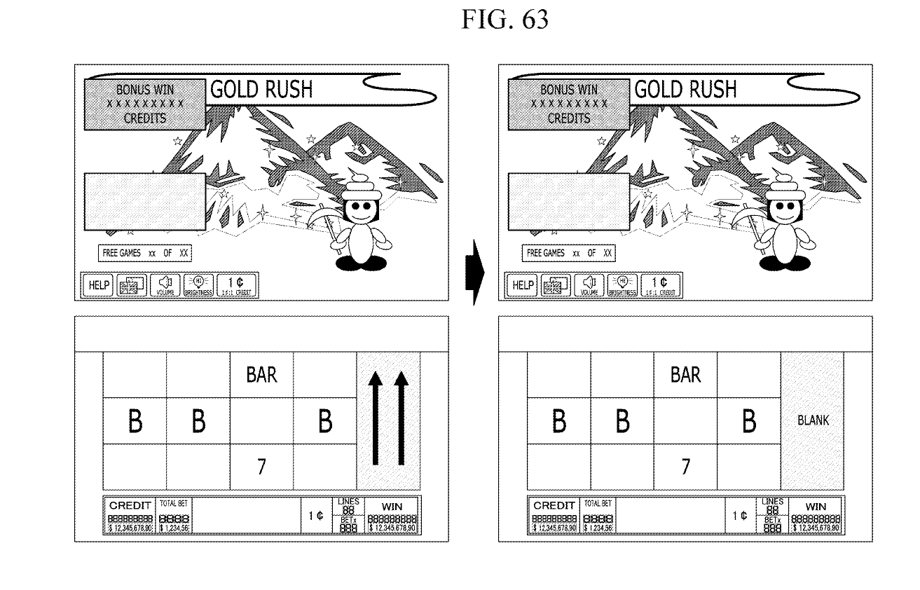

Referring to FIG. 63, the extra reel 31e spins fast in a reverse direction and stops spinning after the win plate vanishes such that the blank symbol BLK on the extra reel 31e returns to the display window 22.

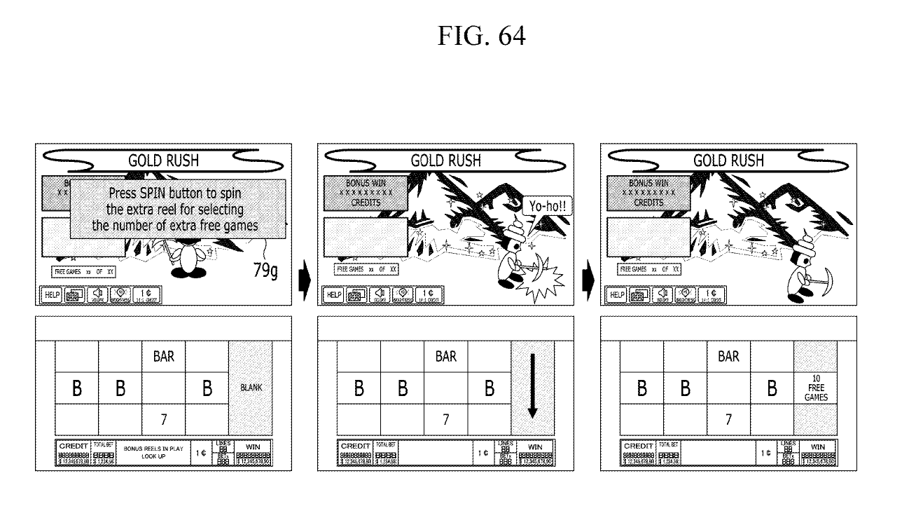

Referring to FIG. 64, a message window 79g urging a player to press the spin button 43 to select the number of additional free rounds pops up. In addition, the game message area 24c of the third display 24 may show a message “LOOK UP.”

After the player presses the spin button 43, the character 73 strikes the extra reel 31e to spin and stop such that one of the determinant symbols “6FG,” “8FG,” “10FG,” and “12FG” stops in the display window 22. FIG. 60 shows that the selected number of the free rounds in the free mode is ten, that is, the selected determinant symbol is “10FG.”

According to an embodiment of the present invention, the pop up of the message window 79d urging the player to press the spin button 43 and the process of the spin button pressing by the player may be omitted. The spin and stop of the extra reel 31e to show one of the determinant symbols “6FG,” “8FG,” “10FG,” and “12FG” with or without the striking action of the character 73 may be executed without any input from the player.

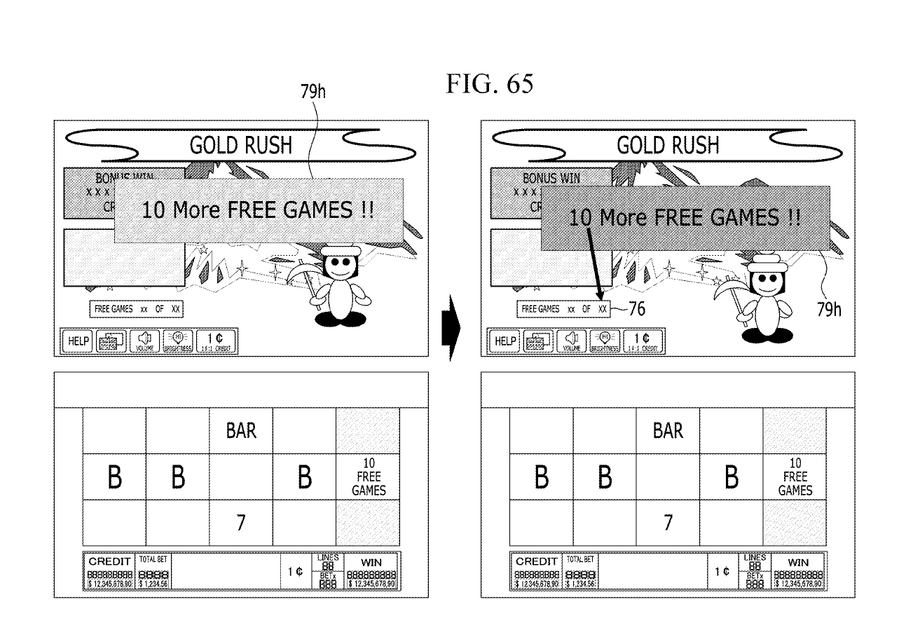

Referring to FIG. 65, a message window 79h informing of the selected number of additional free rounds pops up on the secondary display 70. In addition, the selected number of additional free rounds is added to the free mode win meter 77.

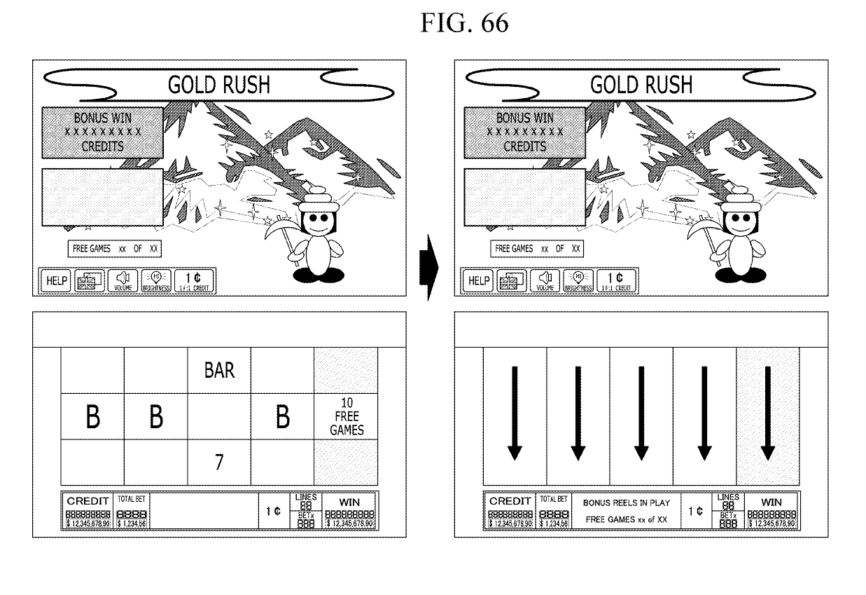

Referring to FIG. 66, the message window 79h vanishes after the addition of the selected number of additional free rounds. Thereafter, the reels 31a-31e start spinning for a new free round.

Addition of Free Rounds

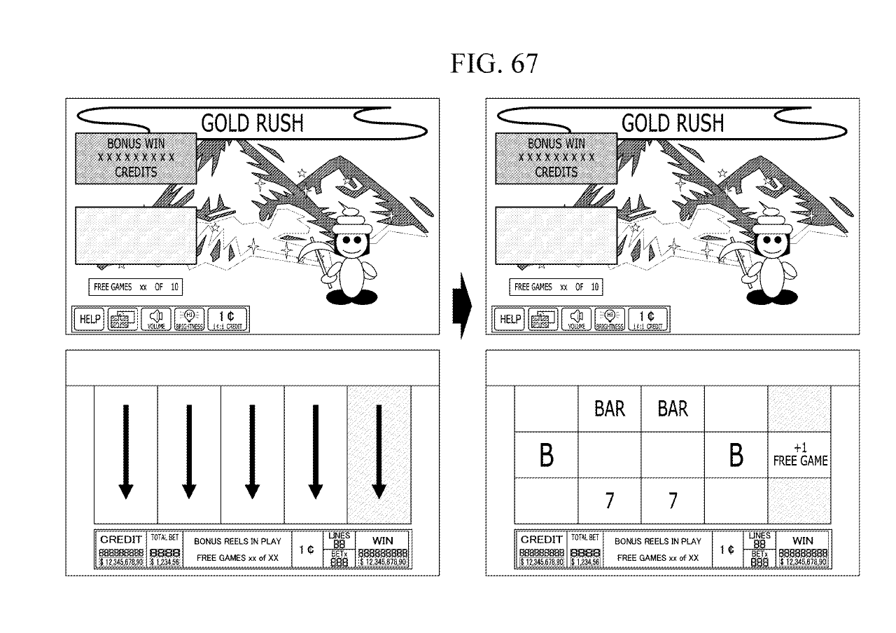

FIG. 67 to FIG. 70 illustrate operations of the displays of the gaming machine in a free mode when extra free rounds are added according to an embodiment of the present invention.

Referring to FIG. 67, the basic reels 31a-31d and the extra reel 31e start to spin in a simultaneous manner. The extra reel 31e may spin either slow or fast either in a forward direction or in a backward direction. The game message area 24c of the third display 24 may show a message “BONUS REELS IN PLAY” and a free mode round counter.

The basic reels 31a-31d and the extra reel 31e stop to show a symbol arrangement on the basic reels 31a-31d and a selected adder symbol on the extra reel 31e. FIG. 67 shows that the selected adder symbol is an “FG_{—}1” adder symbol denoted by “+1 FREE GAME.” The pattern of spin and stop of the reels 31a-31e may be one of the above-described patterns that are applicable to a free mode.

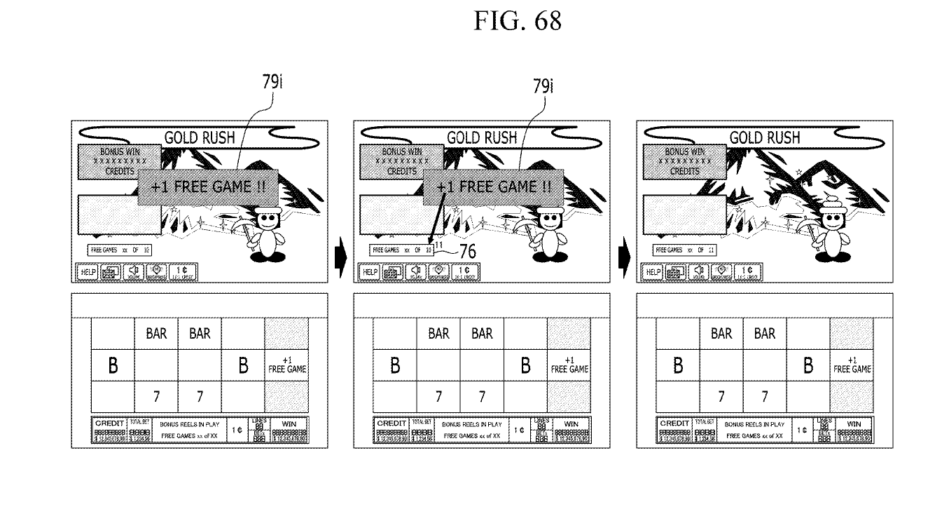

Referring to FIG. 68, a message window 79i informing that one or more extra free rounds are added pops up on the secondary display 70. FIG. 68 shows that the message window 79i displays a message “+1 FREE GAME!!”

Thereafter, the number of the extra free round in the message on the secondary display 70 moves toward the free mode round counter 76, and the number of the extra free round is added to the total number of the free rounds in the free mode round counter 76.

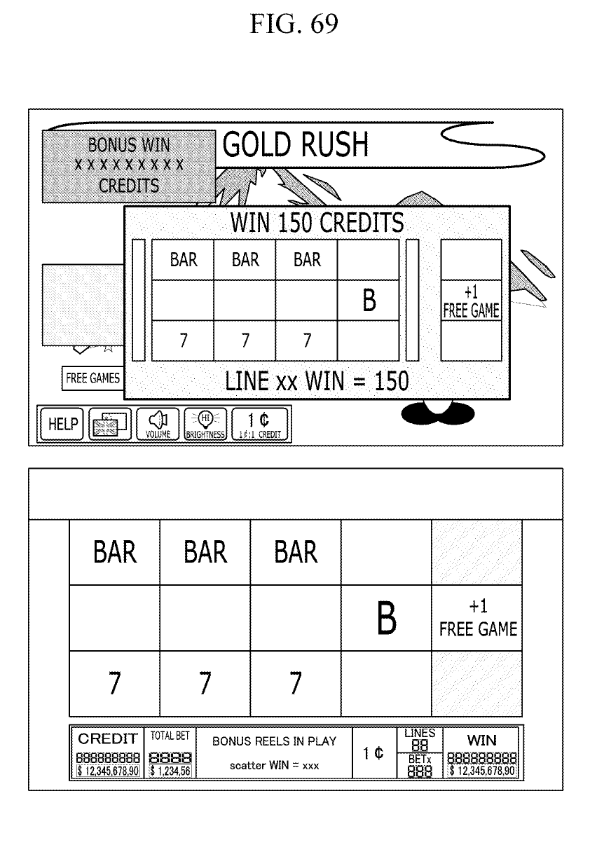

Referring to FIG. 69, after the message window 79i disappears, a win plate showing win information pops up on the secondary display 70 when the symbol arrangement on the basic reels 31a-31e includes one or more winning combinations. The free mode win meter 77 may be incremented, and the win information may be also shown in the game message area 24c on the third display 24. FIG. 62 shows two line wins, and one of the line wins provides a basic win prize of 150 credits.

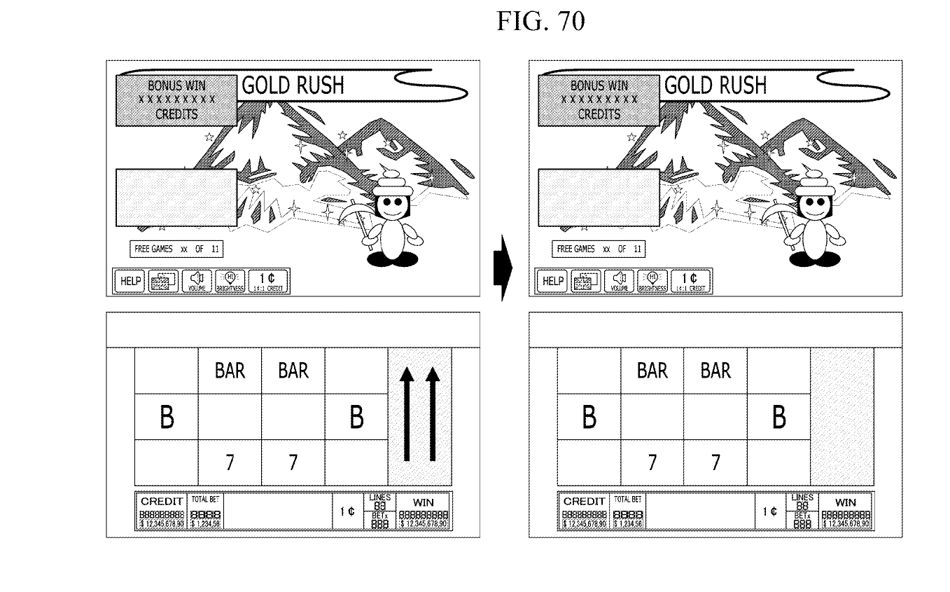

Referring to FIG. 70, the extra reel 31e spins fast in a reverse direction and stops spinning after the win plate vanishes such that the blank symbol BLK on the extra reel 31e returns to the display window 22.

When the gaming machine 1 renders the effects as described above with reference to FIG. 23 to FIG. 70, the gaming machine 1 may use an execution program that may refer to various files such as data sheets. However, according to an alternative embodiment of the present invention, the gaming machine 1 may use a game program into which various rendering pattern data are programmed and complied by the programming language.

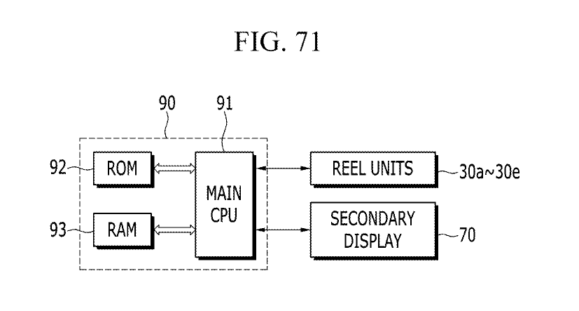

A method of performing effects using an execution program is described with reference to FIG. 71 to FIG. 75C.

First, an electrical structure of a gaming machine according to an embodiment of the present invention is described in detail with reference to FIG. 71.

FIG. 71 is a schematic electrical block diagram of a gaming machine according to an embodiment of the present invention.

Referring to FIG. 71, the gaming machine 1 includes a motherboard 90. The motherboard 90 may include a main CPU 91, a ROM 92, and a RAM 93 interconnected by an internal bus.

The ROM 92 may be configured to store a program to be executed by the main CPU 91 such as BIOS, along with other data to be maintained permanently. The RAM 93 may stores data and an execution program that are used in the operation of the main CPU 91. The RAM 93 may include a working space for executing the programs. The RAM 93 may further store various tables for the operation of the game. The main CPU 91 may execute the execution program.

The motherboard 90 is connected to reel units 30a to 30e and a secondary display 70. The main CPU 91 may execute commands in data sheets when performing a rendering effect process using the execution program. Accordingly, the main CPU 91 may control the reel units 30a to 30e and the secondary display 70 based on the commands executed by the execution program.

For example, the main CPU 91, i.e., a controller of the gaming machine 1 selects a rendering pattern (or a scenario) from the rendering pattern table shown in FIG. 30A and FIG. 30B using the execution program. Each of scenarios can be executed based on commands that are included in a data sheet that may be generated and provided by a gaming machine development system.

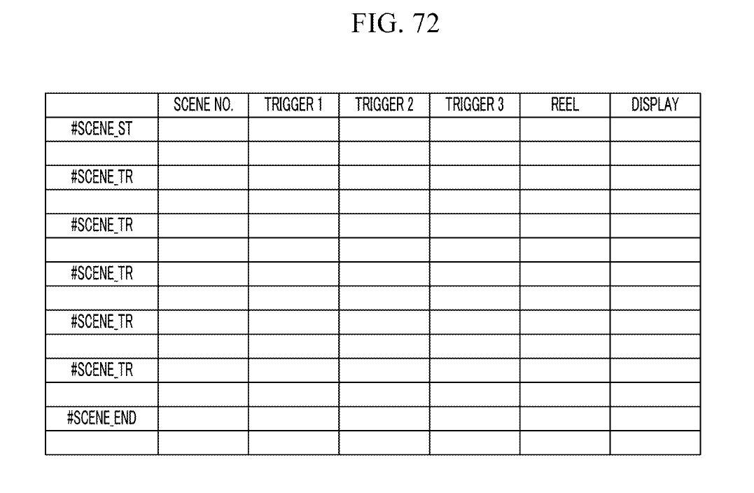

Now, a data generating method of a gaming machine development system according to embodiments of the present invention is described in detail with reference to FIG. 72.

Example of Data Sheet

FIG. 72 is a schematic diagram of a data sheet provided by a gaming machine development system according to an embodiment of the present invention.

Referring to FIG. 72, a gaming machine development system provides a data sheet having an editable format such as a spreadsheet. Commands for a gaming operation of a gaming machine may be input to the data sheet, which is stored in the gaming machine development system. Some of the commands may be used in controlling a plurality of reels (31a to 31e of FIG. 2) and other commands may be used in controlling the secondary display 70.

The data sheet includes a plurality of row and a plurality of columns defining a plurality of cells. Each cell is editable, and a corresponding command is input into each cell. The data sheet further includes a plurality of field names that correspond to the plurality of columns, respectively. The field names include field names indicating the reels 31a to 31e and/or the secondary display 70. The field names may further include a field name indicating a trigger for triggering each of the plurality of rows and a field name indicating a scene number corresponding to each of the plurality of rows. When each of the rows is triggered, commands that are input to each of the rows may be executed in synchronization with each other.

In an example shown in FIG. 72, the plurality of field names include a scene number denoted by “SCENE NO”, a plurality of triggers denoted by “TRIGGER 1,” “TRIGGER 2,” and “TRIGGER 3”, and a plurality of device names. The plurality of device names include a reel field for a column that is predefined to be associated with a plurality of reels 31a to 31e and a display field for a column that is predefined to be associated with a secondary display 70.

Any one of a plurality of tags is input into a beginning of each row and indicates a function of each row. The plurality of tags are used for synchronization of commands included in the plurality of columns. The plurality of tags may include a scene start tag (#SCENE_ST), a scene trigger tag (#SCENE_TR), and a scene end tag (#SCENE_END). The scene end tag (#SCENE_END) may be omitted. A scene corresponds to a rendering effect for the gaming machine 1. The scene start tag (#SCENE_ST) is input to a row including commands to be executed when each scene starts. The scene trigger tag (#SCENE_TR) is input to a row including commands to be executed when a triggering condition is satisfied after the scene start tag (#SCENE_ST). The scene end tag (#SCENE_END) is input to a row including commands to be executed when each scene ends.

The scene number (SCENE NO) indicates a number of the scene and corresponds to a priority for defining an order of execution of commands for a plurality of scenes. The scene number (the priority) may start from zero and be incremented to nine. The scene number may be incremented by one when the scene is changed.

The plurality of triggers may include a trigger (TRIGGER 1 and TRIGGER 2) for indicating a triggering condition of a scene trigger and a trigger (TRIGGER 3) for indicating a start or an end of the scene. The trigger (TRIGGER 1) indicates a triggering condition for triggering each row, and the trigger (TRIGGER 2) indicates a delay between a time when the triggering condition is satisfied and a time when commands are executed. “START” is input to the trigger (TRIGGER 3) when the scene is in progress by at least one of the reels 31a to 31e that is spinning, and “END” is input to the trigger (TRIGGER 3) when all of the reels 31a to 31e are stopped. Accordingly, “START” may be input to the trigger (TRIGGER 3) of rows having the scene start tag (#SCENE_ST) or the scene trigger tag (#SCENE_TR), and “START” may be input to the trigger (TRIGGER 3) of rows having the scene end tag (#SCENE_END).

When a plurality of scene numbers (SCENE NO) are input to the data sheet, commands are in the order of scene number (SCENE NO) in the gaming machine 1. That is, commands that are input to rows having the smallest scene number (SCENE NO=0) are first performed, and commands that are input to rows having the largest scene number (SCENE NO=9) are performed last. Further, in rows having the same scene number (SCENE NO), commands are performed in order of rows having the scene start tag (#SCENE_ST), rows having the scene trigger tag (#SCENE_TR), and rows having the scene end tag (#SCENE_END). Furthermore, in rows having the scene trigger tag in the same scene number (SCENE NO), commands are performed in order of a triggering condition (TRIGGER 1 and/or TRIGGER 2). Accordingly, the order of execution for the commands is defined based on the tag, the scene number (the priority), and the triggering condition.

In some embodiments, the order of execution for the commands may be defined based on the scene number (the priority) and the triggering condition without the tag. That is, a game program or an execution program can identify that commands are executed in order of scene number. Further, the game program or the execution program can identify that commands of rows having no triggering condition are first executed and then commands of rows having the triggering condition are executed in the same scene number because the rows having no triggering condition (TRIGGER 1 or TRIGGER 2) correspond to the scene start tag. Furthermore, the game program or the execution program can identify that commands of rows are executed in order of triggering condition. In this case, the scene end tag may not be used in the data sheet.

A filename of a reel control file for controlling the plurality of reels 31a to 31e is input to the reel field as a command. The reel control file includes information for controlling the reels 31a to 31e, and may include, for example, a speed for rotating each of the reels 31a to 31e, a direction for rotating each of the reels 31a to 31e, a time for stopping each of the reels 31a to 31e, and/or a moving pattern of each of the reels 31a to 31e. The reel control file may be a comma-separated values (CSV) file.

A filename of a display control file for controlling the secondary display 70 is input to the display field as a commands. The display control file includes information for controlling the secondary display 70, and may include, for example, information for the images to be rendered depending to the time. The display control file may be a CSV file.

The data sheets generated and stored by the gaming machine development system are provided for the gaming machine 1. In this case, the data sheets may be transferred to the gaming machine 1 through a wire or wireless network, and the transferred data sheets may be stored to a memory of the gaming machine 1, for example a RAM 93 or a ROM 92. Alternatively, a data storage device storing the data sheets may be provided to the gaming machine 1. The data storage device may be a storage device of the gaming machine 1, for example a memory card. The gaming machine 1 may copy the data sheets stored to the data storage device to its memory, for example the RAM 93 or ROM 92. Next, a controller of the gaming machine 1 executes the commands of the data sheets using an execution program. Since each column of the data sheet is predefined to be associated with the reels 31a to 31e or the secondary display 70 of the gaming machine 1, the controller can execute the command of each field to control the reels 31a to 31e and the secondary display 70.

Alternatively, the gaming machine development system may generates a program based on the data sheets. For example, the gaming machine development system may combine the commands of the data sheets 110 with a basic program such that the program may be generated. In this case, the basic program may be a program including a plurality of subroutines for interpreting the commands of the data sheets. That is, the data sheets may be compiled by the basic program. The generated program may be transferred or provided to the gaming machine 1, and the program may be stored to a memory of the gaming machine 1. Alternatively, a data storage device storing the data sheets may be provided to the gaming machine 1. Next, the controller of the gaming machine 1 executes the program to control the reels 31a to 31e and the secondary display 70 according to the commands of the data sheets included in the program.

As such, according to an embodiment of the present invention, a user can easily input to the data sheets commands for controlling the reels 31a to 31e and the secondary display 70, thereby generating the commands for synchronizing movements of the reels 31a to 31a with movements of the character 73 on the secondary display 70.

Example of Data Sheet for Rendering Effect

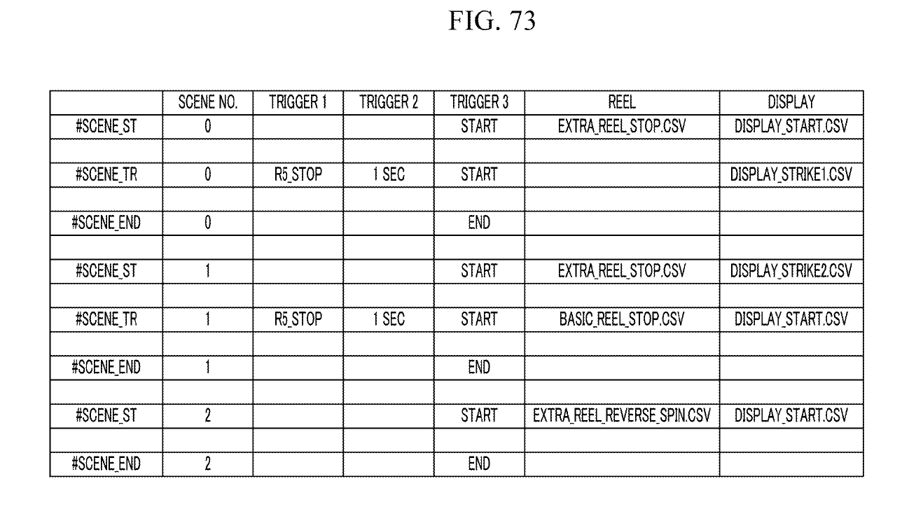

Next, an example of a data sheet for the rendering effect shown in FIG. 65 is described in detail with reference to FIG. 73 to FIG. 75C.

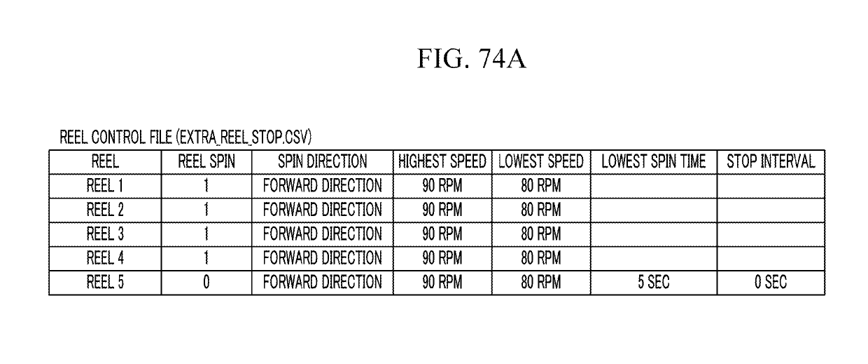

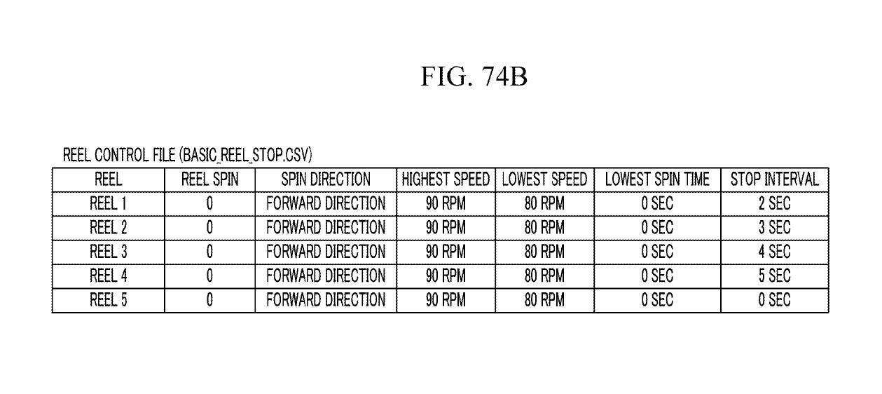

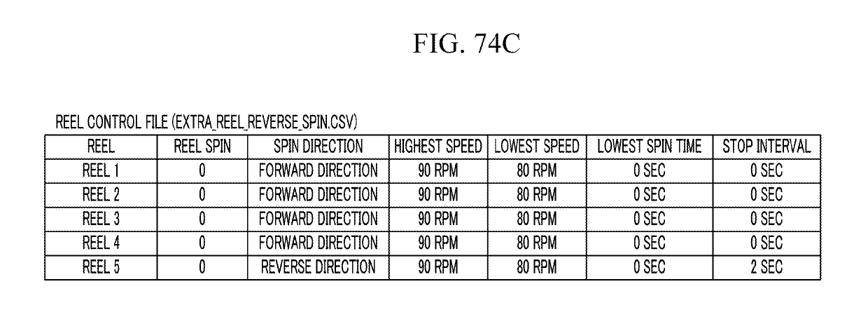

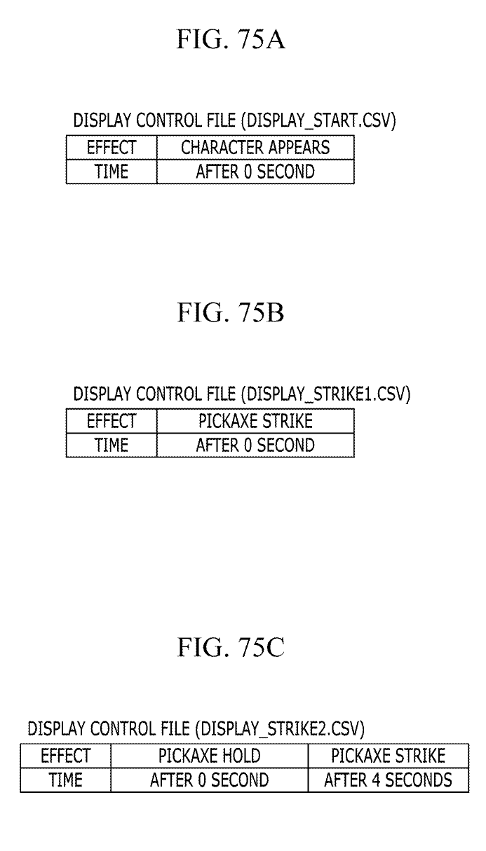

FIG. 73 is a schematic diagram of an example data sheet for a rendering effect 6 according to an embodiment of the present invention, FIG. 74A, FIG. 74B, and FIG. 74C are schematic diagrams of example reel controls file shown in FIG. 73, and FIG. 75A, FIG. 75B, and FIG. 75C are schematic diagrams of example reel controls file shown in FIG. 73.

The case shown in FIG. 38 to FIG. 42 is exemplified in FIG. 73. Accordingly, commands for rendering this rendering pattern are input to the data sheet as shown in FIG. 73.

Referring to FIG. 73, a scene start tag (#SCENE_ST) is first input to at least one row for a start of the first scene (SCENE NO=0). It is assumed in FIG. 73 that the scene start tag (#SCENE_ST) is input to one row. When inputting the scene start tag (#SCENE_ST), a user may input “START” to a trigger (TRIGGER 3) of the row to which the scene start tag (#SCENE_ST) is input.

In the first scene (SCENE NO=0), after a plurality of reels 31a to 31e start spinning, the extra reel 31e stops spinning to show a chance symbol while the basic symbols 31a-31d maintaining the spinning as shown in FIG. 38 and FIG. 39. A filename (EXTRA_REEL_STOP.CSV) of a reel control file for controlling these movements of the reels 31a to 31e is input to a reel field of the data sheet. Accordingly, the gaming machine 1 may spin the reels 31a to 31e according to information included in the reel control file when the scene starts.

Referring to FIG. 74A, the reel control file includes commands for controlling each of the reels 31a to 31e. An example of the reel control file includes a reel number (REEL), a reel spin, a spin direction, a highest speed, a lowest speed, a lowest spin time, and a stop interval.

The reel number indicates each of the first, second, third, fourth, and fifth reels 31a to 31e. A command for defining moving of each of the reels 31a to 31e is input to the reel spin field of the reel control file. For example, the value “0” of the reel spin may indicate stopping a spin of a corresponding reel at a predetermined time, and the value “1” of the reel spin may indicate maintaining the spin of the corresponding reel. A command for defining a spin direction of each of the reels 31a to 31e is input to the spin direction field of the reel control file. For example, a value for indicating “a forward spin” or a value for indicating “a reverse spin” of a corresponding reel may be input to the spin direction field. Values for defining the highest spin speed and the lowest spin of each of the reels 31a to 31e are input to the highest speed and the lowest speed of the reel control file, respectively. Their measurement units may be revolutions per minute (RPM). The highest speed may be generally used as the spin speed of the corresponding reel, and the lowest speed may be used as the spin speed of the corresponding reel at a special mode, for example, a mode for a low speed spin of the corresponding reel. The lowest value of a spin time of each of the reels 31a to 31e is input to the lowest spin time field of the reel control file. A time interval, i.e., a delay time between the lowest spin time and a stop of the corresponding is input to the stop interval field of the reel control file. Accordingly, each of the reels 31a to 31e stops after a sum of the value of a corresponding stop interval and a corresponding lowest spin time is lapsed. In the example of FIG. 74A, the spin time (five seconds) of the extra reel 31e is input to the lowest spin time field. Accordingly, after the reels 31a to 31e spin for five seconds in the forward direction, the extra reel 31e stops as shown in FIG. 38. The value of “1” is input to the reel spin fields of the basic reels 31a-31d such that the basic reels 31a-31d maintain their spinning after the first scene.

A data type of a command input to each of the fields of the reel control file may be defined as a data type of a programming language (for example, the C programming language) for the execution program or the basic program compiling the data sheet. The execution program can execute the commands of the reel control file, or the commands of the reel control file can be complied by the basic program.

When the reels 31a to 31e move based on the reel control file, the character image 73 is shown on the secondary display 70. Accordingly, a filename (DISPLAY_START.CSV) of a display control file for rendering the character image 73 is input to a display field of the data sheet. The gaming machine 1 can display the corresponding images on the secondary display 70 in synchronization with movements of the reels 31a to 31e.

Referring to FIG. 75A, the display control file may include commands for controlling the secondary display 70. The display control file includes commands for effects to be rendered depending on the times. A command for an effect that the character 73 holding a pickaxe with a right hand appears as shown in FIG. 38 when the reels 31a to 31e start spinning (i.e., after zero second) are input to the display control file.

The commands for the effects may be image files. A data type of a command input into each of the fields of the display control file may be defined as a data type of a programming language (for example, the C programming language) for the execution program or the basic program compiling the data sheet. The execution program can execute the commands of the display control file, or the commands of the display control file can be complied by the basic program.

A scene trigger tag (#SCENE_TR) may be input to at least one row for an event to be triggered in the scene. In the first scene, an event may be triggered by the stop of the extra reel 31e. That is, the scene trigger tag (#SCENE_TR) is first input to a row for the event. The stop of the extra reel 31e (R5_STOP) is input, as a triggering condition, into a trigger (TRIGGER 1) of the row to which the scene trigger tag (#SCENE_TR) is input. Furthermore, 1 second (1 SEC) is input, as another triggering condition, to a trigger (TRIGGER 2) of the row to which the scene trigger tag (#SCENE_TR) is input. Accordingly, commands of the row to which the scene trigger tag (#SCENE_TR), “R5_STOP,” and “1 second” are input are simultaneously executed 1 second after the extra reel 31e stops. When inputting “R5_STOP,” the user may input “START” to a trigger (TRIGGER 3) of the same row. A filename (DISPLAY_STRIKELCSV) of a display control file is input, as a command, to the display field of the row to which the scene trigger tag (#SCENE_TR) and “R5_STOP” are input.

Referring to FIG. 75B, the display control file may include a command for an effect that the character image 73 strikes the extra reel 31e or the ground with the pickaxe as shown in FIG. 39 at a time 1 second after the extra reel 31e stops spinning are input to the display control file.

The first scene ends and the second scene starts when the character image 73 strikes the extra reel 31e or the ground with the pickaxe after the extra reel 31e stops. Accordingly, a scene start tag (#SCENE_ST) for the second scene (SCENE NO=1) is input to at least one row. In the second scene, the extra reel 31e starts spinning (in response to the striking action of the character image 73 in the previous scene) and stops the spinning (in response to a striking action of the character image 73 in the current scene) to show a multiplier symbol while the basic symbols 31a-31d maintaining the spinning as shown in FIG. 40. The movements of the reels 31a-31e are substantially the same as those shown in FIG. 38. Therefore, the filename (EXTRA_REEL_STOP.CSV) of the reel control file for controlling the movements of the reels 31a to 31e is input again to a reel field of the data sheet. In addition, a filename (DISPLAY_STRIKE2.CSV) of a display control file is input, as a command, to the display field.

Referring to FIG. 75C, the display control file may include two commands. One of the two commands is provided for an effect that the character image 73 holds the pickaxe in both hands, and the other the two commands is provided for an effect that the character image 73 strikes again the extra reel 31e or the ground with the pickaxe as shown in FIG. 40 at a time 4 seconds after the extra reel 31e starts spinning.

Next, a scene trigger tag (#SCENE_TR) is input to a row for an event to be triggered in the second scene. In the second scene, when 1 second elapse after the extra reel 31e stops spinning, the event for stopping the basic reels 31a-31d is triggered. Accordingly, stop of the extra reel 31e (R5_STOP) is input, as a triggering condition, to a trigger (TRIGGER 1) of the row to which the scene trigger tag (#SCENE_TR) is input. Further, 1 second is input, as another triggering condition, to a trigger (TRIGGER 2) of the row to which the scene trigger tag (#SCENE_TR) is input. Commands of the row to which the scene trigger tag (#SCENE_TR), “R5_STOP” and “1 second” are input are simultaneously executed when 1 second elapses after the start of the second scene.

Further, a filename (BASIC_REEL_STOP.CSV) of a reel control file for stopping the basic symbols 31a-31d is input to the reel field of the row to which the scene trigger tag (#SCENE_TR), “R5_STOP” and “1 second” are input. Referring to FIG. 74B, the reel control file (BASIC_REEL_STOP.CSV) includes commands for controlling the basic reels 31a-31d. In the example of FIG. 74B, the spin time (0 second) of the extra reel 31e is input to the lowest spin time field. Accordingly, when 2 seconds elapse the extra reel 31e stops spinning, the first basic reel 31a stops as shown in FIG. 41. The first to fourth basic reels 31a-31d stop spinning in sequence at an interval of 1 second.

The second scene ends and the third scene starts when all of the reels 31a to 31e stop. Accordingly, a scene start tag (#SCENE_ST) for the third scene (SCENE NO=2) is input to at least one row. In the third scene, the extra reel 31e starts spinning in a reverse direction and stops the spinning while the basic symbols 31a-31d are rest as shown in FIG. 42. Therefore, the filename (EXTRA_REEL_REVERSE_SPIN.CSV) of the reel control file for controlling the movements of the extra reel 31d is input again to a reel field of the data sheet. In addition, a filename (DISPLAY_START.CSV) of a display control file is input, as a command, to the display field.

Referring to FIG. 74C, the reel control file (EXTR_REEL_REVERSE_SPIN.CSV) includes commands for controlling the extra reel 31e. In the example of FIG. 74C, the spin time (0 second) of the basic reels 31a-31d is input to the lowest spin time field, and 2 seconds is input to the stop interval field of the extra reel 31e. In addition, “reverse direction” is input to the spin direction field of the extra reel 31e. Accordingly, when 2 seconds elapse after the extra reel 31e starts reverse spinning, the extra reel 31e stops as shown in FIG. 42.

Accordingly, a scene end tag (#SCENE_END) is input to at least one row for an event corresponding to the end of the scene. When inputting the scene end tag, the user may input “END” to a trigger (TRIGGER 3) of the same row. If no event is performed when the scene ends, the scene end tag (#SCENE_END) may be omitted.

As such, according to the example of the data sheet shown in FIG. 73 to FIG. 75C, the rendering effect can be rendered. In this case, movements of the reels 31a to 31e and/or the secondary display 70 may be synchronized with the time or the music.

Embodiments of the present invention can also be embodied as a computer readable program on a computer-readable recording medium. The computer readable recording medium is any data storage device that can store data that can be read thereafter by a computer. Examples of the computer readable recording medium include ROMs, RAMs, CD-ROMs, magnetic tapes, floppy disks, and optical data storage devices. The computer readable recording medium can also be distributed over a network coupled computer system so that the computer readable code is stored and executed in a distributed fashion.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A gaming machine comprising:
a reel assembly comprising basic reels including a plurality of basic symbols and an extra reel including a plurality of extra symbols; and
a controller configured to:
control the basic reels and the extra reel;
execute a first lottery with the basic reels to determine a win or a loss of a game;
execute a second lottery to select one of the extra symbols; and
control the extra reel to spin and stop to show the selected one of the extra symbols,
wherein
the plurality of extra symbols include a multiplier symbol multiplying a win prize of the game, an effect symbol used in an effect of the game, a determinant symbol determining a number of free rounds in a free mode of the game, and an adder symbol adding extra free rounds in the free mode of the game.

2. The gaming machine of claim 1, wherein the controller is configured to:
determine whether a predetermined condition for moving the extra reel is satisfied; and
execute the second lottery with the extra reel when it is determined that the predetermined condition is satisfied.

3. The gaming machine of claim 1, wherein the plurality of reels are mechanical reels configured to rotate around a common rotational axis.

4. The gaming machine of claim 1, wherein the extra reel moves based on a result of the second lottery.

5. The gaming machine of claim 1, wherein the extra reel and the basic reel move based on a result of the second lottery.

6. The gaming machine of claim 1, wherein the controller is configured to:
execute the first lottery in a normal mode of the game;
determine a result of the first lottery executed in a normal mode satisfies a predetermined condition for triggering a free mode;
execute the second lottery to select the determinant symbol before starting a game round in the free mode when a result of the first lottery executed in the normal mode satisfies the predetermined condition; and
determine a number of game rounds in the free mode based on the selected determinant symbol.

7. The gaming machine of claim 6, wherein the controller is configured to:
execute the first lottery in a free mode of the game;
determine a result of the first lottery executed in the free mode satisfies the predetermined condition;
execute the second lottery to select the determinant symbol before starting a next game round when a result of the first lottery executed in the free mode satisfies the predetermined condition; and
determine a number of additional game rounds in the free mode based the selected determinant symbol.

8. The gaming machine of claim 1, wherein the controller is configured to:
execute the second lottery in a free mode to select the adder symbol; and
increase a number of game rounds in a free mode based on the adder symbol.

9. The gaming machine of claim 1, wherein
the multiplier symbol has a first multiplier value or a second multiplier value higher than the first multiplier value, and
the effect symbol includes a chance symbol informing that a free mode is triggered or retriggered or that the extra reel re-spin and stops to show the multiplier symbol with the second multiplier value.

10. The gaming machine of claim 1, wherein
the effect symbol includes a bonus effect symbol informing that a free mode is triggered, and
the controller is configured to:
execute the first lottery in a normal mode of the game;
determine a result of the first lottery executed in a normal mode satisfies a predetermined condition for triggering a free mode; and
control the extra reel to show the bonus effect symbol when a result of the first lottery executed in the normal mode satisfies the predetermined condition for triggering the free mode.

11. The gaming machine of claim 1, wherein
the effect symbol includes a loss symbol informing of a loss of a game round, and
the controller is configured to control the extra reel to show the loss symbol when a result of the first lottery fails to satisfy a predetermined condition for win.

12. The gaming machine of claim 1, wherein the controller is configured to execute a third lottery to determine a movement pattern of the extra reel.

13. The gaming machine of claim 1, wherein the controller is configured to control the extra reel based on the determined movement pattern such that the extra reel repeatedly spins and stops to show the effect symbol before showing the selected one of the extra symbols.

14. The gaming machine of claim 1, further comprising an illuminator configured to illuminate light image to portions of the plurality of reels,
wherein at least one of the plurality of the reels comprises a reel strip including a partially reflective layer that partially reflect the light image from the illuminator.

15. The gaming machine of claim 1, wherein
the extra reel comprises a first reel strip including a first symbol layer and a second symbol layer,
the first symbol layer comprises a first translucent color sheet having a first background color and a first symbol that is substantially colorless and transparent,
the second symbol layer comprises a second translucent color sheet having a second background color different from the first background color and a second symbol that is substantially colorless and transparent,
the first translucent color sheet and the second translucent color sheet overlap each other, and
the reel assembly comprises a backlighting unit illuminating light to the first reel strip in an outward direction with different colors such that the first symbol and the second symbol is alternatively visible depending on a color of the light illuminated by the backlighting unit.

16. A gaming method comprising:
executing a first lottery for a game round with basic reels of a reel assembly of a gaming machine, the basic reels including a plurality of basic symbols, to determine a win or a loss of the game;
executing a second lottery for the game round with an extra reel of the reel assembly, the extra reel including a plurality of extra symbols, to select one of the extra symbols; and
spinning and stopping the extra reel to show the selected one of the extra symbols,
wherein the plurality of extra symbols include multiplier symbols multiplying a win prize of the game, effect symbols used in an effect of the game, determinant symbols determining a number of free rounds in a free mode of the game, and adder symbols adding extra free rounds in the free mode of the game.

17. The gaming method of claim 16, further comprising:
determining whether a predetermined condition for moving the extra reel is satisfied; and
moving the extra reel in connection with the basic reels when it is determined that the predetermined condition is satisfied,
wherein the second lottery is executed when it is determined that the predetermined condition is satisfied.

18. The gaming method of claim 16, wherein the spinning and stopping the extra reel is performed based on a movement pattern such that the extra reel repeatedly spins and stops to show the effect symbol before showing the selected one of the extra symbols.

19. The gaming method of claim 16, wherein the effect symbols include a first effect symbol informing that the extra reel re-spins and stops to show one of the multiplier symbols, or informing that a free mode is triggered or retriggered.

20. The gaming method of claim 19, wherein the effect symbols further include a second effect symbol informing of a loss of a game round.
